(19) United States
(12) Patent Application Publication
(10) Pub. No.: US 2026/0247197 A1
(43) Pub. Date: Aug. 20, 2026

(54) TRIGGERING OF MEASUREMENT AND REPORTING

(71) Applicant: Samsung Electronics Co., Ltd., Suwon-si (KR)

(72) Inventors: Dalin Zhu, Allen, TX (US); Emad Nader Farag, Flanders, NJ (US); Anil Agiwal, McKinney, TX (US); Saifur Rahman, Plano, TX (US); Eko Onggosanusi, Coppell, TX (US)

(21) Appl. No.: 19/455,771

(22) Filed: Jan. 21, 2026

Related U.S. Application Data
(60) Provisional application No. 63/758,848, filed on Feb. 14, 2025.
(60) Provisional application No. 63/766,113, filed on Mar. 3, 2025.

(51) Int. Cl. H04W 24/10

(52) U.S. Cl. CPC H04W 24/10

(57) ABSTRACT

Methods and apparatuses for triggering of measurement and reporting. A method performed by a user equipment (UE) includes receiving information related to early channel state information (CSI) acquisition for a secondary cell (SCell), receiving signaling associated with the SCell, identifying, based on the signaling and the information, a target CSI report configuration for early CSI acquisition for the SCell, and determining, based on the target CSI report configuration, one or more CSI reference signals (CSI-RSs) for channel measurement and one or more uplink (UL) resources for reporting CSI. The method further includes measuring the one or more CSI-RSs, determining a CSI report based on the measurement, and transmitting the CSI report in the one or more UL resources.

### CROSS-REFERENCE TO RELATED AND CLAIM OF PRIORITY

The present application claims priority under 35 U.S.C. § 119(e) to U.S. Provisional Patent Application No. 63/758,848 filed on Feb. 14, 2025, and U.S. Provisional Patent Application No. 63/766,113 filed on Mar. 3, 2025, which are hereby incorporated by reference in their entirety.

### TECHNICAL FIELD

The present disclosure relates generally to wireless communication systems and, more specifically, the present disclosure relates to methods and apparatuses for triggering of measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed

### SUMMARY

The present disclosure relates to triggering of measurement and reporting.

In one embodiment, a user equipment (UE) is provided. The UE includes a transceiver configured to receive information related to early channel state information (CSI) acquisition for a secondary cell (SCell) and receive signaling associated with the SCell. The UE further includes a processor operably coupled with the transceiver. The processor is configured to identify, based on the signaling and the information, a target CSI report configuration for early CSI acquisition for the SCell and determine, based on the target CSI report configuration, one or more CSI reference signals (CSI-RSs) for channel measurement and one or more uplink (UL) resources for reporting CSI. The transceiver is further configured to measure the one or more CSI-RSs. The processor is further configured to determine a CSI report based on the measurement. The transceiver is further configured to transmit the CSI report in the one or more UL resources.

In another embodiment, a base station (BS) is provided. The BS includes a transceiver configured to transmit information related to early CSI acquisition for a SCell and transmit signaling associated with the SCell, wherein the signaling and the information indicate a target CSI report configuration for early CSI acquisition for the SCell. The BS further includes a processor operably coupled with the transceiver. The processor is configured to determine, based on the target CSI report configuration, one or more CSI-RSs and one or more UL resources for receiving CSI reporting. The transceiver is further configured to transmit the one or more CSI-RSs and receive a CSI report associated with the one or more CSI-RSs in the one or more UL resources.

In yet another embodiment, a method performed by a UE is provided. The method includes receiving information related to early CSI acquisition for a SCell, receiving signaling associated with the SCell, identifying, based on the signaling and the information, a target CSI report configuration for early CSI acquisition for the SCell, and determining, based on the target CSI report configuration, one or more CSI-RSs for channel measurement and one or more UL resources for reporting CSI. The method further includes measuring the one or more CSI-RSs, determining a CSI report based on the measurement, and transmitting the CSI report in the one or more UL resources.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example primary synchronization signal (PSS)/secondary synchronization signal (SSS)/physical broadcast channel (PBCH) (SSB) block according to embodiments of the present disclosure;

FIG. 8 illustrates example type-1 random access procedures according to embodiments of the present disclosure;

FIG. 9 illustrates example type-2 random access procedures according to embodiments of the present disclosure; and

FIG. 10 illustrates an example method performed by a UE in a wireless communication system according to embodiments of the present disclosure.

### DETAILED DESCRIPTION

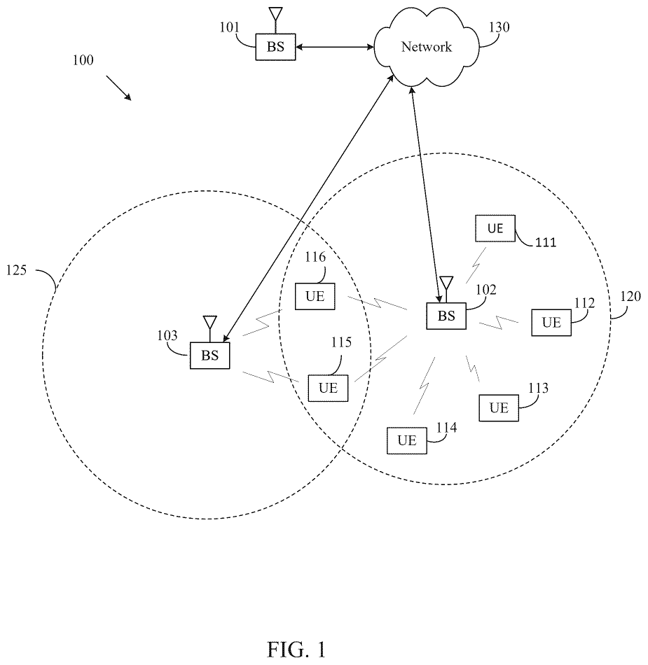

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, and large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for triggering of measurement and reporting. In certain embodiments, one or more of the BSs 101-103 include circuitry, programing, or a combination thereof to support triggering of measurement and reporting.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

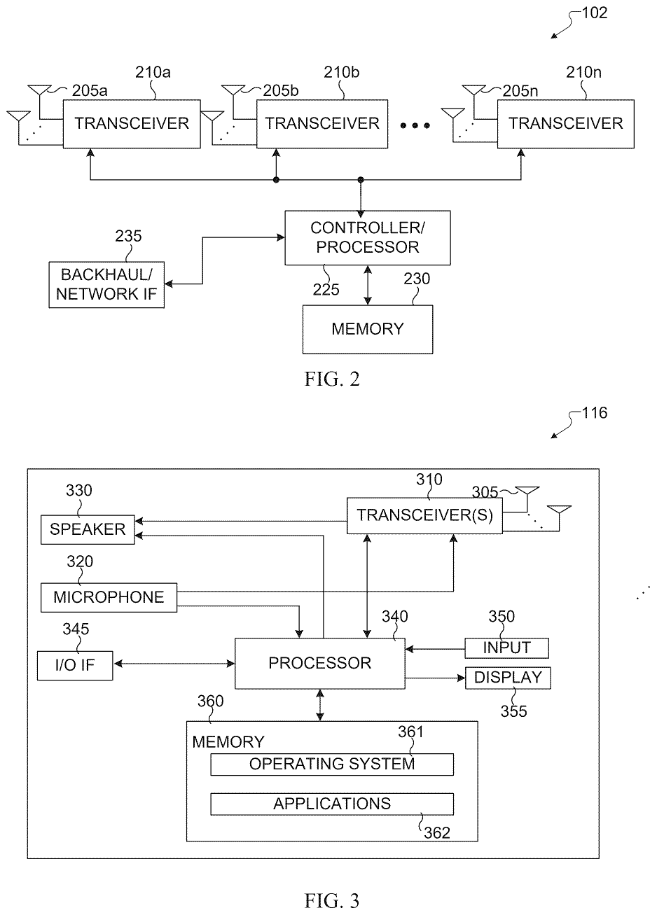

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting triggering of measurement and reporting. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize triggering of measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

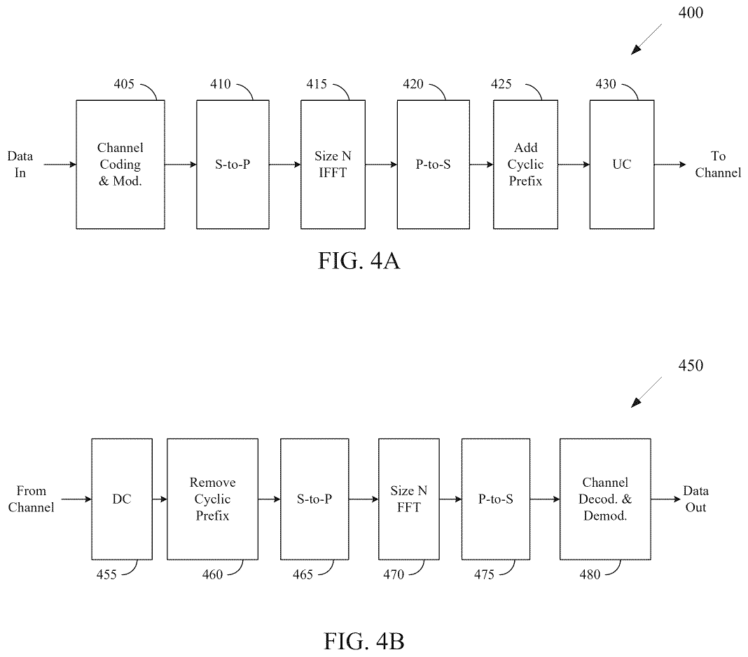

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support triggering of measurement and reporting as described in embodiments of the present disclosure. In some embodiments, the receive path 450 is configured to support triggering of measurement and reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

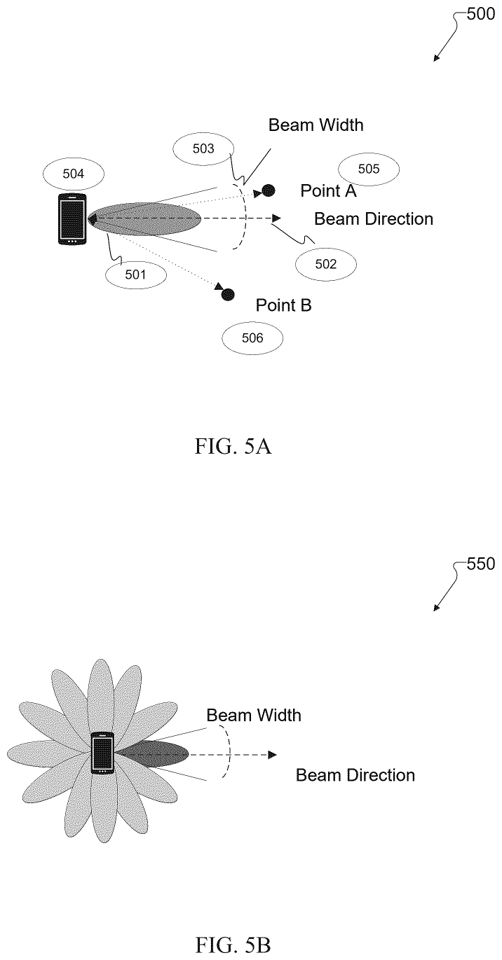

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art that a beam can be 3D, where a beam can be transmitted to or received from any direction in space.

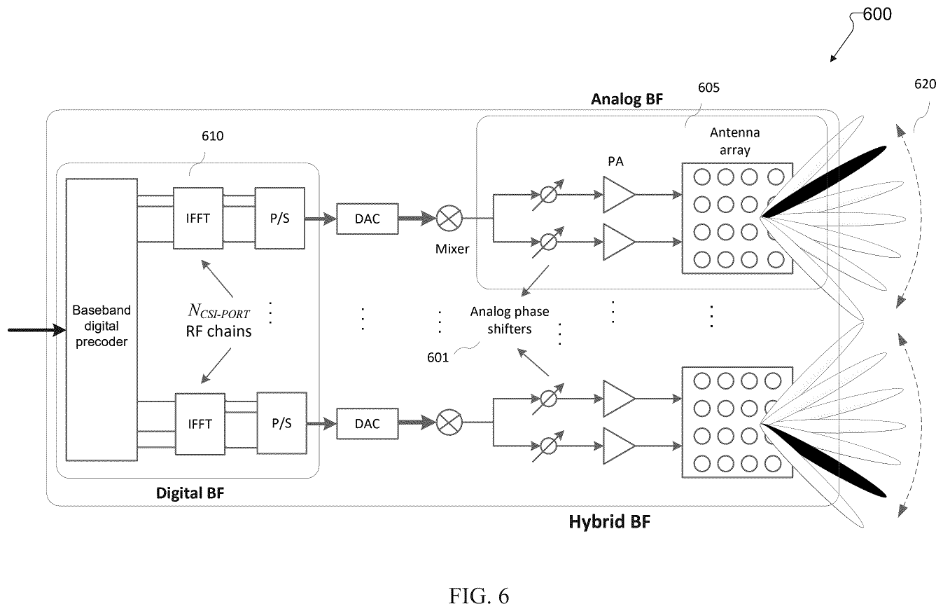

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NcsI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of;
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources. In this disclosure, a TCI state can be referred to as a spatial resource unit.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state (TCI state code point) indicated/included in a DL related DCI format or UL related DCI format is applied after a beam application time from the corresponding HARQ-ACK feedback.

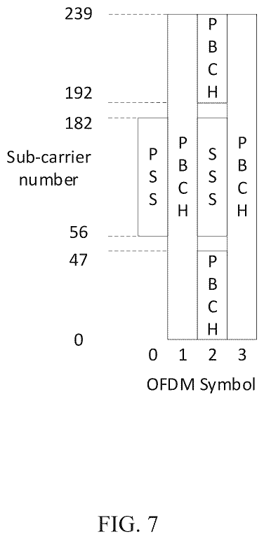

FIG. 7 illustrates an example SSB block 700 according to embodiments of the present disclosure. For example, the SSB block 700 may be described as being implemented in a BS (such as BS 102). The example SSB block 700 shown in FIG. 7 is for illustration only and other embodiments can be used without departing from the scope of the present disclosure.

In 5G/NR, a geographical area served by the network can be partitioned into cells as aforementioned. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

In 5G/NR, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 physical resource blocks (240 subcarriers), as illustrated in FIG. 7.

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHZ, N=4. For carrier frequencies in FR1 that are larger than 3 GHZ, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

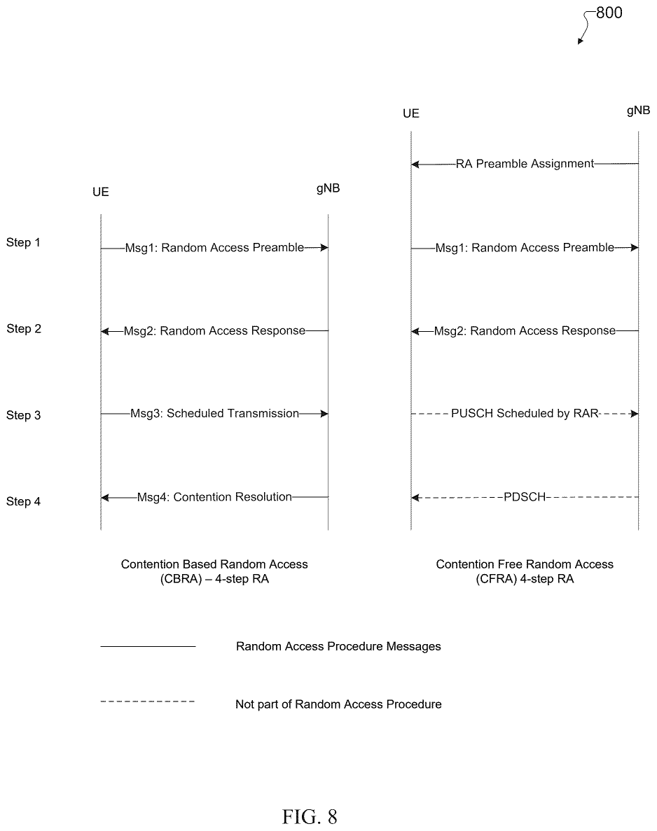

FIG. 8 illustrates example type-1 random access procedures 800 according to embodiments of the present disclosure. For example, a type-1 random access procedure may be described as being implemented in a BS (such as BS 102) and a UE (such as UE 116). The example type-1 random access procedures 800 shown in FIG. 8 are for illustration only and other embodiments can be used without departing from the scope of the present disclosure.

A random access procedure can be initiated by a PDCCH order, by the MAC entity, or by RRC.

There are two types of random access procedures, type-1 random access procedure and type-2 random access procedure.

The type-1 random access procedure also known as a four-step random access procedure (4-step RACH), is as illustrated in FIG. 8;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

A type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

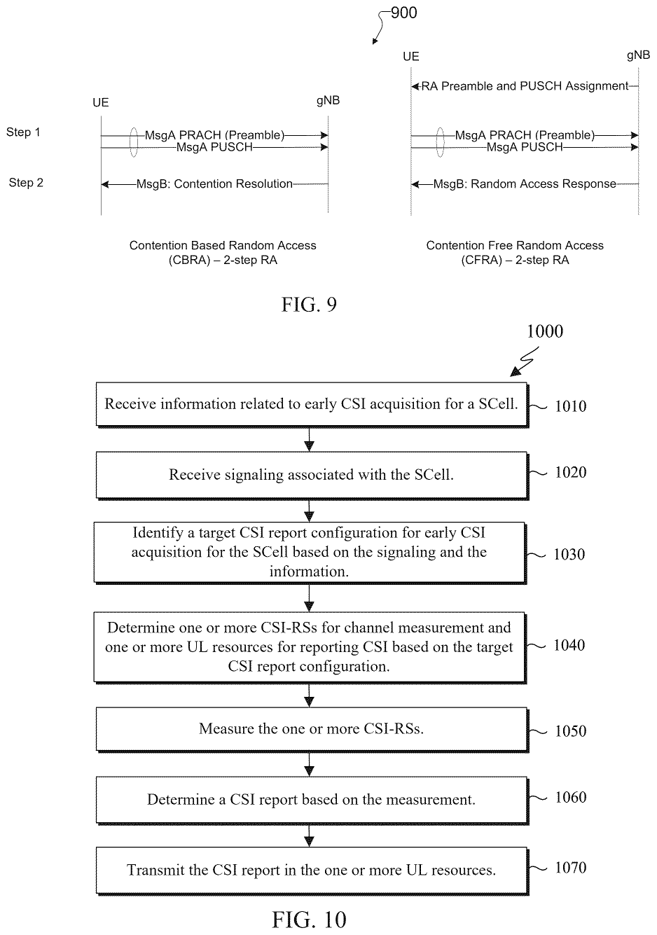

FIG. 9 illustrates example type-2 random access procedures 900 according to embodiments of the present disclosure. For example, a type-2 random access procedure 900 may be described as being implemented in a BS (such as BS 102) and a UE (such as UE 116). The example type-2 random access procedures 900 shown in FIG. 9 are for illustration only and other embodiments can be used without departing from the scope of the present disclosure.

Rel-16 introduced a new random access procedure; Type-2 random access procedure, also known as 2-step random access procedure (2-step RACH), is as illustrated in FIG. 9, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Channel state information reference signal is a downlink reference signal that is used for obtaining the downlink channel condition between the gNB and the UE. CSI-RS can be transmitted independent of data transmissions on the downlink. The CSI-RS usage can be CSI-RS of beam management, CSI-RS for tracking, CSI-RS for CSI and etc.

In NR, CSI-RS resources including SSB(s) and/or NZP CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state.

Sounding reference signal is an uplink reference signal that is used for sounding (i.e., channel quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR, SRS resources are configured by the network, for example, as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic, (2) usage, which can be one of: beamManagement, codebook, nonCodebook or antennaSwitching, and (3) information related to power control and TCI state.

The configuration of the SRS resource includes the following: (1) information related to the transmission comb, including comb size, comb offset and cyclic shift, (2) information related to domain resource mapping including starting symbol within a slot, number of SRS symbols and repetition factor, (3) information related to frequency domain including freqDomainPosition N_RRC, freqDomainShift n_shift, and frequency hopping parameters c-SRS, b-SRS, and b-hop, (4) information related to group or sequence hopping, whether one of them or neither is enabled, (5) for periodic and semi-persistent SRS, the periodicity and offset of the SRS resource, (6) sequence ID, and (7) information related to the TCI state or spatial relation info.

In 5G/NR, a UE can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{jan} {\overline{r}}_{u , v} ( n ) , 0 \leq n < {M}_{ZC} where$$

$${M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}ϵ{2,4,8}. l′ is the SRS symbol within a SRS Resource on a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and$$

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} with {n}_{SRS}^{cs}$$

being provided by higher layer in IE transmissionComb,

$${n}_{SRS}^{cs , max}$$

depends ON K_{TC} as illustrated in Table 1.

TABLE 1

| K_{TC} | n_{SRS}^{cs, max} |
|---|---|
| 2 | 8 |
| 4 | 12 |
| 8 | 6 |

u is the group number uϵ{0, 1, . . . , 29}, v is the base sequence number, with vϵ{0}, if 6≤N_{ZC}≤60 and ϵ{0}, if 60<N_{ZC}. The base sequence, r̅_{u,v}(n), is generated as follows:
1. For N_{ZC}ϵ{6,12,18,24}, r̅_{u,v}(n)=e^{jφ(n)π/}4, with 0≤n<M_{ZC}−1. φ(n) is given by Tables 5.2.2.2-1 to 5.2.2.2-4 of TS 38.211.

$$2. For {N}_{ZC} = 30 , {\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π qm ( m + 1 )}{{N}_{ZC}}} .$$

N_{ZC} is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where,

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length-31 Gold sequence defined asc(n)=(x₁(n+N_{c})+x₂(n+N_{c}) mod 2, with N_{c}=1600, x₁(n+31)=(x₁(n+3)+x₁(n) mod 2, x₁(n+31)=(x₂(n+3)+x₂(n+2)+x₂(n+1)+x₂(n) mod 2, the first m-sequence is initialized with x₁(0)=1, and x₂(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0 and$$

$$v = \{ \text{} \begin{matrix}c ( {n}_{s , f}^{μ} {N}_{symb}^{slot} + {l}_{0} + {l}^{′} & {M}_{sc , b}^{SRS} \geq 6 {N}_{sc}^{RB} \\ 0 & otherwise\end{matrix} \text{}$$

is the number of symbols in a slots, l₀ is the first SRS symbols in the slot, and c(n) a length-31 Gold sequence as previously defined.

The SRS sequence, r^{(p)}(n, l′), is mapped to resource elements

$${a}_{k , l}^{( p )}$$

within a slot, where k is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

### Where,

β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of TS 38.211, and

$${l}^{′} = 0 , 1 , … , {N}_{symb}^{SRS} - 1.$$

l=l′+l₀, with l₀ the first SRS symbols in the slot, where l₀ϵ{0, 1, . . . , 13}.

$$k = {K}_{TC} {k}^{′} + {k}_{0}^{( {p}_{i} )} ,$$

K_{TC} is the transmission comb number as previously described,

$${\sum }_{b = 0}^{{B}_{SRS}} {K}_{TC} {M}_{sc , b}^{SRS} {n}_{b} , {\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} ,$$

$${k}_{TC}^{( {p}_{i} )} = \{ \text{} \begin{matrix}{\overline{k}}_{TC} + {K}_{TC} / 2 ) mod {K}_{TC} & \begin{matrix}if {n}_{SRS}^{cs} ∈ \{ \frac{{n}_{SRS}^{cs , max}}{2} , … , {n}_{SRS}^{cs , max} - 1 \} and \\ {N}_{ap}^{SRS} = 4 and {p}_{i} ∈ \{ 1001 , 1003 \}\end{matrix} \\ {\overline{k}}_{TC} & otherwise\end{matrix} \text{}$$

k̅_{TC} is the transmission comb offset included within higher layer IE transmissionComb, with k̅_{TC}ϵ{0, 1, . . . , K_{TC}−1},

$${k}_{offset}^{{l}^{′}}$$

is a symbol dependent sub-carrier offset given by Table 3, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0) in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of TS 38.211 with b=B_{SRS} and the configured value of C_{SRS}.

TABLE 2

| | ${k}_{offset}^{0} , {k}_{offset}^{1} , … , {k}_{offset}^{{N}_{s y m b}^{S R S} - 1}$ | | | | |
|---|---|---|---|---|---|
| K_{TC} | ${N}_{s y m b}^{S R S} = 1$ | ${N}_{symb}^{SRS} = 2$ | ${N}_{symb}^{SRS} = 4$ | ${N}_{symb}^{SRS} = 8$ | ${N}_{s y m b}^{S R S} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a TMSI or an I-RNTI. The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |

| | |
|---|---|
| message | PCCH-Message Type |

}

| | |
|---|---|
| PCCH-MessageType ::= | CHOICE { |

| | |
|---|---|
| c1 | CHOICE { |
| paging | Paging, |

```
  spare1 NULL
  },
```

| | |
|---|---|
| messageClassExtension | SEQUENCE { } |

}

| | |
|---|---|
| Paging ::= | SEQUENCE { |

| | | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| PagingRecordList ::= | SEQUENCE (SIZE(1..maxNrofPageRec)) OF PagingRecord | |
|---|---|---|
| PagingRecord ::= | SEQUENCE { | |
| ue-Identity | PagingUE-Identity, | |
| accessType | ENUMERATED {non3GPP} | OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can consist of multiple time slots where paging DCI can be sent. A Paging Frame (PF) is one Radio Frame and may contain one or multiple PO(s) or starting point of a PO.

The PF and PO for paging are determined by the following equations:
SFN of the PF is determined by: (SFN+PF_offset) mod T=(T div N)*(UE_ID mod N)
The index i_s of the PO is determined by: i_s=floor (UE_ID/N) mod Ns

### Where,

T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via NAS signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided in into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and TRS availability indication for one or more UEs. DCI Format 2_7 has a CRC scrambled by PEI_RNTI. DCI Format 2_7 includes: (1) a paging indication field of size

$${N}_{PO}^{PEI} \cdot {N}_{SG}^{PO} , where , {N}_{PO}^{PEI}$$

is the number of paging occasions configured by higher layer parameter po-NumPerPEI, and

$${N}_{SG}^{PO}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of all the indBitID(s) provided by the trs-ResourceSetConfig if configured; 0 bits otherwise. Each TRS resource set is configured with an ID i for the association with (i+1)-th indication bit.

This disclosure considers early triggering of CSI measurement/reporting and/or SRS for UEs in RRC_IDLE or RRC_INACTIVE states when the network has data to send to the UE or the UE has data send to network. Early CSI measurement/reporting and/or early SRS transmission, can assist in determining the channel conditions and better link adaptation and better precoding for downlink and uplink transmissions. This disclosure considers means of providing configuration(s) of CSI-RS resource(s) for early triggering of CSI measurement/reporting, means of providing configuration(s) of SRS resource(s) for early triggering of SRS transmission, signaling medium(s)/container(s) to carry the configuration(s) and the corresponding UE's behaviors/assumptions.

This disclosure considers early triggering of CSI measurement/reporting for layer-1/layer-2 (L1/L2) triggered mobility (LTM). Early CSI measurement/reporting can assist in determining the channel conditions and better link adaptation and better precoding for downlink and uplink transmissions.

Embodiments of the present disclosure recognize that when a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger CSI measurement/reporting and/or trigger SRS transmission from the UE for channel quality estimation and the UE can start transmitting and receiving data. For instance, in terms of uplink channel estimation/acquisition, the SRS triggered can be wideband SRS or sub-band SRS, which would require several SRS transmission instances to provide an estimate of the channel quality of the full bandwidth. This process, i.e., the estimation of the channel quality, can take tens of milliseconds, and even longer with sub-band SRS. Data transmission/reception can be delayed until the channel quality has been estimated using CSI-RS and/or SRS, hence increasing latency. Alternatively, data transmission/reception can proceed in parallel with the CSI measurement/reporting and/or SRS transmission, and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for performing CSI measurement/reporting and/or transmitting SRS in parallel with RRC setup procedure, or RRC reconfiguration procedure to reduce latency.

When the network initiates a communication session, the UE is first paged, and this is then followed by a random access (RA), or also referred to as RACH, procedure. When the UE initiates a communication session, a RACH procedure is used. The aforementioned early triggered CSI measurement/reporting and/or early SRS triggering and/or transmission can occur during paging, and/or can be associated with the paging procedure. Alternatively, the aforementioned early triggered CSI measurement/reporting and/or early SRS triggering and/or transmission can occur during a RACH procedure or can be associated with a RACH procedure. This disclosure discusses means of providing configuration(s) of CSI-RS resource(s) for early triggering of CSI measurement/reporting, means of providing configuration(s) of SRS resource(s) for early triggering of SRS transmission, signaling medium(s)/container(s) to carry the configuration(s) and the corresponding UE's behaviors/assumptions.

Accordingly, embodiments of the present disclosure provide various design examples, aspects and means of providing configuration(s) of CSI-RS resource(s) for early triggering of CSI measurement/reporting, and/or configuration(s) of SRS resource(s) for early triggering of SRS transmission, including
Signaling medium(s)/container(s) to carry the configuration(s), which includes SIB, RRC setup, RRC reconfiguration, RRC release message and/or etc.
Detailed configuration(s) and setting(s) for the CSI-RS resource(s) for early CSI measurement/reporting triggering and/or the SRS resource(s) for early SRS transmission triggering
Selection and indication of CSI-RS resource configuration(s) by the UE for the early triggering of CSI measurement/reporting, and/or selection and indication of SRS resource configuration(s) by the UE for the early triggering of SRS transmission
Selection and indication of CSI-RS and/or SRS resource configuration(s) by the network for the early triggering of CSI measurement/reporting and/or SRS transmission(s)

The corresponding/related design procedure(s), signaling flow(s)/method(s), UE's assumption(s)/behavior(s) and/or etc. of the above are also provided in this disclosure.

This disclosure also provides various design examples, aspects and means of providing configuration(s) of CSI-RS resource(s) for the early triggering of the CSI measurement/reporting are also provided in this disclosure, similar to those for the SRS resource(s) for the early triggering of the SRS transmission(s).

This disclosure also considers triggering of CSI measurement/reporting and SRS transmission(s) for CSI acquisition under various operation modes when a UE is in RRC connection with the network. Trigger of CSI measurement/reporting and/or SRS transmission(s), and therefore CSI acquisition, can assist in determining the channel conditions and better link adaptation and better precoding for downlink and uplink transmissions.

In the present disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling. In addition, MAC CE signaling can be UE-specific e.g., to one UE and can be UE common (e.g., to a group of UEs). MAC CE signaling can be DL MAC CE signaling or UL MAC CE signaling. Furthermore, L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used. A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In the present disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). Furthermore, a higher layer message (e.g., SIB-based or RRC-based or MAC CE-based) can be carried by a physical downlink shared channel (PDSCH). In one example, the PDSCH can be scheduled by a DCI format.

In the present disclosure, the configuration(s) of CSI-RS resource(s) may include, contain or comprise at least one or more of the following parameters/settings/components:
CSI-RS resource (including SSB and NZP CSI-RS resource) ID/index, CSI resource set (including SSB resource set and NZP CSI-RS resource set) ID/index, CSI resource configuration/setting ID/index, CSI reporting configuration/setting ID/index.
Resource type and corresponding parameter(s) for the corresponding CSI-RS resource(s) including ‘aperiodic’, ‘periodic’, and/or ‘semi-persistent’; the parameter(s) corresponding to the resource type of ‘aperiodic’ could also comprise or include or contain an aperiodic CSI trigger state list provided by CSI-Aperiodic TriggerState List.
Repetition setting (e.g., repetition set to ‘on’ or ‘off’)
Usage of the CSI-RS resource(s): e.g., CSI-RS for beam management, CSI-RS for CSI, TRS (with trs-Info set to ‘true’), and etc.
Time and frequency resources (e.g., symbols within a slot for CSI-RS, starting symbol for CSI-RS, time slot for CSI-RS, periodicity and offset of CSI-RS (e.g., in case of periodic or semi-persistent CSI-RS), starting PRB for CSI-RS, number of PRBs for CSI-RS).
Resource mapping of CSI-RS resource(s): OFDM symbol location(s) in a slot and subcarrier occupancy in a PRB of the CSI-RS resource
Periodicity and slot offset for the CSI-RS resource(s)
Scrambling ID
Transmit power control parameter(s)/setting(s) for the corresponding reference signal.
TCI state(s) and/or reference signal(s) used for determining the spatial filter(s) for receiving the corresponding CSI-RS(s).

In particular, a UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, the configuration(s) of the CSI-RS resource(s) for the early triggering of the CSI measurement/reporting. For instance, the UE could be provided by the network via/in a higher layer parameter EarlyCSI-ResourceConfig providing or configuring or indicating
At least one or more of the aforementioned parameters/settings/components for the configuration(s) of the corresponding CSI-RS resource(s)
At least one or more of parameters/settings/components provided or configured by/in higher layer parameter(s) including at least CSI-ResourceConfig, CSI-ResourceSet including CSI-SSB-ResourceSet/NZP-CSI-RS-ResourceSet, NZP-CSI-RS-Resource/SSB-Index, and/or etc. for the corresponding CSI-RS resource(s) defined/specified in the 3GPP TS 38.331 for 5G NR.

The UE could alternatively be provided by the network via/in a higher layer parameter EarlyCSI-ReportConfig associated/specific to one or more CSI resource settings/configurations—each provided by EarlyCSI-ResourceConfig—for the early triggering of the CSI measurement/reporting as aforementioned, wherein the higher layer parameter EarlyCSI-ReportConfig could provide or configure or indicate at least one or more of parameters/settings/components provided or configured by/in higher layer parameter(s) including at least CSI-ReportConfig associated/specific/linked to the corresponding CSI-RS resource(s) defined/specified in the 3GPP TS 38.331 for 5G NR.

In one example, the UE could be provided or configured by the network, in system information block including SIB1, SIB2 and/or other SIBs, the above discussed/specified CSI-RS resource configuration(s) for early triggering of the CSI measurement/reporting (e.g., provided by EarlyCSI-ResourceConfig or EarlyCSI-ReportConfig). Examples of providing or configuring the EarlyCSI-ResourceConfig and/or EarlyCSI-ReportConfig as defined/specified above in the higher layer parameters SIB1 and SIB2 are respectively presented below.

| | |
|---|---|
| SIB1 ::= | SEQUENCE { |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

| | |
|---|---|
| SIB2 ::= | SEQUENCE { |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

In one example, the UE could be provided or configured by the network, in RRC release message, the above discussed/specified CSI-RS resource configuration(s) for early triggering of the CSI measurement/reporting (e.g., provided by EarlyCSI-ResourceConfig or EarlyCSI-ReportConfig). One example of providing or configuring the EarlyCSI-ResourceConfig and/or EarlyCSI-ReportConfig as defined/specified above in the higher layer parameters RRCRelease-IEs is presented below.

| RRCRelease-IEs ::= | SEQUENCE { | |
|---|---|---|
| redirectedCarrierInfo | RedirectedCarrierInfo | OPTIONAL, |

-- Need N,

| | |
|---|---|
| cellReselectionPriorities | CellReselectionPriorities |

OPTIONAL, -- Need R,

| | | |
|---|---|---|
| suspendConfig | SuspendConfig | OPTIONAL, -- Need R, |

...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

According to those specified herein in the present disclosure, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, which RRC signaling(s)/parameter(s)—e.g., RRCRelease-IEs and/or SIB1 and/or SIB2 as specified/defined above—to use/apply for determine the CSI-RS resource configuration(s) for the early CSI measurement/reporting triggering(s). Furthermore, the CSI-RS resource configuration(s) for the early triggering of the CSI measurement/reporting, e.g., provided by EarlyCSI-ResourceConfig or linked/specific to EarlyCSI-ReportConfig, can be (configured to be) present or absent/not present in the corresponding RRC signaling(s)/parameter(s)—e.g., RRCRelease-IEs and/or SIB1 and/or SIB2 as specified/defined above. When/if there are multiple or more than one RRC signals/parameters, e.g., both SIB1 and RRCRelease-IEs, providing or configuring the CSI-RS resource configurations for the early triggering, the UE could determine or identify which of the CSI-RS resource configurations, provided/configured in the multiple RRC signals/parameters as specified/defined herein in the present disclosure, to use/apply for the early CSI measurement/reporting triggering(s), according to or based on
Fixed rule(s) in system specification(s) and/or per RRC (re-)configuration/setup: for example, the UE could (always) determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could (always) determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could (always) determine or identify the CSI-RS resource configuration(s), e.g., EarlyCSI-ResourceConfig and/or EarlyCSI-ReportConfig, provided/configured i n the higher layer parameter(s)/signaling(s) that is provided/received the latest (or earlies) in time to use/apply for the early CSI measurement/reporting triggering(s); for another example, association(s)/mapping(s) between one or more of the higher layer signals/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure could be fixed in system specification(s) and/or per RRC (re-) configuration/setup; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could determine or identify the CSI-RS resource configuration(s) for the early triggering of the CSI measurement/reporting according to or based on priority orders of the higher layer parameters/signals that provide or configure the CSI-RS resource configurations for early CSI measurement/reporting triggering(s) from high to low (or from low to high), wherein the priority orders could be fixed in system specification(s) and/or per RRC (re-) configuration/setup.
Network's configuration(s)/indication(s), e.g., via/by higher layer RRC signaling(s)/parameter(s) and/or MAC CE command(s) and/or dynamic DCI based L1 signaling(s) based on or according to a corresponding UE's capability or capability signaling: for example, the network's configuration(s)/indication(s) can be in form of a bitmap with each entry/bit position of the bitmap corresponding/specific to a higher layer parameter/signaling that provides the CSI-RS resource configuration(s)—e.g., provided by EarlyCSI-ResourceConfig or EarlyCSI-ReportConfig—for the early triggering; for this design example, when/if an entry/bit position of the bitmap is set to ‘1’ (or ‘0’), the higher layer parameter/signaling that is corresponding/specific to the entry/bit position is enabled for providing or configuring the CSI-RS resource configuration for the early triggering of the CSI measurement/reporting; for another example, the network's configuration(s)/indication(s) can be in form of one-bit flag indicator(s), provided/configured in or associated/specific to the higher layer parameter(s)/signaling(s) that provides the CSI-RS resource configuration(s) for the early triggering of the CSI measurement/reporting; for this design example, when/if an one-bit flag indicator, provided/configured in or associated/specific to a higher layer parameter/signaling that provides the CSI-RS resource configuration(s) for the early triggering, is set to ‘1’ (or ‘0’) or ‘enabled’, the higher layer parameter/signaling is enabled for providing or configuring the CSI-RS resource configuration for the early triggering of the CSI measurement/reporting; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, association(s)/mapping(s) between one or more of the higher layer signals/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, priority order(s) for the higher layer signals/parameters that provide or indicate the CSI-RS resource configurations for the early triggering of the CSI measurement/reporting; for this design example, the UE could determine or identify the CSI-RS resource configuration(s) for the early triggering of the CSI measurement/reporting according to or based on priority orders of the higher layer parameters/signals that provide or configure the CSI-RS resource configurations for early CSI measurement/reporting triggering(s) from high to low (or from low to high).

A UE could indicate support of early CSI measurement/reporting by the preamble and/or RO used for the random access procedure.
In one example, a set of preambles and/or ROs are configured for the UE to indicate early CSI measurement and/or reporting-denoted by or referred to as early CSI (UE can randomly select a preamble/RO from the set for early CSI support indication). The set of preambles and/or ROs can be per-SS/PBCH block, or can be common across SS/PBCH blocks.
In another example, preambles within existing RO configurations can be used to indicate that the UE supports early CSI (e.g., group g₁), legacy preambles are used to indicate that the UE doesn't support early CSI (e.g., group g₀). In one example, new ROs can be used to indicate that the UE supports early CSI, e.g., preambles in new ROs can be used to indicate that the UE supports early CSI (e.g., group g₁), legacy preambles are used to indicate that the UE doesn't support early CSI (e.g., group g₀).
In another example, a UE can be configured with a set of preambles in group g₁ for indicating support of early CSI. A UE can be configured with a set of preambles in group g₀ (e.g., legacy preambles) for indicating non-support of early CSI, or UE doesn't prefer performing early CSI.
In another example, a UE randomly selects a preamble from group g₁, if the UE supports early CSI (or if the UE supports and desires to perform early CSI). A network/gNB receiving a preamble in group g₁ can indicate to or configure the UE, in a subsequent message or messages to perform early CSI as described in this disclosure.
In another example, a UE randomly selects a preamble from group g₀, if the UE doesn't support early CSI (or if the UE doesn't desire to perform early CSI). A network/gNB receiving a preamble in group g₀ is expected not to indicate or configure the UE to perform early CSI.

For the above described design examples, the preambles and/or ROs in group g₁ are configured for each SS/PBCH block. Alternatively, the preambles and/or ROs in group g₁ are configured commonly for all SS/PBCH blocks. In a variant of the above described design examples, a set of preambles and/or ROs can be configured for group g₀, e.g., separate from the legacy preambles and/or ROs. Optionally, the preambles and/or ROs in group g₀ are configured for each SS/PBCH block, or the preambles and/or ROs in group g₀ are configured commonly for all SS/PBCH blocks.

A UE can indicate their support of one or more CSI report types (each comprising e.g. one or more CSI report quantities/parameters) for early CSI based on the preamble and/or RO used for the random access procedure. In one example, a first set of preambles and/or ROs are configured for the UE to indicate support of a first CSI report type, a second set of preambles and/or ROs are configured for the UE to indicate support of a second CSI report type, . . . , and the N-th set of preambles and/or ROs are configured for the UE to indicate support of an N-th CSI report type. Wherein, the UE can randomly select a preamble from a set, and the set corresponds to the UE's capability of supporting different CSI report types for early CSI. In one example, the selection of a preamble from any of the N sets indicates to the network that the UE supports early CSI (or supports and desires to perform early CSI). In one example, the network upon receiving a preamble associated with an i-th group, determines that the UE could perform CSI measurement/reporting corresponding to the i-th group corresponding to a CSI report type associated with the i-th group.
In one example, the support of CSI report type(s) could be indicated by a combination of signaling in preamble/RO (e.g., based on the preamble/TO group), and Msg3 or PUSCH MsgA.
In another example, an RO (e.g., per SS/PBCH block or across all SS/PBCH blocks) is configured for indicating the support of CSI report type(s). In one example, the RO has M, e.g., 64 preambles, and the M preambles are split among N groups of preambles. In one example, an RO has M preambles per SSB, and the M preambles are split among N groups of preambles. In one example, the RO has M preambles per SSB per preamble group (group A and group B wherein group A and group B indicates different Msg3/MsgA size), and the M preambles are split among N groups of preambles.

According to or following those specified/defined herein in the present disclosure,
In one example, N=1, and the CSI report type indicated by a preamble (e.g., according to the set of the preamble(s)) can be {ri} for a rank indicator.
In one example, N=1, and the CSI report type indicated by a preamble (e.g., according to the set of the preamble(s)) can be {cqi} for a channel quality indicator.
In one example, N=1, and the CSI report type indicated by a preamble (e.g., according to the set of the preamble(s)) can be {cri} for a CSI-RS resource indicator.
In one example, N=1, and the CSI report type indicated by a preamble (e.g., according to the set of the preamble(s)) can be {li} for a layer indicator.
In one example, N=2, and the CSI report type indicated by a preamble (e.g., according to the set of the preamble(s)) can be one of {ri, cqi}.
In one example, N=2, and the CSI report type indicated by a preamble (e.g., according to the set of the preamble(s)) can be one of {ri, cri}.
In one example, N=2, and the CSI report type indicated by a preamble (e.g., according to the set of the preamble(s)) can be one of {ri, li}.
In one example, N=2, and the CSI report type indicated by a preamble (e.g., according to the set of the preamble(s)) can be one of {cqi, cri}.
In one example, N=2, and the CSI report type indicated by a preamble (e.g., according to the set of the preamble(s)) can be one of {cqi, li}.
In one example, N=2, and the CSI report type indicated by a preamble (e.g., according to the set of the preamble(s)) can be one of {cri, li}.
In one example, N=3, and the CSI report type indicated by a preamble (e.g., according to the set of the preamble(s)) can be one of {ri, cqi, cri}.
In one example, N=3, and the CSI report type indicated by a preamble (e.g., according to the set of the preamble(s)) can be one of {ri, cqi, li}.
In one example, N=3, and the CSI report type indicated by a preamble (e.g., according to the set of the preamble(s)) can be one of {cqi, cri, li}.
In one example, N=4, and the CSI report type indicated by a preamble (e.g., according to the set of the preamble(s)) can be one of {ri, cqi, cri, li}.

In addition, a CSI report type can additionally be a precoding matrix indicator (PMI), a number of antenna ports and/or a number of non-zero coefficients.

In one example, configuration of the number of preamble groups for indication of CSI report type(s), the preambles and/or ROs associated with each group (per SS/PBCH block or across SS/PBCH blocks), and CSI report type (or set of CSI report types) associated with each group can be configured and/or updated by SIB and/or RRC and/or MAC CE and/or L1 control (e.g., DCI Format) signaling.

In one example, for indication of N CSI report type codepoints (or N CSI report types), a set of preambles and/or ROs is configured for each codepoint of the N codepoints (or for each of the N CSI report types). Each set of preambles and/or ROs can be per-SS/PBCH block, or can be common across SS/PBCH blocks.

In one example, M preambles (e.g., each preamble can be associated with index j=0, . . . , M−1) in one or more ROs (or M preambles per SSB in a RO or M preambles per SSB per preamble group (group A and group B wherein group A and group B indicates different Msg3/MsgA size) in a RO) are allocated for early CSI indication, the M preambles are divided into N groups (e.g., each group can have index i=0,1, . . . , N−1) of preambles, for indication of N CSI report type codepoints (or N CSI report types). In one example, M is a multiple of N, and each group i, wherein i=0, 1, . . . , N−1 has M/N preambles. In one example, the preambles in group i can have index

$$j = i * \frac{N}{M} + k , where$$

$$k = 0 , 1 , … , \frac{M}{N} - 1 .$$

In one example, the number of preambles per group is

$$⌊ \frac{M}{N} ⌋ .$$

In one example, the preambles in group i can have index

$$j = i * ⌊ \frac{M}{N} ⌋ + k , where$$

$$k = 0 , 1 , … , ⌊ \frac{M}{N} ⌋ - 1 .$$

In one example, the number of preambles per group is

$$⌈ \frac{M}{N} ⌉$$

for group i, if i<(M % N), and

$$⌊ \frac{M}{N} ⌋$$

for group i, if i≥(M % N), where % is the modulo operator, that is the remainder of M divided by N. In one example, the preambles in group i, for i<(M % N), can have index

$$j = i * ⌈ \frac{M}{N} ⌉ + k , where$$

$$k = 0 , 1 , … , ⌈ \frac{M}{N} ⌉ - 1 .$$

In one example, the preambles in group i, for i≥(M % N), can have index

$$j = ( M \% N ) + i * ⌊ \frac{M}{N} ⌋ + k , where$$

$$k = 0 , 1 , … , ⌊ \frac{M}{N} ⌋ - 1 .$$

A UE can indicate the support of early SRS and/or the UE's support of CSI report type(s) for early CSI in Msg3 or MsgA PUSCH. In one example, the UE is configured with “groupBconfigured” random access preambles for group B. In one example, the Msg3 or MsgA PUSCH payload size when the UE transmits random access preamble for group B is larger than the Msg3 or MsgA PUSCH payload size when the UE transmits random access preamble for group A. In one example, the network allocates time and frequency resources and MCS for a payload size of RACH Msg3 or MsgA PUSCH that is large enough for the UE to report UE's early CSI capability and/or the UE's support of CSI report type(s) for early CSI.

In one example, UE could report in RACH Msg3 or MsgA PUSCH support or not support of early CSI. For example, a one-bit flag can indicate early CSI is not supported (e.g., value 0), or early CSI is supported (e.g., value 1). In a variant example, a one-bit flag can indicate early CSI is not supported (e.g., value 1), or early CSI is supported (e.g., value 0).

According to those specified/defined herein in the present disclosure, UE could report in RACH Msg3 or MsgA PUSCH UE's early CSI capability and/or the UE's support of CSI report type(s) for early CSI according to one or more of:
In one example, the UE could report in RACH Msg3 or MsgA PUSCH one of {ri for a rank indicator as a CSI report type, early CSI not supported}.
In one example, the UE could report in RACH Msg3 or MsgA PUSCH one of {cqi for a channel quality indicator as a CSI report type, early CSI not supported}.
In one example, the UE could report in RACH Msg3 or MsgA PUSCH one of {cri for a CSI-RS resource indicator as a CSI report type, early CSI not supported}.
In one example, the UE could report in RACH Msg3 or MsgA PUSCH one of {li for a layer indicator as a CSI report type, early CSI not supported}.
In one example, the UE could report in RACH Msg3 or MsgA PUSCH one of {ri, cqi, early CSI not supported}.
In one example, the UE could report in RACH Msg3 or MsgA PUSCH one of {ri, cri, early CSI not supported}.
In one example, the UE could report in RACH Msg3 or MsgA PUSCH one of {ri, li, early CSI not supported}.
In one example, the UE could report in RACH Msg3 or MsgA PUSCH one of {cqi, cri, early CSI not supported}.
In one example, the UE could report in RACH Msg3 or MsgA PUSCH one of {cqi, li, early CSI not supported}.
In one example, the UE could report in RACH Msg3 or MsgA PUSCH one of {cri, li, early CSI not supported}.
In one example, the UE could report in RACH Msg3 or MsgA PUSCH one of {ri, cqi, cri, early CSI not supported}.
In one example, the UE could report in RACH Msg3 or MsgA PUSCH one of {ri, cqi, li, early CSI not supported}.
In one example, the UE could report in RACH Msg3 or MsgA PUSCH one of {cqi, cri, li, early CSI not supported}.
In one example, the UE could report in RACH Msg3 or MsgA PUSCH one of {ri, cqi, cri, li, early CSI not supported}.

In the following examples, as described, a UE can indicate the support of early CSI and/or the UE's support of CSI report type(s) for early CSI in Msg3 or MsgA PUSCH. In one example, using a specific LCID/eLCID in MAC subheader of CCCH SDU included in Msg3/MsgA MAC PDU can indicate the support of early CSI and/or the UE's support of CSI report type(s) for early CSI.

In one example, a same preamble is used whether or not the UE supports early CSI. The CSI report type(s) can be indicated in Msg3 or MsgA PUSCH/MAC PDU. In one example a set of preambles and/or ROs are configured for the UE to indicate early CSI (UE can randomly select a preamble/RO from the set for early CSI support indication), as aforementioned. The set of preambles and/or ROs can be per-SS/PBCH block, or can be common across SS/PBCH blocks.

In one example, LCID/eLCID codepoint (e.g. in MAC subheader of CCCH SDU included in Msg3/MsgA) is configured for indicating the support of early CSI capability. In one example, the LCID/eLCID codepoint (e.g. in MAC subheader of CCCH SDU included in Msg3/MsgA) can be configured separately for different CCCH SDU sizes (e.g. 48 bits and 64 bits) for indicating the support of early CSI capability. In one example LCID/eLCID codepoint for indicating the support of early CSI capability can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

In one example, N LCID/eLCIDs codepoints (e.g. in MAC subheader of CCCH SDU included in Msg3/MsgA) are configured for indicating the support of CSI report type(s). In one example, N LCID/eLCIDs codepoints (e.g. in MAC subheader of CCCH SDU included in Msg3/MsgA) can be configured separately for different CCCH SDU sizes (e.g. 48 bits and 64 bits) for indicating the support of CSI report type(s). In one example N LCID/eLCIDs codepoints for indicating the support of CSI report type(s) can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

According to or following those specified/defined herein in the present disclosure,
In one example, N=1, and the CSI report type indicated by a LCID/eLCID codepoint can be {ri} for a rank indicator.
In one example, N=1, and the CSI report type indicated by a LCID/eLCID codepoint can be {cqi} for a channel quality indicator.
In one example, N=1, and the CSI report type indicated by a LCID/eLCID codepoint can be {cri} for a CSI-RS resource indicator.
In one example, N=1, and the CSI report type indicated by a LCID/eLCID codepoint can be {li} for a layer indicator.
In one example, N=2, and the CSI report type indicated by a LCID/eLCID codepoint can be one of {ri, cqi}.
In one example, N=2, and the CSI report type indicated by a LCID/eLCID codepoint can be one of {ri, cri}.
In one example, N=2, and the CSI report type indicated by a LCID/eLCID codepoint can be one of {ri, li}.
In one example, N=2, and the CSI report type indicated by a LCID/eLCID codepoint can be one of {cqi, cri}
In one example, N=2, and the CSI report type indicated by a LCID/eLCID codepoint can be one of {cqi, li}
In one example, N=2, and the CSI report type indicated by a LCID/eLCID codepoint can be one of {cri, li} ° In one example, N=3, and the CSI report type indicated by a LCID/eLCID codepoint can be one of {ri, cqi, cri}.
In one example, N=3, and the CSI report type indicated by a LCID/eLCID codepoint can be one of {ri, cqi, li}.
In one example, N=3, and the CSI report type indicated by a LCID/eLCID codepoint can be one of {cqi, cri, li}.
In one example, N=4, and the CSI report type indicated by a LCID/eLCID codepoint can be one of {ri, cqi, cri, li}.

Furthermore,
In one example, the early CSI capability and/or UE's support of CSI report type(s) can be indicated in Msg3 or MsgA PUSCH by including a MAC CE (e.g. early CSI capability MAC CE) in Msg3 or MsgA MAC PDU wherein the MAC PDU include CCCH SDU and the MAC CE. One or more fields in the MAC CE indicate early CSI capability and/or UE's support of CSI report type(s). In one example, UE can indicate that it supports early CSI acquisition through the PRACH preamble and in response the network provides large enough grant in random access response to transmit Msg3 including UE's other early CSI capabilities such as UE's support of CSI report type(s) in MAC CE.
In one example, the early CSI capability can be indicated by LCID/eLCID of CCCH SDU in Msg3 or MsgA PUSCH/MAC PDU and UE's other early CSI capabilities such as UE's support of CSI report type(s) for early CSI can be indicated by a MAC CE in Msg3 or MsgA PUSCH/MAC PDU.
In one example, the early CSI capability and/or UE's support of CSI report type(s) can be indicated in Msg3 or MsgA PUSCH/MAC PDU in LCID/eLCID of CCCH SDU.
In one example, the early CSI capability and/or UE's support of CSI report type(s) can be indicated in Msg3 or MsgA PUSCH/MAC PDU by a combination of LCID/eLCID of CCCH SDU and MAC CE (e.g., using one or more new fields).

CSI measurement and/or reporting could be triggered in the random access response (RAR) (e.g., Msg2) to a preamble transmission. In one example, the CSI measurement and/or reporting is triggered in the random access response (RAR) (e.g., Msg2) to a preamble transmission for a contention based random access procedure. In one example, the CSI measurement and/or reporting is triggered in the random access response (RAR) (e.g., Msg2) to a preamble transmission for a contention free random access procedure. In one example, the CSI measurement and/or reporting is triggered in a RAR if the UE supports early CSI acquisition. In one example, the indication of the support of early CSI is indicated by the preamble and/or PRACH Occasion (RO) used for the random access procedure. For example, the preambles and/or ROs can be partitioned into 2 groups g₀, g₁, if a UE doesn't support early CSI or doesn't request early CSI, a preamble and/or RO in the first group is used (e.g. g₀), if a UE supports early CSI or supports and requests early CSI, a preamble and/or RO in the second group is used (e.g. g₁). In a variant example, there are N groups of preambles and/or ROs, as aforementioned, wherein the N groups can indicate the UE's capability to support or not support early CSI, and/or the capability of the UE in regard to their support of CSI report type(s) for early CSI acquisition as aforementioned.

In one example, a UE is configured e.g., by a field or flag in the system information to perform (early) CSI measurement and/or reporting in response to receiving a RAR. The (early) CSI measurement and/or reporting can be further conditioned on whether the UE transmits an associated PRACH preamble/RO from a first group of preambles/ROs or from a second group of preambles/ROs indicated in the system information. In one example, if a UE is configured by system information with a first set of preambles/ROs for “no early CSI” and a second of preambles/ROs for “early CSI”, the UE can:
If the UE transmits a preamble/RO associated with “no early CSI”, the UE doesn't expect to receive a trigger for early CSI in the RAR. In a variant example, if a UE receives a trigger for early CSI in the RAR, the UE ignores the trigger.
In one example, if the UE transmits a preamble/RO associated with “early CSI”, the RAR doesn't include a flag for early CSI measurement and/or reporting trigger, the UE could perform CSI measurement and/or reporting upon receiving the RAR.
In one example, if the UE transmits a preamble/RO associated with “early CSI”, the RAR includes a flag for early CSI measurement and/or reporting trigger, based on the flag the UE performs or does not perform CSI measurement and/or reporting upon receiving the RAR.

In one example, a UE is indicated in the RAR to perform CSI measurement and/or reporting. In one example, a flag or a field in the RAR can indicate whether the UE could perform CSI measurement and/or reporting in response to receiving the RAR. In one example, a field in the MAC sub-header for Random Access Response, e.g., a reserved field in the MAC sub-header for the Random Access Response can be used to trigger the early CSI, for example, a value of “1” triggers the (early) CSI measurement and/or reporting, and a value of “0” doesn't trigger the (early) CSI measurement and/or reporting. In one example, a field in the MAC RAR, e.g., a reserved field in the MAC RAR can be used to trigger the (early) CSI measurement and/or reporting, for example, a value of “1” triggers the (early) CSI measurement and/or reporting, and a value of “0” doesn't trigger the early CSI measurement and/or reporting.

In one example, a UE is indicated by a flag (e.g., one-bit flag) or a special bit pattern in the RAR to perform CSI measurement and/or reporting. In one example, the UE could measure CSI-RS(s) and/or transmit CSI report(s) instead of or in place of PUSCH Msg3. In one example, the UE could measure CSI-RS(s) and/or transmit CSI report(s) in addition to PUSCH Msg3 (before or after PUSCH Msg3). In one example, the flag (e.g., one-bit flag) is included in the MAC sub-header for the Random Access Response, e.g., for Type-1 Random Access Procedure. In one example, the flag (e.g., one-bit flag) is included in the MAC RAR, e.g., for Type-1 Random Access Procedure. In one example, the flag (e.g., one-bit flag) is included in the UL Grant of the MAC RAR, e.g., for Type-1 Random Access Procedure. In one example, a special bit pattern of fields in the UL Grant of the MAC RAR, e.g., for Type-1 Random Access Procedure, indicates (early) CSI measurement and/or reporting. In one example, the flag (e.g., one-bit flag) is included in the DCI scheduling PDSCH of the MAC RAR. In one example, a special bit pattern of fields in the DCI scheduling the PDSCH of the MAC RAR indicates (early) CSI measurement and/or reporting.

In one example, a UE is indicated information related to one or more CSI-RS resources and/or CSI reporting setting(s) in the RAR to use for CSI measurement and/or reporting. In one example, the UE could measure CSI-RS(s) and/or transmit CSI report(s) instead of or in place of PUSCH Msg3. In one example, the UE could measure CSI-RS(s) and/or transmit CSI report(s) in addition to PUSCH Msg3 (before or after PUSCH Msg3). In one example, the information is included in the MAC RAR, e.g., for Type-1 Random Access Procedure. In one example, the information is included in the UL Grant of the MAC RAR, e.g., for Type-1 Random Access Procedure. In one example, the information is included in the DCI scheduling the PDSCH of the MAC RAR. In one example, the information is linked to (associated with) the preamble index. In one example, the information is linked to (associated with) the PRACH occasion. In one example, the information is linked to (associated with) the preamble index and the PRACH occasion. In one example, the preambles and/or ROs are portioned into N groups as aforementioned, the UE can determine the CSI-RS resource(s) to measure and/or CSI reporting setting(s) based on the group of the preamble and/or RO, in one example, one of the groups can be associated with no early CSI acquisition. In one example, the information includes a CSI-RS resource ID/index and/or CSI resource set ID/index configured to the UE from a list of CSI-RS resources and/or a list of CSI resource sets configured to the UE, wherein the configuration can be by SIB signaling or by RRC signaling. In one example, the information includes configuration/scheduling parameters for the (early) CSI measurement and/or reporting, such as time domain resources (e.g., symbol(s) in a slot to use for CSI measurement/reporting, time offset from the RAR, time offset from Msg3, or time offset within a period, CSI-RS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the resource(s) for CSI reporting.

TABLE 3

| | Signaling medium(s) that | |
|---|---|---|
| | can indicate the flag (e.g., | Signaling medium(s) that |
| Example | one-bit flag) or special | can indicate the |
| number | pattern | information |
| Example 1 | MAC RAR | MAC RAR |
| Example 2 | MAC RAR | UL grant included in MAC RAR |
| Example 3 | MAC RAR | DCI Format scheduling PDSCH |
| | | of MAC RAR |
| Example 4 | UL grant included in MAC | MAC RAR |
| | RAR | |
| Example 5 | UL grant included in MAC | UL grant included in MAC RAR |
| | RAR | |
| Example 6 | UL grant included in MAC | DCI Format scheduling PDSCH |
| | RAR | of MAC RAR |
| Example 7 | DCI Format scheduling | MAC RAR |
| | PDSCH of MAC RAR | |
| Example 8 | DCI Format scheduling | UL grant included in MAC RAR |
| | PDSCH of MAC RAR | |
| Example 9 | DCI Format scheduling | DCI Format scheduling PDSCH |
| | PDSCH of MAC RAR | of MAC RAR |

In one example, a UE is indicated by a flag (e.g., one-bit flag) or a special bit pattern in the RAR to perform CSI measurement and/or reporting and is indicated the aforementioned information in the RAR. In one example, the UE could measure CSI-RS(s) and/or transmit CSI report(s) instead of or in place of PUSCH Msg3. In one example, the UE could measure CSI-RS(s) and/or transmit CSI report(s) in addition to PUSCH Msg3 (before or after PUSCH Msg3). In one example, the information includes a CSI-RS resource ID and/or CSI resource set ID configured to the UE from a list of CSI-RS resources and/or a list of CSI resource sets configured to the UE, wherein the configuration can be by SIB signaling or by RRC signaling. In one example, the information includes configuration/scheduling parameters for the (early) CSI measurement and/or reporting, such as time domain resources (e.g., symbol(s) in a slot to use for CSI measurement/reporting, time offset from the RAR, or time offset within a period, CSI-RS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the resource(s) for CSI reporting. The indication of the flag (e.g., one-bit flag) or special pattern and the information can follow one of the examples of Table 3.

In one example, information related to M CSI-RS resources for CSI measurement and/or CSI reporting setting(s) for CSI reporting are configured by system information. In one example, the CSI resource set ID/index and/or the CSI-RS resource ID/index used by a UE for CSI measurement is determined based on one or more of the following:
Based on a TC-RNTI conveyed by the RAR, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in or determined by a paging message that triggered the random access procedure associated with the RAR.
Based on the C-RNTI (or UE-ID), in Msg3, the UE and the gNB can identify a CSI-RS resource (e.g., CSI-RS resource in a stored context associated with the C-RNTI or the UE-ID)
Based on the preamble index associated with the RAR.
Based on the PRACH occasion (RO) associated with the RAR.
Based on the preamble index and PRACH occasion (RO) associated with the RAR.
Based on the group of the preamble and/or RO associated with the RAR as aforementioned.
Based on the CSI report type(s) or a default CSI report type if the CSI report type(s) is unknown at the time of early CSI triggering and/or (early) CSI measurement and/or reporting.
The time and/or frequency resources of a PDCCH reception providing a DCI format scheduling a RAR or of the PDSCH reception providing the RAR.

In one example, the network configures CSI-RS resource(s) for each preamble-ID. In one example, the network configures CSI-RS resource(s) for each RO within a frame. In one example, the network configures CSI-RS resource(s) for each RO within an association period. In one example, the network configures CSI-RS resource(s) for each RO within an association pattern period. In one example, the network configures CSI-RS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures CSI-RS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the CSI-RS resource ID (and/or CSI resource set ID) and the aforementioned parameters is based on a rule. In one example, this mapping between the CSI-RS resource ID (and/or CSI-RS resource set ID) and the aforementioned parameters is based on a network configuration. In one example, this mapping between the CSI-RS resource ID (and/or CSI resource set ID) and the aforementioned parameters is based on a combination of a rule and network configuration.

In one example, the CSI-RS resource ID (and/or CSI resource set ID) transmitted by a UE is determined based on one or more of the following:
A CSI-RS ID of the M CSI-RS resource IDs (and/or CSI resource set IDs) configured by system information, wherein the CSI-RS resource ID (and/or CSI resource set ID) is included in the DCI Format scheduling the RAR and/or the RAR.
In a variant, the CSI configuration parameters (or a subset of them) for the CSI-RS resource can be included in the DCI Format scheduling the RAR and/or the RAR instead of or in addition to the CSI-RS ID. Wherein the configuration parameters for the CSI-RS resource can be as aforementioned

In one example, the UE could measure/receive the CSI-RS(s) and/or transmit the corresponding CSI report(s) at or after a time T after the end (or start) of the PDSCH reception providing the RAR or of end (or start) of the PDCCH reception providing the DCI Format scheduling the RAR associated with the UE. In one example, the slot or subframe or frame used to measure/receive the CSI-RS(s) and/or transmit the corresponding CSI report(s) can be at or after a time T after the end (or start) of PDSCH reception providing the RAR or of end (or start) of the PDCCH reception providing the DCI Format scheduling the RAR associated with the UE. In one example, the slot or subframe or frame used to measure/receive the CSI-RS(s) and/or transmit the corresponding CSI report(s) is that first slot or subframe or frame that starts at or after a time T after the end (or start) of PDSCH reception providing the RAR or of end (or start) of PDCCH reception providing the DCI Format scheduling the RAR associated with the UE transmitting SRS and optionally based on an offset and a periodicity, where (early) CSI trigger can be replaced by the PDSCH providing the RAR or the PDCCH providing the DCI Format scheduling the RAR associated with the UE. Wherein, the time T can be defined in the system specifications and/or configured or updated by network (e.g., using SIB signaling and/or RRC signaling and/or MAC CE signaling and/or L1 control signaling).

In one example, the RAR and/or DCI scheduling the RAR includes a flag to trigger CSI measurement and/or reporting. The UE could measure/receive CSI-RS(s) and/or transmit the corresponding CSI report(s) after RACH Msg3. In one example, the UE has a stored context, and the store context is associated with a C-RNTI (or a UE ID), for example the UE is in INACTIVE state. In one example, the UE transmits a C-RNTI MAC CE (or UE ID) in the Msg3, based on the C-RNTI (or UE-ID) the UE and the gNB can identify a CSI-RS resource and/or resource for CSI reporting (e.g., CSI-RS resource and/or resource for CSI reporting in a stored context associated with the C-RNTI or the UE-ID).

In one example, the RAR and/or DCI scheduling the RAR includes a flag to trigger CSI measurement and/or reporting. The UE could measure/receive CSI-RS(s) and/or transmit the corresponding CSI report(s) after RACH Msg3. In one example, Msg3 can convey UE's capability of early CSI acquisition and/or UE's support of CSI report type(s). In a variant example, the UE's capability of early CSI acquisition and/or UE's support of CSI report type(s) could be conveyed by a combination of signaling in the preamble/RO (e.g., based on preamble and/or RO group as aforementioned) and signaling in Msg3. In one example, early CSI acquisition capability in Msg3 is indicated by 1 bit in RRC message or using a specific LCID/eLCID in MAC PDU.

In one example, if the RAR includes a trigger for early CSI measurement and/or reporting, Msg3 can further include an indication whether or not the UE is performing CSI-RS measurement(s)/reception(s) and/or transmitting the corresponding CSI report(s).

In one example, the UE could measure/receive the CSI-RS(s) and/or transmit the corresponding CSI report(s) at or after a time T after the end (or start) of the PUSCH transmission containing Msg3 associated with the UE. In one example, the slot or subframe or frame used to measure/receive the CSI-RS(s) and/or transmit the corresponding CSI report(s) can be at or after a time T after the end (or start) of the PUSCH transmission containing Msg3 associated with the UE. In one example, the slot or subframe or frame used to measure/receive the CSI-RS(s) and/or transmit the corresponding CSI report(s) is that first slot or subframe or frame that starts at or after a time T after the end (or start) of the PUSCH transmission containing Msg3 associated with the UE and optionally based on an offset and a periodicity, where early CSI acquisition trigger can be replaced by the PUSCH transmission containing Msg3 associated with the UE. Wherein, the time T can be defined in the system specifications and/or configured or updated by network (e.g., using SIB signaling and/or RRC signaling and/or MAC CE signaling and/or L1 control signaling).

In one example, CSI measurement and/or reporting could be triggered in contention resolution message providing a C-RNTI for the UE, or in Msg4, of a random access procedure. In one example, CSI measurement and/or reporting is triggered in contention resolution message or Msg4 of a contention-based random access procedure. In one example, the CSI measurement and/or reporting is triggered in a Msg4 if the UE supports early CSI acquisition capability(s). In one example, the indication of the support of early CSI is indicated by the preamble and/or PRACH Occasion (RO) used for the random access procedure. For example, the preambles and/or ROs can be partitioned into 2 groups g₀, g₁, if a UE doesn't support early CSI or doesn't request early CSI, a preamble and/or RO in the first group is used (e.g. g₀), if a UE supports early CSI or supports and requests early CSI, a preamble and/or RO in the second group is used (e.g. g₁). In a variant example, there are N groups of preambles and/or ROs, as aforementioned, wherein the N groups can indicate the UE's capability to support or not support early CSI, and/or the capability of the UE in regard to their support of CSI report type(s) as aforementioned.

In one example, the indication of the support of early CSI is indicated by Msg3 (or MsgA) of the random access procedure. Support of early CSI can be indicated in MAC subheader (e.g. by using a pre-defined LCID or eLCID) or MAC CE or RRC message (e.g. RRC setup request or RRC resume request) included in Msg3/MsgA MAC PDU. In a variant example, Msg3 can indicate the UE's capability to support or not support early CSI, and/or the capability of the UE in regard to their support of CSI report type(s) as aforementioned. In a variant example, the UE's capability to support or not support early CSI, and/or the support of CSI report type(s) is conveyed by a combination of signaling in the preamble/RO (e.g., based on preamble and/or RO group as aforementioned) and signaling in Msg3.

In one example, a UE is configured e.g., by a field or flag in the system information to perform (early) CSI measurement and/or reporting in response to receiving a contention resolution message, or in Msg4, or in a DCI Format scheduling Msg4 or MsgB. The (early) CSI measurement and/or reporting can be further conditioned on whether the UE transmits an associated PRACH preamble from a first group of preambles or from a second group of preambles indicated in the system information. In one example, if a UE is configured by system information with a first set of preamble for “no early CSI” and a second of preambles for “early CSI”, the UE can:
If the UE transmits a preamble associated with “no early CSI”, the UE doesn't expect to receive a trigger for early CSI in a contention resolution message, or in Msg4, or in a DCI Format scheduling Msg4. In a variant example, if a UE receives a trigger for early CSI in a contention resolution message, or in Msg4, or in a DCI Format scheduling Msg4, the UE ignores the trigger.
In one example, if the UE transmits a preamble associated with “early CSI”, the contention resolution message, or Msg4, or DCI Format scheduling Msg4 doesn't include a flag for early CSI trigger, the UE could measure/receive CSI-RS(s) and/or transmit the corresponding CSI report(s) upon receiving the contention resolution message, or Msg4, or DCI Format scheduling Msg4.
In one example, if the UE transmits a preamble associated with “early CSI”, the contention resolution message, or Msg4, or DCI Format scheduling Msg4 includes a flag for early CSI trigger, based on the flag the UE performs or does not perform CSI measurement and/or reporting upon receiving the contention resolution message, or Msg4, or DCI Format scheduling Msg4.

For brevity, only the contention resolution message is referred to in the following.

In one example, a UE is indicated in the contention resolution message to measure/receive CSI-RS(s) and/or transmit CSI report(s). In one example, a flag or a field in the contention resolution message can indicate whether the UE measures/receives CSI-RS(s) and/or transmits CSI report(s) in response to receiving the contention resolution message.

In one example, a MAC CE in the contention resolution message can provide a configuration for CSI measurement and/or reporting by the UE.

In one example, information related to M CSI-RS resources for CSI measurement and/or CSI reporting setting(s) are configured by system information. In one example, the CSI-RS resource ID (and/or CSI resource set ID) used by a UE for CSI measurement is determined based on one or more of the following:
Based on a C-RNTI conveyed by the contention resolution, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a CSI-RS resource (e.g., CSI-RS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the contention resolution.
Based on the preamble index associated with the random access procedure.
Based on the PRACH occasion (RO) associated with the RAR.
Based on the preamble index and PRACH occasion (RO) associated with the RAR.
Based on the group of the preamble and/or RO associated with the RAR as aforementioned.
Based on signaling in Msg3.
Based on the CSI report type(s) or a default CSI report type if CSI report type(s) is unknown at the time of early CSI triggering and/or (early) CSI measurement and/or reporting.
The time and/or frequency resources of a DCI format scheduling a contention resolution or of the contention resolution.
Based on the resource used for HARQ-ACK acknowledgment of contention resolution.
Based on an information provided by a MAC CE in the contention resolution message.

In one example, the network configures CSI-RS resource(s) for each preamble-ID. In one example, the network configures CSI-RS resource(s) for each RO within a frame. In one example, the network configures CSI-RS resource(s) for each RO within an association period. In one example, the network configures CSI-RS resource(s) for each RO within an association pattern period. In one example, the network configures CSI-RS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures CSI-RS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the CSI-RS resource ID (and/or CSI resource set ID) and the aforementioned parameters is based on a rule. In one example, this mapping between the CSI-RS resource ID (and/or CSI resource set ID) and the aforementioned parameters is based on a network configuration. In one example, this mapping between the CSI-RS resource ID (and/or CSI resource set ID) and the aforementioned parameters is based on a combination of a rule and network configuration.

In one example, the CSI-RS resource ID (and/or CSI resource set ID) transmitted by a UE is determined based on one or more of the following:
A CSI-RS ID of the M CSI-RS resource IDs (and/or CSI resource set IDs) configured by system information, wherein the CSI-RS resource ID (and/or CSI resource set ID) is included in the DCI Format scheduling the contention resolution and/or in the contention resolution message.
In a variant, the CSI configuration parameters (or a subset of them) for the CSI-RS resource can be included in the DCI Format scheduling the contention resolution message and/or in the contention resolution message instead of or in addition to the CSI-RS ID. Wherein the configuration parameters for the CSI-RS resource can be as aforementioned

In one example, the UE could measure/receive the CSI-RS(s) and/or transmit the corresponding CSI report(s) at or after a time T after the end (or start) of the PDSCH reception providing the contention resolution message or of the PDCCH reception providing the DCI Format scheduling the contention resolution message associated with the UE. In one example, the slot or subframe or frame used to measure/receive the CSI-RS(s) and/or transmit the corresponding CSI report(s) can be at or after a time T after the end (or start) of the PDSCH reception providing the contention resolution message or of the PDCCH reception providing the DCI Format scheduling the contention resolution message associated with the UE. In one example, the slot or subframe or frame used to measure/receive the CSI-RS(s) and/or transmit the corresponding CSI report(s) is that first slot or subframe or frame that starts at or after a time T after the end (or start) of the PDSCH reception providing the contention resolution message or of the PDCCH reception providing the DCI Format scheduling the contention resolution message associated with the UE and optionally based on an offset and a periodicity, where (early) CSI trigger can be replaced by the PDSCH providing the contention resolution message or the PDCCH providing the DCI Format scheduling the contention resolution message associated with the UE. Wherein, the time T can be defined in the system specifications and/or configured or updated by network (e.g., using SIB signaling and/or RRC signaling and/or MAC CE signaling and/or L1 control signaling).

CSI measurement and/or reporting could be triggered in MsgB of a Type-2 random access procedure. In one example, MsgB is for successRAR. In one example, MsgB is for a fallback RAR. In one example, the CSI measurement and/or reporting is triggered in MsgB successRAR of a contention-based random access procedure. In one example, the CSI measurement and/or reporting is triggered in MsgB fallbackRAR of a contention-free random access procedure. In one example, the CSI measurement and/or reporting is triggered in a successRAR or fallbackRAR if the UE supports early CSI acquisition. In one example, the indication of the support of early CSI acquisition is indicated by the preamble and/or PRACH Occasion (RO) used for the Type-2 random access procedure. For example, the preambles and/or ROs of the MsgA PRACH can be partitioned into 2 groups g₀, g₁, if a UE doesn't support early CSI or doesn't request early CSI, a preamble and/or RO in the first group is used (e.g. g₀), if a UE supports early CSI or supports and requests early CSI acquisition, a preamble and/or RO in the second group is used (e.g. g₁). In a variant example, there are N groups of preambles and/or ROs, as aforementioned, wherein the N groups can indicate the UE's capability to support or not support early CSI, and/or the capability of the UE in regard to their support of CSI report type(s) as aforementioned.

In one example, the indication of the support of early CSI acquisition is indicated by MsgA PUSCH of the random access procedure. In a variant example, MsgA PUSCH can indicate the UE's capability to support or not support early CSI, and/or the capability of the UE in regard to their support of CSI report type(s) as aforementioned. In a variant example, the UE's capability to support or not support early CSI, and/or the their support of CSI report type(s) is conveyed by a combination of signaling in the preamble/RO of MsgA PRACH (e.g., based on preamble and/or RO group as aforementioned) and signaling in MsgA PUSCH. In one example, early CSI capability in MsgA is indicated by 1 bit in RRC message or using a specific LCID/eLCID in MAC PDU.

In one example, a UE is configured e.g., by a field or flag in the system information to perform CSI measurement and/or reporting in response to receiving a MsgB. The (early) CSI measurement and/or reporting can be further conditioned on whether the UE transmits an associated MsgA PRACH preamble/RO from a first group of preambles/ROs or from a second group of preambles/ROs indicated in the system information. In one example, if a UE is configured by system information with a first set of preamble for “no early CSI” and a second of preambles for “early CSI”, the UE can:
If the UE transmits a preamble/RO associated with “no early CSI”, the UE doesn't expect to receive a trigger for early CSI in the successRAR or fallbackRAR. In a variant example, if a UE receives a trigger for early CSI in the successRAR or fallbackRAR, the UE ignores the trigger.
In one example, if the UE transmits a preamble/RO associated with “early CSI”, the successRAR or fallbackRAR doesn't include a flag for early CSI trigger, the UE could measure/receive CSI-RS(s) and/or transmit the corresponding CSI report(s) upon receiving the successRAR or fallbackRAR.
In one example, if the UE transmits a preamble/RO associated with “early CSI”, the successRAR or fallbackRAR includes a flag for early CSI trigger, based on the flag the UE performs or does not perform CSI measurement and/or reporting upon receiving the successRAR or fallbackRAR.

In one example, a UE is indicated in the MsgB to perform CSI measurement and/or reporting. In one example, a flag or a field in the MsgB can indicate whether the UE could perform CSI measurement and/or reporting in response to receiving the MsgB. In one example, MsgB can include a fallback RAR. In one example, MsgB can include a success RAR. In one example, a field in the MAC sub-header for success RAR or the fallback RAR, e.g., a reserved field in the MAC sub-header for the success RAR or fallback RAR can be used to trigger the CSI acquisition, for example, a value of “1” triggers the CSI, and a value of “0” doesn't trigger the CSI. In one example, a field in the success RAR or fallback RAR, e.g., a reserved field in the success RAR or fallback RAR can be used to trigger the CSI, for example, a value of “1” triggers the CSI, and a value of “0” doesn't trigger the CSI.

In one example, a UE is indicated by a flag (e.g., one-bit flag) or a special bit pattern in the MsgB (e.g., fallbackRAR or successRAR) to perform CSI measurement and/or reporting. In one example, the UE could measure/receive CSI-RS(s) and/or transmit CSI report(s) instead of or in place of PUSCH Msg3. In one example, the UE could measure/receive CSI-RS(s) and/or transmit CSI report(s) in addition to PUSCH Msg3, e.g., scheduled by fallbackRAR, (before or after PUSCH Msg3). In one example, the flag (e.g., one-bit flag) is included in the MAC sub-header for the success RAR or fallback RAR, e.g., for Type-2 Random Access Procedure. In one example, the flag (e.g., one-bit flag) is included in MsgB (e.g., fallbackRAR or successRAR), e.g., for Type-2 Random Access Procedure. In one example, the flag (e.g., one-bit flag) is included in the UL Grant of MsgB (e.g., fallbackRAR), e.g., for Type-2 Random Access Procedure. In one example, a special bit pattern of fields in the UL Grant of MsgB (e.g., fallbackRAR), e.g., for Type-2 Random Access Procedure, indicates (early) CSI measurement and/or reporting. In one example, the flag (e.g., one-bit flag) is included in the DCI scheduling PDSCH of MsgB (e.g., fallbackRAR or successRAR). In one example, a special bit pattern of fields in the DCI scheduling the PDSCH of MsgB (e.g., fallbackRAR or successRAR) indicates (early) CSI measurement and/or reporting.

In one example, a UE is indicated information related to one or more CSI-RS resources and/or CSI reporting setting(s) in MsgB (e.g., fallbackRAR or successRAR) to use for CSI measurement and/or reporting. In one example, the UE could measure CSI-RS(s) and/or transmit CSI report(s) instead of or in place of PUSCH Msg3. In one example, the UE could measure CSI-RS(s) and/or transmit CSI report(s) in addition to PUSCH Msg3, e.g., scheduled by fallbackRAR, (before or after PUSCH Msg3). In one example, the information is included in MsgB (e.g., fallbackRAR or successRAR), e.g., for Type-2 Random Access Procedure. In one example, the information is included in the UL Grant of MsgB (e.g., fallbackRAR), e.g., for Type-2 Random Access Procedure. In one example, the information is included in the DCI scheduling the PDSCH of MsgB (e.g., fallbackRAR or successRAR). In one example, the information is linked to (associated with) the preamble index. In one example, the information is linked to (associated with) the PRACH occasion. In one example, the information is linked to (associated with) the preamble index and the PRACH occasion. In one example, the preambles and/or ROs of MsgA PRACH are portioned into N groups as aforementioned, the UE can determine the information based on the group of the preamble and/or RO, in one example, one of the groups can be associated with no early CSI acquisition. In one example, the information includes a CSI-RS resource ID/index and/or CSI resource set ID/index configured to the UE from a list of CSI-RS resources and/or a list of CSI resource sets configured to the UE, wherein the configuration can be by SIB signaling or by RRC signaling. In one example, the information includes configuration/scheduling parameters for the (early) CSI measurement and/or reporting, such as time domain resources (e.g., symbol(s) in a slot to use for CSI measurement/reporting, time offset from MsgB (e.g., fallbackRAR or successRAR), or time offset within a period, CSI-RS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the resource(s) for CSI reporting. In one example, the successRAR includes an UL grant with parameters to schedule the resource(s) for CSI reporting.

TABLE 4

| | Signaling medium(s) that | |
|---|---|---|
| | can indicate the flag (e.g., | Signaling medium(s) that |
| Example | one-bit flag) or special | can indicate the |
| number | pattern | information |
| Example 1 | MsgB (e.g., fallbackRAR | MsgB (e.g., fallbackRAR or |
| | or successRAR) | successRAR) |
| Example 2 | MsgB (e.g., fallbackRAR | UL grant included in MsgB |
| | or successRAR) | (e.g., fallbackRAR) |
| Example 3 | MsgB (e.g., fallbackRAR | DCI Format scheduling PDSCH |
| | or successRAR) | of MsgB (e.g., fallbackRAR |
| | | or successRAR) |
| Example 4 | UL grant included in MsgB | MsgB (e.g., fallbackRAR or |
| | (e.g., fallbackRAR) | successRAR) |
| Example 5 | UL grant included in MsgB | UL grant included in MsgB |
| | (e.g., fallbackRAR) | (e.g., fallbackRAR) |
| Example 6 | UL grant included in MsgB | DCI Format scheduling PDSCH |
| | (e.g., fallbackRAR) | of MsgB (e.g., fallbackRAR |
| | | or successRAR) |
| Example 7 | DCI Format scheduling | MsgB (e.g., fallbackRAR or |
| | PDSCH of MsgB (e.g., | successRAR) |
| | fallbackRAR or | |
| | successRAR) | |
| Example 8 | DCI Format scheduling | UL grant included in MsgB |
| | PDSCH of MsgB (e.g., | (e.g., fallbackRAR) |
| | fallbackRAR or | |
| | successRAR) | |
| Example 9 | DCI Format scheduling | DCI Format scheduling PDSCH |
| | PDSCH of MsgB (e.g., | of MsgB (e.g., fallbackRAR |
| | fallbackRAR or | or successRAR) |
| | successRAR) | |

In one example, a UE is indicated by a flag (e.g., one-bit flag) or a special bit pattern in MsgB (e.g., fallbackRAR or successRAR) to perform CSI measurement and/or reporting and is indicated the aforementioned information in MsgB (e.g., fallbackRAR or successRAR). In one example, the UE could measure/receive CSI-RS(s) and/or transmit the corresponding CSI report(s) instead of or in place of PUSCH Msg3, e.g., scheduled by fallbackRAR. In one example, the UE could measure/receive CSI-RS(s) and/or transmit the corresponding CSI report(s) in addition to PUSCH Msg3 (before or after PUSCH Msg3). In one example, the information includes a CSI-RS resource ID/index and/or CSI resource set ID/index configured to the UE from a list of CSI-RS resources and/or a list of CSI resource sets configured to the UE, wherein the configuration can be by SIB signaling or by RRC signaling. In one example, the information includes configuration/scheduling parameters for the (early) CSI measurement and/or reporting, such as time domain resources (e.g., symbol(s) in a slot to use for CSI measurement/reporting, time offset from MsgB (e.g., fallbackRAR or successRAR), or time offset within a period, CSI-RS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the information. In one example, the successRAR includes an UL grant with parameters to schedule the resource(s) for CSI reporting. The indication of the flag (e.g., one-bit flag) or special pattern and the information can follow one of the examples of Table 4.

In one example, information related to M CSI-RS resources for CSI measurement and/or CSI reporting setting(s) for CSI reporting are configured by system information. In one example, the CSI-RS resource ID/index (and/or CSI resource set ID/index) used by a UE for CSI measurement is determined based on one or more of the following:
Based on a C-RNTI conveyed by the MsgB, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a CSI-RS resource (e.g., CSI-RS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the MsgB.
Based on the preamble index associated with the random access procedure.
Based on the PRACH occasion (RO) associated with the RAR.
Based on the preamble index and PRACH occasion (RO) associated with the RAR.
Based on the group of the preamble and/or RO of MsgA PRACH associated with the successRAR or fallbackRAR as aforementioned.
Based on signaling in MsgB.
Based on the CSI report type(s) or a default CSI report type if the CSI report type(s) is unknown at the time of early CSI triggering and/or (early) CSI measurement and/or reporting.
The time and/or frequency resources of a DCI format scheduling a MsgB or of the MsgB.
Based on the resource used for HARQ-ACK acknowledgment of MsgB.

In one example, the network configures CSI-RS resource(s) for each preamble-ID. In one example, the network configures CSI-RS resource(s) for each RO within a frame. In one example, the network configures CSI-RS resource(s) for each RO within an association period. In one example, the network configures SRS resource(s) for each RO within an association pattern period. In one example, the network configures CSI-RS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures CSI-RS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the CSI-RS resource ID/index (and/or CSI resource set ID/index) and the aforementioned parameters is based on a rule. In one example, this mapping between the CSI-RS resource ID/index (and/or CSI resource set ID/index) and the aforementioned parameters is based on a network configuration. In one example, this mapping between the CSI-RS resource ID/index (and/or CSI resource set ID/index) and the aforementioned parameters is based on a combination of a rule and network configuration.

In one example, the CSI-RS resource ID (and/or CSI resource set ID) used by a UE for CSI measurement/reporting is determined based on one or more of the following:
A CSI-RS ID of the M CSI-RS resource IDs (and/or CSI resource set IDs) configured by system information, wherein the CSI-RS resource ID (and/or CSI resource set ID) is included in the DCI Format scheduling the MsgB and/or the MsgB.
In a variant, the CSI configuration parameters (or a subset of them) for the CSI-RS resource can be included in the DCI Format scheduling the MsgB and/or the MsgB instead of or in addition to the CSI-RS ID. Wherein the configuration parameters for the CSI-RS resource can be as aforementioned.

In one example, the UE could measure/receive the CSI-RS(s) and/or transmit the corresponding CSI report(s) at or after a time T after the end (or start) of the PDSCH reception providing MsgB or of the PDCCH reception providing the DCI Format scheduling the MsgB associated with the UE. In one example, the slot or subframe or frame used to measure/receive the CSI-RS(s) and/or transmit the corresponding CSI report(s) can be at or after a time T after the end (or start) of the PDSCH reception providing MsgB or of the PDCCH reception providing the DCI Format scheduling the MsgB associated with the UE. In one example, the slot or subframe or frame used to measure/receive the CSI-RS(s) and/or transmit the corresponding CSI report(s) is that first slot or subframe or frame that starts at or after a time T after the end (or start) of the PDSCH reception providing MsgB or of the PDCCH reception providing the DCI Format scheduling the MsgB associated with the UE and optionally based on an offset and a periodicity, where early CSI acquisition trigger can be replaced by the MsgB or the PDCCH reception providing the DCI Format scheduling the MsgB associated with the UE transmitting SRS. Wherein, the time T can be defined in the system specifications and/or configured or updated by network (e.g., using SIB signaling and/or RRC signaling and/or MAC CE signaling and/or L1 control signaling).

According to or following those specified/defined herein in the present disclosure,
A UE receives in system information (e.g., SIB1, SIB2, etc.) information related to channel measurement resource(s), interference measurement resource(s) in terms/form their resource ID(s)/index(es), resource set ID(s)/index(es), resource setting ID(s)/index(es) and/or etc. e.g. provided by earlyCsi-ResourceConfig, and/or their corresponding CSI reporting setting(s) e.g. provided by earlyCsi-ReportConfig, and/or their association(s) to one or more preamble IDs and/or ROs as specified/defined herein in the present disclosure for (early) CSI measurement/reporting; in addition, the system information could also comprise indicator(s) to enable early CSI acquisition, and/or minimum time offset(s) required (e.g., value T in the above described design examples) between the CSI acquisition triggering signaling (e.g., Msg2 RAR, Msg4, PDCCH that schedules the RAR, PDCCH that schedules the Msg4, etc.) and the actual measurement/reception of CSI-RS(s) and/or transmission of CSI report(s).
The UE transmits a preamble for a Type-1 random access procedure or a Type-2 random access procedure. In one example, a Type-2 random access procedure includes a PRACH and a PUSCH.
   In one example, the preambles and/or ROs are partitioned into 2 groups or into groups, wherein the preamble and/or RO group used for the random access procedure can indicate whether or not the UE supports early CSI. In other examples, the preamble and/or RO group used for the random access procedure can indicate a CSI report type.
   In one example, for Type-2 random access procedure, MsgA PRACH (based on preamble and/or RO group) and/or MsgA PUSCH (based on signaling in MsgA PUSCH) can indicate capability of UE to support early CSI and/or CSI report type(s).
The network responds to the preamble of the Type-1 random access procedure or the Type-2 random access procedure, with a RAR or a success RAR or a fallback RAR.
   In one example, the RAR or a success RAR or a fallback RAR includes a trigger for CSI measurement
   In one example, the RAR or a success RAR or a fallback RAR includes a trigger for CSI reporting
   In one example, the RAR or success RAR or a fallback RAR includes a trigger for CSI measurement and reporting
   In one example, the RAR or success RAR or a fallback RAR includes minimum time offset(s) required (e.g., value T in the above described design examples) between the RAR/success RAR/fallback RAR (or the corresponding scheduling PDCCH) and the actual measurement/reception of CSI-RS(s) and/or transmission of CSI report(s)
   In one example, the RAR/success RAR/fallback RAC includes UL resource(s)/grant for CSI reporting
   In one example, the RAR or a success RAR or a fallback RAR indicates CSI-RS resource(s) for CSI measurement and/or resource(s) for CSI reporting, e.g., explicitly or based on preamble ID or RO or TC-RNTI or C-RNTI or CSI report type(s) if known, or default CSI report type(s) as aforementioned.

The trigger for CSI measurement could point to or could be associated or linked to one or more CSI-RS resources and/or one or more CSI resource sets provided or configured in the system information for (early) CSI measurement and/or reporting.
For Type 1 random access procedure, the UE transmits Msg3.
   In one example, Msg3 includes C-RNTI MAC CE or CCCH SDU.
   In one example, for Type-1 random access procedure, Msg3 (based on preamble and/or RO group) and/or MsgA PUSCH (based on signaling in MsgA PUSCH) can indicate capability of UE to support early CSI acquisition and/or UE's support of CSI report type(s).
   In one example, Msg3 includes an indicator to indicate to the network that (or whether or not) the UE has available CSI report(s) to transmit.
   In one example, Msg3 includes the CSI report(s), wherein
      the CSI report(s) could be triggered by the trigger in the RAR/success RAR/fallback RAR as aforementioned, and/or
      the UE could identify or determine to the CSI report(s) according to and/or include the CSI report(s) in Msg3 when/if the system information comprises information related to (early) CSI measurement/reporting such as the indicator(s) to indicate/enable/configure early CSI, CSI resource setting(s), CSI reporting setting(s) and/or etc. for (early) CSI acquisition as specified/defined herein in the present disclosure.
The network responds to the Msg3 of the Type-1 random access procedure with a Msg4, wherein the Msg4 could comprise (e.g., when/if Msg3 includes the indicator to indicate that the UE has available CSI report(s) to transmit)
   In one example, the Msg4 includes a trigger for CSI measurement
   In one example, the Msg4 includes a trigger for CSI reporting
   In one example, the Msg4 includes a trigger for CSI measurement and reporting
   In one example, the Msg4 includes minimum time offset(s) required (e.g., value T in the above described design examples) between the Msg4 (or the corresponding scheduling PDCCH) and the actual measurement/reception of CSI-RS(s) and/or transmission of CSI report(s)
   In one example, the Msg4 includes UL resource(s)/grant for CSI reporting
   In one example, the Msg4 indicates CSI-RS resource(s) for CSI measurement and/or resource(s) for CSI reporting, e.g., explicitly or based on preamble ID or RO or TC-RNTI or C-RNTI or CSI report type(s) if known, or default CSI report type(s) as aforementioned.
   In one example, when/if Msg1 and/or Msg3 includes and/or indicates capability of UE to support early CSI acquisition and/or UE's support of CSI report type(s), the Msg4 could include information related to channel measurement resource(s), interference measurement resource(s) in terms/form their resource ID(s)/index(es), resource set ID(s)/index(es), resource setting ID(s)/index(es) and/or etc. e.g. provided by earlyCsi-ResourceConfig, and/or their corresponding CSI reporting setting(s) e.g. provided by earlyCsi-ReportConfig, and/or their association(s) to one or more preamble IDs and/or ROs as specified/defined herein in the present disclosure for (early) CSI measurement/reporting; in addition, the system information could also comprise indicator(s) to enable early CSI acquisition, and/or minimum time offset(s) required (e.g., value T in the above described design examples) between the CSI acquisition triggering signaling (e.g., Msg4, PDCCH that schedules Msg4, etc.) and the actual measurement/reception of CSI-RS(s) and/or transmission of CSI report(s).
The trigger for CSI measurement could point to or could be associated or linked to one or more CSI-RS resources and/or one or more CSI resource sets provided or configured in the system information, and/or provided or indicated in Msg4, for (early) CSI measurement and/or reporting.

According to or following the aforementioned procedure(s), in terms of (early) CSI measurement(s),
In one example, the UE could start to receive or measure CSI-RS(s), e.g., after the minimum time offset(s) required (e.g., value T in the above described design examples), after reception(s) of Msg2 or RAR/success RAR/fallback RAR. The UE could determine or identify the CSI-RS(s) according to:
   The CSI resource/reporting setting(s) provided or configured in the system information for (early) CSI measurement and/or reporting according to or following those specified/defined herein in the present disclosure, and/or
   CSI-RS resource ID(s)/index(es), CSI recourse set ID(s)/index(es) and/or etc. associated or linked to the trigger in Msg2 or RAR/success RAR/fallback RAR (if any)
In one example, the UE could start to receive or measure CSI-RS(s), e.g., after the minimum time offset(s) required (e.g., value T in the above described design examples), after reception(s) of Msg4. The UE could determine or identify the CSI-RS(s) according to:
   The CSI resource/reporting setting(s) provided or configured in the system information for (early) CSI measurement and/or reporting according to or following those specified/defined herein in the present disclosure, and/or
   The CSI resource/reporting setting(s) provided or configured or included in Msg4 (if any) for (early) CSI measurement and/or reporting according to or following those specified/defined herein in the present disclosure, and/or
   CSI-RS resource ID(s)/index(es), CSI recourse set ID(s)/index(es) and/or etc. associated or linked to the trigger in Msg2 or RAR/success RAR/fallback RAR and/or Msg4 (if any)
In one example, the UE could start to receive or measure CSI-RS(s), e.g., after the minimum time offset(s) required (e.g., value T in the above described design examples), after transmission(s) of Msg1, MsgA and/or Msg3. The UE could determine or identify the CSI-RS(s) according to:
   The CSI resource/reporting setting(s) provided or configured in the system information for (early) CSI measurement and/or reporting according to or following those specified/defined herein in the present disclosure, and/or
   CSI-RS resource ID(s)/index(es), CSI recourse set ID(s)/index(es) and/or etc. associated or linked to the trigger in Msg2 or RAR/success RAR/fallback RAR (if any)

According to or following the aforementioned procedure(s), in terms of (early) CSI reporting,
In one example, the UE could transmit or send the CSI report(s) via/in/by one or more UL resources/transmission occasions (e.g., one or more PUCCH and/or PUSCH resources or transmission occasions (TOs)), e.g., after the minimum time offset(s) required (e.g., value T in the above described design examples), after reception(s) of Msg2 or RAR/success RAR/fallback RAR. The UE could determine or identify the UL resource(s) for CSI reporting according to:
   The CSI resource/reporting setting(s) provided or configured in the system information for (early) CSI measurement and/or reporting according to or following those specified/defined herein in the present disclosure, and/or
   UL grant/resource allocation(s) provided or indicated in Msg2 or RAR/success RAR/fallback RAR (if any) as specified/defined herein in the present disclosure, and/or
   CSI reporting setting(s) and/or etc. associated or linked to the trigger in Msg2 or RAR/success RAR/fallback RAR (if any)
In this case, the CSI reporting can be:
   Before Msg3
   With (or as part of) Msg3
   After Msg3
In one example, the UE could transmit or send the CSI report(s) via/in/by one or more UL resources/transmission occasions (e.g., one or more PUCCH and/or PUSCH resources or transmission occasions (TOs)), e.g., after the minimum time offset(s) required (e.g., value T in the above described design examples), after reception(s) of Msg4. The UE could determine or identify the UL resource(s) for CSI reporting according to:
   First available and valid UL resource(s)/TO(s) for CSI reporting, and/or
   The CSI resource/reporting setting(s) provided or configured in the system information for (early) CSI measurement and/or reporting according to or following those specified/defined herein in the present disclosure, and/or
   The CSI resource/reporting setting(s) provided or configured or indicated in Msg4 for (early) CSI measurement and/or reporting according to or following those specified/defined herein in the present disclosure, and/or
   UL grant/resource allocation(s) provided or indicated in Msg2 or RAR/success RAR/fallback RAR and/or Msg4 (if any) as specified/defined herein in the present disclosure, and/or
   CSI reporting setting(s) and/or etc. associated or linked to the trigger in Msg2 or RAR/success RAR/fallback RAR and/or Msg4 (if any)
In one example, the UE could transmit or send the CSI report(s) via/in/by one or more UL resources/transmission occasions (e.g., one or more PUCCH and/or PUSCH resources or transmission occasions (TOs)), e.g., after the minimum time offset(s) required (e.g., value T in the above described design examples), after the UE is in connected mode.

In the following examples, as described, a UE can indicate the support of early SRS by the preamble and/or RO used for the random access procedure. In one example a set of preambles and/or ROs are configured for the UE to indicate early SRS (UE can randomly select a preamble/RO from the set for early SRS support indication). The set of preambles and/or ROs can be per-SS/PBCH block, or can be common across SS/PBCH blocks.

In one example, preambles within existing RO configurations can be used to indicate that the UE supports early SRS (e.g., group g₁), legacy preambles are used to indicate that the UE doesn't support early SRS (e.g., group g₀). In one example, new ROs can be used to indicate that the UE supports early SRS, e.g., preambles in new ROs can be used to indicate that the UE supports early SRS (e.g., group g₁), legacy preambles are used to indicate that the UE doesn't support early SRS (e.g., group g₀).

A UE can be configured with a set of preambles in group g₁ for indicating support of early SRS. A UE can be configured with a set of preambles in group g₀ (e.g., legacy preambles) for indicating non-support of early SRS, or UE doesn't prefer transmitting early SRS. In one example, a UE randomly selects a preamble from group g₁, if the UE supports early SRS (or if the UE supports and desires to transmit early SRS). A network/gNB receiving a preamble in group g₁ can indicate to or configure the UE, in a subsequent message or messages to transmit early SRS as described in this disclosure. In one example, a UE randomly selects a preamble from group g₀, if the UE doesn't support early SRS (or if the doesn't desire to transmit early SRS). A network/gNB receiving a preamble in group g₀ is expected not to indicate or configure the UE to transmit early SRS.

In one example, the preambles and/or ROs in group g₁ are configured for each SS/PBCH block.

In one example, the preambles and/or ROs in group g₁ are configured commonly for all SS/PBCH blocks.

In a variant of the above examples, a set of preambles and/or ROs can be configured for group g₀, e.g., separate from the legacy preambles and/or ROs. In one example, the preambles and/or ROs in group g₀ are configured for each SS/PBCH block. In one example, the preambles and/or ROs in group g₀ are configured commonly for all SS/PBCH blocks.

In the following examples, as described, a UE can indicate its SRS antenna switching TxRy capability for early SRS based on the preamble and/or RO used for the random access procedure. In one example a first set of preambles and/or ROs are configured for the UE to indicate support of a first TxRy capability, a second set of preambles and/or ROs are configured for the UE to indicate support of a second TxRy capability, . . . , an Nth set of preambles and/or ROs are configured for the UE to indicate support of an Nth TxRy capability. Wherein, the UE can randomly select a preamble from a set, and the set corresponds to the UE's SRS antenna switching capability (or early SRS antenna switching capability). In one example, the selection of a preamble from any of the N sets indicates to the network that the UE supports early SRS (or supports and desires to transmit early SRS). In one example, the network upon receiving a preamble associated with an ith group, determines that the can UE transmit an SRS resource(s) corresponding to the ith group corresponding to a SRS antenna switching capability TxRy associated with the ith group.

In one example, the SRS antenna switching capability TxRy is indicated by a combination of signaling in preamble/RO (e.g., based on the preamble/TO group), and Msg3 or PUSCH MsgA.

In one example, an RO (e.g., per SS/PBCH block or across all SS/PBCH blocks) is configured for indicating the SRS antenna switching TxRy capability. In one example, the RO has M, e.g., 64 preambles, and the M preambles are split among N groups of preambles. In one example, an RO has M preambles per SSB, and the M preambles are split among N groups of preambles. In one example, the RO has M preambles per SSB per preamble group (group A and group B wherein group A and group B indicates different Msg3/MsgA size), and the M preambles are split among N groups of preambles.

In one example, N=6, and the TxRy capability indicated by a preamble (e.g., according to the set of the preamble) can be one of {‘t1r2’ for 1T2R, ‘t2r4’ for 2T4R, ‘t1r4’ for 1T4R, ‘t1r1’ for 1T=1R, ‘t2r2’ for 2T=2R, or ‘t4r4’ for 4T=4R}.

In one example, N=7, and the TxRy capability indicated by a preamble can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, or ‘t4r4’ for 4T=4R}.

In one example, N=7, and the TxRy capability indicated by a preamble (e.g., according to the set of the preamble) can be one of {‘t1r2’ for 1T2R, ‘t2r4’ for 2T4R, ‘t1r4’ for 1T4R, ‘t1r1’ for 1T=1R, ‘t2r2’ for 2T=2R, ‘t4r4’ for 4T=4R, or not supported}.

In one example, N=8, and the TxRy capability indicated by a preamble (e.g., according to the set of the preamble) can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, ‘t4r4’ for 4T=4R, or not supported}.

In one example, N=3, and the TxRy capability indicated by a preamble (e.g., according to the set of the preamble) can be one of {‘t1r2’ for 1T2R, ‘t1r1’ for 1T=1R, or ‘t2r2’ for 2T=2R}.

In one example, N=3, and the TxRy capability indicated by a preamble (e.g., according to the set of the preamble) can be one of {‘t1r1’ for 1T=1R, ‘t1r2’ for 1T2R, or ‘t1r4’ for 1T4R}.

In one example, N=3, and the TxRy capability indicated by a preamble (e.g., according to the set of the preamble) can be one of {1T4R, 1T2R/2T4R, 1T=1R/2T=2R/4T=4R}. In one example, the number of SRS resource transmitted one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R. In one example, the number of ports is indicated in Msg3 or MsgA PUSCH.

In one example, N=11, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R}.

In one example, N=12, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or not supported}.

In one example, N=6, and the TxRy capability indicated by a preamble (e.g., according to the set of the preamble) can be one of {1T8R, 1T6R, 1T4R/2T8R, 2T6R, 1T2R/2T4R/4T8R, 1T=1R/2T=2R/4T=4R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R. In one example, the number of ports is indicated in Msg3 or MsgA PUSCH.

In one example, N=12, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=13, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=13, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=14, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the TxRy capability indicated by a preamble (e.g., according to the set of the preamble) can be one of {1T8R, 1T6R, 1T4R/2T8R, 2T6R, 1T2R/2T4R/4T8R, 1T=1R/2T=2R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R. In one example, the number of ports is indicated in Msg3 or MsgA PUSCH.

In one example, N=14, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=15, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=15, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=16, and the TxRy capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the TxRy capability indicated by a preamble (e.g., according to the set of the preamble) can be one of {1T8R, 1T6R, 1T4R/2T8R, 2T6R, 1T2R/2T4R/3T6R/4T8R, 1T=1R/2T=2R/3T=3R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3ports for 3T6R and 3T=3R, 4 ports for 4T8R and 4T=4R and 8 ports for 8T8R. In one example, the number of ports is indicated in Msg3 or MsgA PUSCH.

In one example, N=5, and the TxRy capability indicated by a preamble (e.g., according to the set of the preamble) can be one of {1T8R, 1T6R, 1T4R, 1T2R, or 1T=1R}.

In one example, N=6, and the TxRy capability indicated by a preamble (e.g., according to the set of the preamble) can be one of {1T8R, 1T6R, 1T4R, 1T2R, 1T=1R or not supported}.

In one example, N=4, and the TxRy capability indicated by a preamble (e.g., according to the set of the preamble) can be one of {1T8R, 1T4R, 1T2R, or 1T=1R}.

In one example, N=5, and the TxRy capability indicated by a preamble (e.g., according to the set of the preamble) can be one of {1T8R, 1T4R, 1T2R, 1T=1R or not supported}.

In a variant of the aforementioned examples, there are N codepoints indicated by the preamble and/or RO, wherein each code-point can be a subset of {1T=1R, 1T2R, 1T4R, 1T6R, 1T8R, 2T=2R, 2T/4R, 2T/6R, 2T/8R, 3T=3R, 3T/6R, 4T=4R, 4T4R, 8T8R}. In a further example, an element of the subset is indicated by Msg3 or MsgA PUSCH.

In one example, configuration of the number of preamble groups for indication of SRS antenna switching capability, the preambles and/or ROs associated with each group (per SS/PBCH block or across SS/PBCH blocks), and TxRy capability (or set of capabilities) associated with each group can be configured and/or updated by SIB and/or RRC and/or MAC CE and/or L1 control (e.g., DCI Format) signaling.

In one example, for indication of N SRS antenna switching capability codepoints (or N SRS antenna switching capabilities), a set of preambles and/or ROs is configured for each codepoint of the N codepoints (or for each SRS antenna switching capability of the N SRS antenna switching capabilities). Each set of preambles and/or ROs can be per-SS/PBCH block, or can be common across SS/PBCH blocks.

In one example, M preambles (e.g., each preamble can be associated with index j=0, . . . , M−1) in one or more ROs (or M preambles per SSB in a RO or M preambles per SSB per preamble group (group A and group B wherein group A and group B indicates different Msg3/MsgA size) in a RO) are allocated for early SRS indication, the M preambles are divided into N groups (e.g., each group can have index i=0,1, . . . , N−1) of preambles, for indication of N SRS antenna switching capability codepoints (or N SRS antenna switching capabilities). In one example, M is a multiple of N, and each group i, wherein i=0,1, . . . , N−1 has M/N preambles. In one example, the preambles in group i can have index

$$j = i * \frac{N}{M} + k , where$$

$$k = 0 , 1 , … , \frac{M}{N} - 1 .$$

In one example, the number of preambles per group is

$$⌊ \frac{M}{N} ⌋ .$$

In one example, the preambles in group i can have index

$$j = i * ⌊ \frac{M}{N} ⌋ + k , where$$

$$k = 0 , 1 , … , ⌊ \frac{M}{N} ⌋ - 1 .$$

In one example, the number of preambles per group is

$$⌈ \frac{M}{N} ⌉$$

for group i, if i<(M % N), and

$$⌊ \frac{M}{N} ⌋$$

for group i, if i≥(M % N), where % is the modulo operator, that is the remainder of M divided by N. In one example, the preambles in group i, for i<(M % N), can have index

$$j = i * ⌈ \frac{M}{N} ⌉ + k , where$$

$$k = 0 , 1 , … , ⌈ \frac{M}{N} ⌉ - 1 .$$

In one example, the preambles in group i, for i≥(M % N), can have index

$$j = ( M \% N ) + i * ⌊ \frac{M}{N} ⌋ + k , where$$

$$k = 0 , 1 , … , ⌊ \frac{M}{N} ⌋ - 1 .$$

In the following examples, as described, a UE can indicate the support of early SRS and/or the UE's SRS antenna switching TxRy capability for early SRS in Msg3 or MsgA PUSCH. In one example, the UE is configured with “groupBconfigured” random access preambles for group B. In one example, the Msg3 or MsgA PUSCH payload size when the UE transmits random access preamble for group B is larger than the Msg3 or MsgA PUSCH payload size when the UE transmits random access preamble for group A. In one example, the network allocates time and frequency resources and MCS for a payload size of RACH Msg3 or MsgA PUSCH that is large enough for the UE to report UE's early SRS capability and/or the UE's SRS antenna switching TxRy capability for early SRS.

In one example, UE reports in RACH Msg3 or MsgA PUSCH support or not support of early SRS. For example, a one-bit flag can indicate early SRS is not supported (e.g., value 0), or early SRS is supported (e.g., value 1). In a variant example, a one-bit flag can indicate early SRS is not supported (e.g., value 1), or early SRS is supported (e.g., value 0).

In one example, UE reports in RACH Msg3 or MsgA PUSCH UE's SRS antenna switching TxRy capability or UE doesn't support early SRS.
In one example, the UE reports in RACH Msg3 or MsgA PUSCH one of {‘t1r2’ for 1T2R, ‘t2r4’ for 2T4R, ‘t1r4’ for 1T4R, ‘t1r1’ for 1T=1R, ‘t2r2’ for 2T=2R, ‘t4r4’ for 4T=4R, or not early SRS not supported}
In one example, the UE reports in RACH Msg3 or MsgA PUSCH one of {′t1r2′ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, ‘t4r4’ for 4T=4R, or early SRS not supported}.
In one example, the UE reports in RACH Msg3 or MsgA PUSCH one of {‘t1r2’ for 1T2R, ‘t1r1’ for 1T=1R, ‘t2r2’ for 2T=2R, or early SRS not supported}
In one example, the UE reports in RACH Msg3 or MsgA PUSCH one of {‘t1r1’ for 1T=1R, ‘t1r2’ for 1T2R, ‘t1r4’ for 1T4R, or early SRS not supported}
In one example, the UE reports in RACH Msg3 or MsgA PUSCH one of {1T4R, 1T2R/2T4R, 1T=1R/2T=2R/4T=4R, or early SRS not supported}. In one example, the number of SRS resource transmitted one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or early SRS not supported}
In one example, the UE reports in RACH Msg3 or MsgA PUSCH one of {1T8R, 1T6R, 1T4R/2T8R, 2T6R, 1T2R/2T4R/4T8R, 1T=1R/2T=2R/4T=4R, or early SRS not supported}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R.
In one example, the UE reports in RACH Msg3 or MsgA PUSCH one of‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or early SRS not supported}.

In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or early SRS not supported}
In one example, the UE reports in RACH Msg3 or MsgA PUSCH one of {1T8R, 1T6R, 1T4R/2T8R, 2T6R, 1T2R/2T4R/4T8R, 1T=1R/2T=2R/4T=4R/8T8R, or early SRS not supported}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R.
In one example, the UE reports in RACH Msg3 or MsgA PUSCH one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or early SRS not supported}.
In one example, the UE reports in RACH Msg3 or MsgA PUSCH one of {‘t1r1’ for 1T=1R, t2r2′ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or early SRS not supported}.
In one example, the UE reports in RACH Msg3 or MsgA PUSCH one of {1T8R, 1T6R, 1T4R/2T8R, 2T6R, 1T2R/2T4R/3T6R/4T8R, 1T=1R/2T=2R/3T=3R/4T=4R/8T8R, or early SRS not supported}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3ports for 3T6R and 3T=3R, 4 ports for 4T8R and 4T=4R and 8 ports for 8T8R.
In one example, the UE reports in RACH Msg3 or MsgA PUSCH one of {1T8R, 1T6R, 1T4R, 1T2R, 1T=1R or early SRS not supported}.
In one example, the UE reports in RACH Msg3 or MsgA PUSCH one of {1T8R, 1T4R, 1T2R, 1T=1R or early SRS not supported}.
In one example, the UE reports in RACH Msg3 or MsgA PUSCH one of {1T=1R, 1T2R, 1T4R, 1T6R, 1T8R, 2T=2R, 2T/4R, 2T/6R, 2T/8R, 3T=3R, 3T/6R, 4T=4R, 4T4R, 8T8R, or early SRS not supported}.

In the following examples, as described, a UE can indicate the support of early SRS by the preamble and/or RO used for the random access procedure, and the UE can indicate the SRS antenna switching TxRy capability for early SRS in Msg3 or MsgA PUSCH. In one example a set of preambles and/or ROs are configured for the UE to indicate early SRS (UE can randomly select a preamble/RO from the set for early SRS support indication), as aforementioned. The set of preambles and/or ROs can be per-SS/PBCH block, or can be common across SS/PBCH blocks.

In one example, the Msg3 or MsgA PUSCH payload size when the UE transmits random access preamble indicating support of early SRS, is larger than the Msg3 or MsgA PUSCH payload size when the UE transmits random access preamble that doesn't indicate support of early SRS (e.g., legacy preamble). In one example, the network allocates time and frequency resources and MCS for a payload size of RACH Msg3 or MsgA PUSCH that is large enough for the UE to report UE's early SRS capability and/or the UE's SRS antenna switching TxRy capability for early SRS.

In one example, UE reports in RACH Msg3 or MsgA PUSCH UE's SRS antenna switching TxRy capability or UE doesn't support early SRS.
In one example, the UE reports in RACH Msg3 or MsgA PUSCH one of {‘t1r2’ for 1T2R, ‘t2r4’ for 2T4R, ‘t1r4’ for 1T4R, ‘t1r1’ for 1T=1R, ‘t2r2’ for 2T=2R, or ‘t4r4’ for 4T=4R}
In one example, the UE reports in RACH Msg3 or MsgA PUSCH one of {′t1r2′ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, or ‘t4r4’ for 4T=4R}.
In one example, the UE reports in RACH Msg3 or MsgA PUSCH one of {‘t1r2’ for 1T2R, ‘t1r1’ for 1T=1R, or ‘t2r2’ for 2T=2R}
In one example, the UE reports in RACH Msg3 or MsgA PUSCH one of {‘t1r1’ for 1T=1R, ‘t1r2’ for 1T2R, or ‘t1r4’ for 1T4R}
In one example, the UE reports in RACH Msg3 or MsgA PUSCH one of {1T4R, 1T2R/2T4R, or 1T=1R/2T=2R/4T=4R}. In one example, the number of SRS resource transmitted one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, or ‘t1r8’ for 1T8R}
In one example, the UE reports in RACH Msg3 or MsgA PUSCH one of {1T8R, 1T6R, 1T4R/2T8R, 2T6R, 1T2R/2T4R/4T8R, or 1T=1R/2T=2R/4T=4R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R.
In one example, the UE reports in RACH Msg3 or MsgA PUSCH one of ‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or ‘t8r8’ for 8T8R}.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}
In one example, the UE reports in RACH Msg3 or MsgA PUSCH one of {1T8R, 1T6R, 1T4R/2T8R, 2T6R, 1T2R/2T4R/4T8R, or 1T=1R/2T=2R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R.
In one example, the UE reports in RACH Msg3 or MsgA PUSCH one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or ‘t8r8’ for 8T8R}.
In one example, the UE reports in RACH Msg3 or MsgA PUSCH one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.
In one example, the UE reports in RACH Msg3 or MsgA PUSCH one of {1T8R, 1T6R, 1T4R/2T8R, 2T6R, 1T2R/2T4R/3T6R/4T8R, or 1T=1R/2T=2R/3T=3R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3ports for 3T6R and 3T=3R, 4 ports for 4T8R and 4T=4R and 8 ports for 8T8R.
In one example, the UE reports in RACH Msg3 or MsgA PUSCH one of {1T8R, 1T6R, 1T4R, 1T2R, or 1T=1R}.
In one example, the UE reports in RACH Msg3 or MsgA PUSCH one of {1T8R, 1T4R, 1T2R, or 1T=1R}.
In one example, the UE reports in RACH Msg3 or MsgA PUSCH one of {1T=1R, 1T2R, 1T4R, 1T6R, 1T8R, 2T=2R, 2T/4R, 2T/6R, 2T/8R, 3T=3R, 3T/6R, 4T=4R, 4T4R, or 8T8R}.

In the following examples, as described, a UE can indicate the support of early SRS and/or the UE's SRS antenna switching TxRy capability for early SRS in Msg3 or MsgA PUSCH. In one example, using a specific LCID/eLCID in MAC subheader of CCCH SDU included in Msg3/MsgA MAC PDU can indicate the support of early SRS and/or the UE's SRS antenna switching TxRy capability for early SRS.

In one example, a same preamble is used whether or not the UE supports early SRS. The early SRS capability can be indicated in Msg3 or MsgA PUSCH/MAC PDU. In one example a set of preambles and/or ROs are configured for the UE to indicate early SRS (UE can randomly select a preamble/RO from the set for early SRS support indication), as aforementioned. The set of preambles and/or ROs can be per-SS/PBCH block, or can be common across SS/PBCH blocks.

In one example, LCID/eLCID codepoint (e.g. in MAC subheader of CCCH SDU included in Msg3/MsgA) is configured for indicating the support of early SRS capability. In one example, the LCID/eLCID codepoint (e.g. in MAC subheader of CCCH SDU included in Msg3/MsgA) can be configured separately for different CCCH SDU sizes (e.g. 48 bits and 64 bits) for indicating the support of early SRS capability. In one example LCID/eLCID codepoint for indicating the support of early SRS capability can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

In one example, N LCID/eLCIDs codepoints (e.g. in MAC subheader of CCCH SDU included in Msg3/MsgA) are configured for indicating the SRS antenna switching TxRy capability. In one example, N LCID/eLCIDs codepoints (e.g. in MAC subheader of CCCH SDU included in Msg3/MsgA) can be configured separately for different CCCH SDU sizes (e.g. 48 bits and 64 bits) for indicating the SRS antenna switching TxRy capability. In one example N LCID/eLCIDs codepoints for indicating the SRS antenna switching TxRy capability can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

In one example, N=6, and the TxRy capability indicated by a LCID/eLCID codepoint can be one of {‘t1r2’ for 1T2R, ‘t2r4’ for 2T4R, ‘t1r4’ for 1T4R, ‘t1r1’ for 1T=1R, ‘t2r2’ for 2T=2R, or ‘t4r4’ for 4T=4R}.

In one example, N=7, and the TxRy capability indicated by a LCID/eLCID codepoint can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, or ‘t4r4’ for 4T=4R}.

In one example, N=7, and the TxRy capability indicated by a LCID/eLCID codepoint can be one of {‘t1r2’ for 1T2R, ‘t2r4’ for 2T4R, ‘t1r4’ for 1T4R, ‘t1r1’ for 1T=1R, ‘t2r2’ for 2T=2R, ‘t4r4’ for 4T=4R, or not supported}.

In one example, N=8, and the TxRy capability indicated by a LCID/eLCID codepoint can be one of {′t1r2′ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, ‘t4r4’ for 4T=4R, or not supported}.

In one example, N=3, and the TxRy capability indicated by a LCID/eLCID codepoint can be one of {‘t1r2’ for 1T2R, ‘t1r1’ for 1T=1R, or ‘t2r2’ for 2T=2R}.

In one example, N=3, and the TxRy capability indicated by LCID/eLCID codepoint can be one of {‘t1r1’ for 1T=1R, ‘t1r2’ for 1T2R, or ‘t1r4’ for 1T4R}.

In one example, N=3, and the TxRy capability indicated by a LCID/eLCID codepoint can be one of {1T4R, 1T2R/2T4R, 1T=1R/2T=2R/4T=4R}. In one example, the number of SRS resource transmitted one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R. In one example, the number of ports is indicated in Msg3 or MsgA PUSCH.

In one example, N=11, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R}.

In one example, N=12, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or not supported}.

In one example, N=6, and the TxRy capability indicated by a LCID/eLCID codepoint can be one of {1T8R, 1T6R, 1T4R/2T8R, 2T6R, 1T2R/2T4R/4T8R, 1T=1R/2T=2R/4T=4R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R. In one example, the number of ports is indicated in Msg3 or MsgA PUSCH.

In one example, N=12, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=13, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=13, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=14, and the TxRy capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the TxRy capability indicated by a LCID/eLCID codepoint can be one of {1T8R, 1T6R, 1T4R/2T8R, 2T6R, 1T2R/2T4R/4T8R, 1T=1R/2T=2R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R. In one example, the number of ports is indicated in Msg3 or MsgA PUSCH.

In one example, N=14, and the TxRy capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=15, and the TxRy capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=15, and the TxRy capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=16, and the TxRy capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘no Tdm’ or ‘tdmAndNoTdm’ for 8T8R, or not supported}.

In one example, N=6, and the TxRy capability indicated by a LCID/eLCID codepoint can be one of {1T8R, 1T6R, 1T4R/2T8R, 2T6R, 1T2R/2T4R/3T6R/4T8R, 1T=1R/2T=2R/3T=3R/4T=4R/8T8R}. In one example, the number of SRS resource transmitted one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3ports for 3T6R and 3T=3R, 4 ports for 4T8R and 4T=4R and 8 ports for 8T8R. In one example, the number of ports is indicated in Msg3 or MsgA PUSCH.

In one example, N=5, and the TxRy capability indicated by a LCID/eLCID codepoint can be one of {1T8R, 1T6R, 1T4R, 1T2R, or 1T=1R}.

In one example, N=6, and the TxRy capability indicated by a LCID/eLCID codepoint can be one of {1T8R, 1T6R, 1T4R, 1T2R, 1T=1R or not supported}.

In one example, N=4, and the TxRy capability indicated by a LCID/eLCID codepoint can be one of {1T8R, 1T4R, 1T2R, or 1T=1R}.

In one example, N=5, and the TxRy capability indicated by a LCID/eLCID codepoint can be one of {1T8R, 1T4R, 1T2R, 1T=1R or not supported}.

In a variant of the aforementioned examples, there are N codepoints indicated by the LCID/eLCID codepoint, wherein each code-point can be a subset of {1T=1R, 1T2R, 1T4R, 1T6R, 1T8R, 2T=2R, 2T/4R, 2T/6R, 2T/8R, 3T=3R, 3T/6R, 4T=4R, 4T4R, 8T8R}.

In a variant of the aforementioned examples the following examples can be considered:
In one example, the early SRS capability and/or UE's SRS antenna switching TxRy capability can be indicated in Msg3 or MsgA PUSCH by including a MAC CE (e.g. SRS capability MAC CE) in Msg3 or MsgA MAC PDU wherein the MAC PDU include CCCH SDU and the MAC CE. One or more fields in the MAC CE indicate early SRS capability and/or UE's SRS antenna switching TxRy capability. In one example, UE can indicate that it supports early SRS through the PRACH preamble and in response network provides large enough grant in random access response to transmit Msg3 including UE's other SRS capabilities such as SRS antenna switching TxRy capability in MAC CE.
In one example, the one or more early SRS capability can be indicated by LCID/eLCID of CCCH SDU in in Msg3 or MsgA PUSCH/MAC PDU and other SRS capability can be indicated by a MAC CE in Msg3 or MsgA PUSCH/MAC PDU.
In one example, the early SRS capability and/or UE's SRS antenna switching TxRy capability can be indicated in Msg3 or MsgA PUSCH/MAC PDU in LCID/eLCID of CCCH SDU.
In one example, the early SRS capability and/or UE's SRS antenna switching TxRy capability can be indicated in Msg3 or MsgA PUSCH/MAC PDU by a combination of LCID/eLCID of CCCH SDU and MAC CE (e.g., using one or more new fields). In one example, indication of TxRy, y/x can be indicated by LCID/eLCID and x can be indicated by a new field in MAC CE. In one example, indication of TxRy, y/x can be indicated by LCID/eLCID and y can be indicated by a new field in MAC CE. In one example, indication of TxRy, x can be indicated by LCID/eLCID and y/x can be indicated by a new field in MAC CE. In one example, indication of TxRy, y can be indicated by LCID/eLCID and y/x can be indicated by a new field in MAC CE. In one example, indication of TxRy, y can be indicated by LCID/eLCID and x can be indicated by a new field in MAC CE. In one example, indication of TxRy, x can be indicated by LCID/eLCID and y can be indicated by a new field in MAC CE.

In one example, an SRS transmission is triggered in the random access response (RAR) (e.g., Msg2) to a preamble transmission. In one example, an SRS transmission is triggered in the random access response (RAR) (e.g., Msg2) to a preamble transmission for a contention based random access procedure. In one example, an SRS transmission is triggered in the random access response (RAR) (e.g., Msg2) to a preamble transmission for a contention free random access procedure. In one example, the SRS is triggered in a RAR if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, a UE is configured e.g., by a field or flag in the system information to transmit SRS in response to receiving a RAR. The SRS transmission can be further conditioned on whether the UE transmits an associated PRACH preamble/RO from a first group of preambles/ROs or from a second group of preambles/ROs indicated in the system information. In one example, if a UE is configured by system information with a first set of preambles/ROs for “no early” SRS and a second of preambles/ROs for “early SRS”, the UE can:
If the UE transmits a preamble/RO associated with “no early SRS”, the UE doesn't expect to receive a trigger for early SRS in the RAR. In a variant example, if a UE receives a trigger for early SRS in the RAR, the UE ignores the trigger.
In one example, if the UE transmits a preamble/RO associated with “early SRS”, the RAR doesn't include a flag for early SRS trigger, the UE transmits the early SRS upon receiving the RAR.
In one example, if the UE transmits a preamble/RO associated with “early SRS”, the RAR includes a flag for early SRS trigger, based on the flag in the UE transmits or doesn't transmit the early SRS upon receiving the RAR.

In one example, a UE is indicated in the RAR to transmit a SRS. In one example, a flag or a field in the RAR can indicate whether the UE transmits SRS in response to receiving the RAR. In one example, a field in the MAC sub-header for Random Access Response, e.g., a reserved field in the MAC sub-header for the Random Access Response can be used to trigger the SRS, for example, a value of “1” triggers the SRS, and a value of “0” doesn't trigger the SRS. In one example, a field in the MAC RAR, e.g., a reserved field in the MAC RAR can be used to trigger the SRS, for example, a value of “1” triggers the SRS, and a value of “0” doesn't trigger the SRS.

In one example, a UE is indicated by a flag (e.g., one-bit flag) or a special bit pattern in the RAR to transmit SRS. In one example, the UE transmits SRS instead of or in place of PUSCH Msg3. In one example, the UE transmits SRS in addition to PUSCH Msg3 (before or after PUSCH Msg3). In one example, the flag (e.g., one-bit flag) is included in the MAC sub-header for the Random Access Response, e.g., for Type-1 Random Access Procedure. In one example, the flag (e.g., one-bit flag) is included in the MAC RAR, e.g., for Type-1 Random Access Procedure. In one example, the flag (e.g., one-bit flag) is included in the UL Grant of the MAC RAR, e.g., for Type-1 Random Access Procedure. In one example, a special bit pattern of fields in the UL Grant of the MAC RAR, e.g., for Type-1 Random Access Procedure, indicates transmission of SRS. In one example, the flag (e.g., one-bit flag) is included in the DCI scheduling PDSCH of the MAC RAR. In one example, a special bit pattern of fields in the DCI scheduling the PDSCH of the MAC RAR indicates transmission of SRS.

In one example, a UE is indicated by a SRS resource in the RAR to use for SRS transmission. In one example, the UE transmits SRS instead of or in place of PUSCH Msg3. In one example, the UE transmits SRS in addition to PUSCH Msg3 (before or after PUSCH Msg3). In one example, the SRS resource is included in the MAC RAR, e.g., for Type-1 Random Access Procedure. In one example, the SRS resource is included in the UL Grant of the MAC RAR, e.g., for Type-1 Random Access Procedure. In one example, the SRS resource is included in the DCI scheduling the PDSCH of the MAC RAR. In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs are portioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, time offset from Msg3, or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource.

In one example, a UE is indicated by a flag (e.g., one-bit flag) or a special bit pattern in the RAR to transmit SRS and is indicated an SRS resource in the RAR. In one example, the UE transmits SRS instead of or in place of PUSCH Msg3. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource. The indication of the flag (e.g., one-bit flag) or special pattern and the SRS resource can follow one of the examples of Table 5.

In one example, the UE determines the early SRS resource or resources to transmit based in the antenna switching capability if known. In one example, the antenna switching capability (e.g., xTyR or whether it is supported or not) is signaled based on a preamble and/or RO index or group as aforementioned. In one example, the antenna switching capability is signaled in Msg3, for an early SRS transmitted after Msg3, the network and UE can be aligned on the antenna switching capability and early SRS resource(s) used.

TABLE 5

| Example | flag (e.g., one-bit flag) | |
|---|---|---|
| number | or special pattern | SRS resource |
| Example 1 | MAC RAR | MAC RAR |
| Example 2 | MAC RAR | UL grant included in MAC RAR |
| Example 3 | MAC RAR | DCI Format scheduling |
| | | PDSCH of MAC RAR |
| Example 4 | UL grant included in | MAC RAR |
| | MAC RAR | |
| Example 5 | UL grant included in | UL grant included in MAC RAR |
| | MAC RAR | |
| Example 6 | UL grant included in | DCI Format scheduling |
| | MAC RAR | PDSCH of MAC RAR |
| Example 7 | DCI Format scheduling | MAC RAR |
| | PDSCH of MAC RAR | |
| Example 8 | DCI Format scheduling | UL grant included in MAC RAR |
| | PDSCH of MAC RAR | |
| Example 9 | DCI Format scheduling | DCI Format scheduling |
| | PDSCH of MAC RAR | PDSCH of MAC RAR |

In one example, M SRS resources are configured by system information. In one example, the SRS resource set ID and/or the SRS resource ID transmitted by a UE is determined based on one or more of the following:
Based on a TC-RNTI conveyed by the RAR, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in or determined by a paging message that triggered the random access procedure associated with the RAR.
Based on the C-RNTI (or UE-ID), in Msg3, the UE and the gNB can identify a SRS resource (e.g., SRS resource in a stored context associated with the C-RNTI or the UE-ID)
Based on the preamble index associated with the RAR.
Based on the PRACH occasion (RO) associated with the RAR.
Based on the preamble index and PRACH occasion (RO) associated with the RAR.
Based on the group of the preamble and/or RO associated with the RAR as aforementioned.
Based on the antenna switching capability or a default antenna switching capability is antenna switching capability is unknown at the time of early SRS transmission or early SRS triggering.
The time and/or frequency resources of a PDCCH reception providing a DCI format scheduling a RAR or of the PDSCH reception providing the RAR.

In one example, in case of antenna switching, with multiple SRS resources, an SRS resource ID (and/or SRS resource set ID) can be determined by or be linked or mapped to multiple SRS resources based on the antenna switching capability, and the corresponding number of SRS resources.

In one example, the network configures SRS resource(s) for each preamble-ID. In one example, the network configures SRS resource(s) for each RO within a frame. In one example, the network configures SRS resource(s) for each RO within an association period. In one example, the network configures SRS resource(s) for each RO within an association pattern period. In one example, the network configures SRS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the RAR and/or the RAR.
In a variant, the SRS configuration parameters (or a subset of them) for the SRS resource can be included in the DCI Format scheduling the RAR and/or the RAR instead of or in addition to the SRS ID. Wherein the configuration parameters for the SRS resource can be as aforementioned

In one example, the SRS resource can be transmitted at or after a time T after the end (or start) of the PDSCH reception providing the RAR or of end (or start) of the PDCCH reception providing the DCI Format scheduling the RAR associated with the UE transmitting SRS. In one example, the slot or subframe or frame used to transmit SRS resource can be at or after a time T after the end (or start) of PDSCH reception providing the RAR or of end (or start) of the PDCCH reception providing the DCI Format scheduling the RAR associated with the UE transmitting SRS. In one example, the slot or subframe or frame used to transmit SRS resource is that first slot or subframe or frame that starts at or after a time T after the end (or start) of PDSCH reception providing the RAR or of end (or start) of PDCCH reception providing the DCI Format scheduling the RAR associated with the UE transmitting SRS and optionally based on an offset and a periodicity as illustrated in FIG. 13 (the SRS instances can be one-shot, N-shots or semi-persistent), where SRS trigger can be replaced by the PDSCH providing the RAR or the PDCCH providing the DCI Format scheduling the RAR associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, the RAR and/or DCI scheduling the RAR includes a flag to trigger SRS. The SRS is transmitted after RACH Msg3. In one example, the UE has a stored context, and the store context is associated with a C-RNTI (or a UE ID), for example the UE is in INACTIVE state. In one example, the UE transmits a C-RNTI MAC CE (or UE ID) in the Msg3, based on the C-RNTI (or UE-ID) the UE and the gNB can identify a SRS resource (e.g., SRS resource in a stored context associated with the C-RNTI or the UE-ID).

In one example, the RAR and/or DCI scheduling the RAR includes a flag to trigger SRS. The SRS is transmitted after RACH Msg3. In one example, Msg3 can convey antenna switching capability, and the SRS resource(s) is determined based on the antenna switching capability as aforementioned. In a variant example, the antenna switching capability is conveyed by a combination of signaling in the preamble/RO (e.g., based on preamble and/or RO group as aforementioned) and signaling in Msg3. In one example, early SRS capability in Msg3 is indicated by 1 bit in RRC message or using a specific LCID/eLCID in MAC PDU.

In one example, if the RAR includes a trigger for early SRS transmission, Msg3 can further include an indication whether or not the UE is transmitting the early SRS.

In one example, the SRS resource can be transmitted at or after a time T after the end (or start) of the PUSCH transmission containing Msg3 associated with the UE transmitting SRS. In one example, the slot or subframe or frame used to transmit SRS resource can be at or after a time T after the end (or start) of the PUSCH transmission containing Msg3 associated with the UE transmitting SRS. In one example, the slot or subframe or frame used to transmit SRS resource is that first slot or subframe or frame that starts at or after a time T after the end (or start) of the PUSCH transmission containing Msg3 associated with the UE transmitting SRS and optionally based on an offset and a periodicity as illustrated in FIG. 13 (the SRS instances can be one-shot, N-shots or semi-persistent), where SRS trigger can be replaced by the PUSCH transmission containing Msg3 associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, an SRS transmission is triggered in contention resolution message providing a C-RNTI for the UE, or in Msg4, of a random access procedure. In one example, an SRS transmission is triggered in contention resolution message or Msg4 of a contention-based random access procedure. In one example, the SRS is triggered in a Msg4 if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g.), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by Msg3 (or MsgA) of the random access procedure. Support of early SRS can be indicated in MAC subheader (e.g. by using a pre-defined LCID or eLCID) or MAC CE or RRC message (e.g. RRC setup request or RRC resume request) included in Msg3/MsgA MAC PDU. In a variant example, Msg3 can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO (e.g., based on preamble and/or RO group as aforementioned) and signaling in Msg3.

In one example, a UE is configured e.g., by a field or flag in the system information to transmit SRS in response to receiving a contention resolution message, or in Msg4, or in a DCI Format scheduling Msg4 or MsgB. The SRS transmission can be further conditioned on whether the UE transmits an associated PRACH preamble from a first group of preambles or from a second group of preambles indicated in the system information. In one example, if a UE is configured by system information with a first set of preamble for “no early” SRS and a second of preambles for “early SRS”, the UE can:
If the UE transmits a preamble associated with “no early SRS”, the UE doesn't expect to receive a trigger for early SRS in a contention resolution message, or in Msg4, or in a DCI Format scheduling Msg4. In a variant example, if a UE receives a trigger for early SRS in a contention resolution message, or in Msg4, or in a DCI Format scheduling Msg4, the UE ignores the trigger.
In one example, if the UE transmits a preamble associated with “early SRS”, the contention resolution message, or Msg4, or DCI Format scheduling Msg4 doesn't include a flag for early SRS trigger, the UE transmits the early SRS upon receiving the contention resolution message, or Msg4, or DCI Format scheduling Msg4.
In one example, if the UE transmits a preamble associated with “early SRS”, the contention resolution message, or Msg4, or DCI Format scheduling Msg4 includes a flag for early SRS trigger, based on the flag in the UE transmits or doesn't transmit the early SRS upon receiving the contention resolution message, or Msg4, or DCI Format scheduling Msg4.

For brevity, only the contention resolution message is referred to in the following.

In one example, a UE is indicated in the contention resolution message to transmit a SRS. In one example, a flag or a field in the contention resolution message can indicate whether the UE transmits SRS in response to receiving the contention resolution message.

In one example, a MAC CE in the contention resolution message can provide a configuration for SRS transmission by the UE.

In one example, the UE determines the early SRS resource or resources to transmit based in the antenna switching capability if known. In one example, the antenna switching capability (e.g., xTyR or whether it is supported or not) is signaled based on a preamble and/or RO index or group and/or signaling in Msg3 as aforementioned.

In one example, M SRS resources are configured by system information. In one example, the SRS resource ID (and/or SRS resource set ID) transmitted by a UE is determined based on one or more of the following:
Based on a C-RNTI conveyed by the contention resolution, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the contention resolution.
Based on the preamble index associated with the random access procedure.
Based on the PRACH occasion (RO) associated with the RAR.
Based on the preamble index and PRACH occasion (RO) associated with the RAR.
Based on the group of the preamble and/or RO associated with the RAR as aforementioned.
Based on signaling in Msg3.
Based on the antenna switching capability or a default antenna switching capability is antenna switching capability is unknown at the time of early SRS transmission or early SRS triggering.
The time and/or frequency resources of a DCI format scheduling a contention resolution or of the contention resolution.
Based on the resource used for HARQ-ACK acknowledgment of contention resolution.
Based on an information provided by a MAC CE in the contention resolution message.

In one example, in case of antenna switching, with multiple SRS resources, an SRS resource ID (and/or SRS resource set ID) can be determined by or be linked or mapped to multiple SRS resources based on the antenna switching capability, and the corresponding number of SRS resources.

In one example, the network configures SRS resource(s) for each preamble-ID. In one example, the network configures SRS resource(s) for each RO within a frame. In one example, the network configures SRS resource(s)) for each RO within an association period. In one example, the network configures SRS resource(s) for each RO within an association pattern period. In one example, the network configures SRS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the contention resolution and/or in the contention resolution message.
In a variant, the SRS configuration parameters (or a subset of them) for the SRS resource can be included in the DCI Format scheduling the contention resolution message and/or in the contention resolution message instead of or in addition to the SRS ID. Wherein the configuration parameters for the SRS resource can be as aforementioned

In one example, the SRS resource can be transmitted at or after a time T after the end (or start) of the PDSCH reception providing the contention resolution message or of the PDCCH reception providing the DCI Format scheduling the contention resolution message associated with the UE transmitting SRS. In one example, the slot or subframe or frame used to transmit SRS resource can be at or after a time T after the end (or start) of the PDSCH reception providing the contention resolution message or of the PDCCH reception providing the DCI Format scheduling the contention resolution message associated with the UE transmitting SRS. In one example, the slot or subframe or frame used to transmit SRS resource is that first slot or subframe or frame that starts at or after a time T after the end (or start) of the PDSCH reception providing the contention resolution message or of the PDCCH reception providing the DCI Format scheduling the contention resolution message associated with the UE transmitting SRS and optionally based on an offset and a periodicity as illustrated in FIG. 13 (the SRS instances can be one-shot, N-shots or semi-persistent), where SRS trigger can be replaced by the PDSCH providing the contention resolution message or the PDCCH providing the DCI Format scheduling the contention resolution message associated with the UE transmitting SRS transmission. Wherein, the time T can be defined in the system specifications and/or configured or updated by network (e.g., using SIB signaling and/or RRC signaling and/or MAC CE signaling and/or L1 control signaling).

In one example, an SRS transmission is triggered in MsgB of a Type-2 random access procedure. In one example, MsgB is for successRAR. In one example, MsgB is for a fallback RAR. In one example, an SRS transmission is triggered in MsgB successRAR of a contention-based random access procedure. In one example, an SRS transmission is triggered in MsgB fallbackRAR of a contention-free random access procedure. In one example, the SRS is triggered in a successRAR or fallbackRAR if the UE supports early SRS. In one example, the indication of the support of early SRS is indicated by the preamble and/or PRACH Occasion (RO) used for the Type-2 random access procedure. For example, the preambles and/or ROs of the MsgA PRACH can be partitioned into 2 groups g₀, g₁, if a UE doesn't support early SRS or doesn't request early SRS a preamble and/or RO in the first group is used (e.g. g.), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by MsgA PUSCH of the random access procedure. In a variant example, MsgA PUSCH can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO of MsgA PRACH (e.g., based on preamble and/or RO group as aforementioned) and signaling in MsgA PUSCH. In one example, early SRS capability in MsgA is indicated by 1 bit in RRC message or using a specific LCID/eLCID in MAC PDU.

In one example, a UE is configured e.g., by a field or flag in the system information to transmit SRS in response to receiving a MsgB. The SRS transmission can be further conditioned on whether the UE transmits an associated MsgA PRACH preamble/RO from a first group of preambles/ROs or from a second group of preambles/ROs indicated in the system information. In one example, if a UE is configured by system information with a first set of preamble for “no early” SRS and a second of preambles for “early SRS”, the UE can:
If the UE transmits a preamble/RO associated with “no early SRS”, the UE doesn't expect to receive a trigger for early SRS in the successRAR or fallbackRAR. In a variant example, if a UE receives a trigger for early SRS in the successRAR or fallbackRAR, the UE ignores the trigger.
In one example, if the UE transmits a preamble/RO associated with “early SRS”, the successRAR or fallbackRAR doesn't include a flag for early SRS trigger, the UE transmits the early SRS upon receiving the successRAR or fallbackRAR.
In one example, if the UE transmits a preamble/RO associated with “early SRS”, the successRAR or fallbackRAR includes a flag for early SRS trigger, based on the flag in the UE transmits or doesn't transmit the early SRS upon receiving the successRAR or fallbackRAR.

In one example, a UE is indicated in the MsgB to transmit a SRS. In one example, a flag or a field in the MsgB can indicate whether the UE transmits SRS in response to receiving the MsgB. In one example, MsgB can include a fallback RAR. In one example, MsgB can include a success RAR. In one example, a field in the MAC sub-header for success RAR or the fallback RAR, e.g., a reserved field in the MAC sub-header for the success RAR or fallback RAR can be used to trigger the SRS, for example, a value of “1” triggers the SRS, and a value of “0” doesn't trigger the SRS. In one example, a field in the success RAR or fallback RAR, e.g., a reserved field in the success RAR or fallback RAR can be used to trigger the SRS, for example, a value of “1” triggers the SRS, and a value of “0” doesn't trigger the SRS.

In one example, a UE is indicated by a flag (e.g., one-bit flag) or a special bit pattern in the MsgB (e.g., fallbackRAR or successRAR) to transmit SRS. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the flag (e.g., one-bit flag) is included in the MAC sub-header for the success RAR or fallback RAR, e.g., for Type-2 Random Access Procedure. In one example, the flag (e.g., one-bit flag) is included in MsgB (e.g., fallbackRAR or successRAR), e.g., for Type-2 Random Access Procedure. In one example, the flag (e.g., one-bit flag) is included in the UL Grant of MsgB (e.g., fallbackRAR), e.g., for Type-2 Random Access Procedure. In one example, a special bit pattern of fields in the UL Grant of MsgB (e.g., fallbackRAR), e.g., for Type-2 Random Access Procedure, indicates transmission of SRS. In one example, the flag (e.g., one-bit flag) is included in the DCI scheduling PDSCH of MsgB (e.g., fallbackRAR or successRAR). In one example, a special bit pattern of fields in the DCI scheduling the PDSCH of MsgB (e.g., fallbackRAR or successRAR) indicates transmission of SRS.

In one example, a UE is indicated by a SRS resource in MsgB (e.g., fallbackRAR or successRAR) to use for SRS transmission. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the SRS resource is included in MsgB (e.g., fallbackRAR or successRAR), e.g., for Type-2 Random Access Procedure. In one example, the SRS resource is included in the UL Grant of MsgB (e.g., fallbackRAR), e.g., for Type-2 Random Access Procedure. In one example, the SRS resource is included in the DCI scheduling the PDSCH of MsgB (e.g., fallbackRAR or successRAR). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs of MsgA PRACH are portioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource.

In one example, a UE is indicated by a flag (e.g., one-bit flag) or a special bit pattern in MsgB (e.g., fallbackRAR or successRAR) to transmit SRS and is indicated an SRS resource in MsgB (e.g., fallbackRAR or successRAR). In one example, the UE transmits SRS instead of or in place of PUSCH Msg3, e.g., scheduled by fallbackRAR. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource. The indication of the flag (e.g., one-bit flag) or special pattern and the SRS resource can follow one of the examples of Table 6.

In one example, the UE determines the early SRS resource or resources to transmit based in the antenna switching capability if known. In one example, the antenna switching capability (e.g., xTyR or whether it is supported or not) is signaled based on a preamble and/or RO index or group of MsgA PRACH and/or signaling in MsgA PUSCH as aforementioned.

TABLE 6

| Example | flag (e.g., one-bit flag) | |
|---|---|---|
| number | or special pattern | SRS resource |
| Example 1 | MsgB (e.g., fallbackRAR | MsgB (e.g., fallbackRAR |
| | or successRAR) | or successRAR) |
| Example 2 | MsgB (e.g., fallbackRAR | UL grant included in |
| | or successRAR) | MsgB (e.g., fallbackRAR) |
| Example 3 | MsgB (e.g., fallbackRAR | DCI Format scheduling |
| | or successRAR) | PDSCH of MsgB (e.g., |
| | | fallbackRAR or successRAR) |
| Example 4 | UL grant included in | MsgB (e.g., fallbackRAR |
| | MsgB (e.g., fallbackRAR) | or successRAR) |
| Example 5 | UL grant included in | UL grant included in MsgB |
| | MsgB (e.g., fallbackRAR) | (e.g., fallbackRAR) |
| Example 6 | UL grant included in | DCI Format scheduling |
| | MsgB (e.g., fallbackRAR) | PDSCH of MsgB (e.g., |
| | | fallbackRAR or successRAR) |
| Example 7 | DCI Format scheduling | MsgB (e.g., fallbackRAR |
| | PDSCH of MsgB (e.g., | or successRAR) |
| | fallbackRAR or | |
| | successRAR) | |
| Example 8 | DCI Format scheduling | UL grant included in MsgB |
| | PDSCH of MsgB (e.g., | (e.g., fallbackRAR) |
| | fallbackRAR or | |
| | successRAR) | |
| Example 9 | DCI Format scheduling | DCI Format scheduling |
| | PDSCH of MsgB (e.g., | PDSCH of MsgB (e.g., |
| | fallbackRAR or | fallbackRAR or successRAR) |
| | successRAR) | |

In one example, M SRS resources are configured by system information. In one example, the SRS resource ID (and/or SRS resource set ID) transmitted by a UE is determined based on one or more of the following:
Based on a C-RNTI conveyed by the MsgB, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the MsgB.
Based on the preamble index associated with the random access procedure.
Based on the PRACH occasion (RO) associated with the RAR.
Based on the preamble index and PRACH occasion (RO) associated with the RAR.
Based on the group of the preamble and/or RO of MsgA PRACH associated with the successRAR or fallbackRAR as aforementioned.
Based on signaling in MsgB.
Based on the antenna switching capability or a default antenna switching capability is antenna switching capability is unknown at the time of early SRS transmission or early SRS triggering
The time and/or frequency resources of a DCI format scheduling a MsgB or of the MsgB.
Based on the resource used for HARQ-ACK acknowledgment of MsgB.

In one example, in case of antenna switching, with multiple SRS resources, an SRS resource ID (and/or SRS resource set ID) can be determined by or be linked or mapped to multiple SRS resources based on the antenna switching capability, and the corresponding number of SRS resources.

In one example, the network configures SRS resource(s) for each preamble-ID. In one example, the network configures SRS resource(s) for each RO within a frame. In one example, the network configures SRS resource(s) for each RO within an association period. In one example, the network configures SRS resource(s) for each RO within an association pattern period. In one example, the network configures SRS resource(s) for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the MsgB and/or the MsgB.
In a variant, the SRS configuration parameters (or a subset of them) for the SRS resource can be included in the DCI Format scheduling the MsgB and/or the MsgB instead of or in addition to the SRS ID. Wherein the configuration parameters for the SRS resource can be as aforementioned

In one example, the SRS resource can be transmitted at or after a time T after the end (or start) of the PDSCH reception providing MsgB or of the PDCCH reception providing the DCI Format scheduling the MsgB associated with the UE transmitting SRS. In one example, the slot or subframe or frame used to transmit SRS resource can be at or after a time T after the end (or start) of the PDSCH reception providing MsgB or of the PDCCH reception providing the DCI Format scheduling the MsgB associated with the UE transmitting SRS. In one example, the slot or subframe or frame used to transmit SRS resource is that first slot or subframe or frame that starts at or after a time T after the end (or start) of the PDSCH reception providing MsgB or of the PDCCH reception providing the DCI Format scheduling the MsgB associated with the UE transmitting SRS and optionally based on an offset and a periodicity as illustrated in FIG. 13 (the SRS instances can be one-shot, N-shots or semi-persistent), where SRS trigger can be replaced by the MsgB or the PDCCH reception providing the DCI Format scheduling the MsgB associated with the UE transmitting SRS. Wherein, the time T can be defined in the system specifications and/or configured or updated by network (e.g., using SIB signaling and/or RRC signaling and/or MAC CE signaling and/or L1 control signaling).

In the aforementioned examples,
UE transmits a preamble for a Type-1 random access procedure or a Type-2 random access procedure. In one example, a Type-2 random access procedure includes a PRACH and a PUSCH.
In one example, the preambles and/or ROs are partitioned into 2 groups or into groups, wherein the preamble and/or RO group used for the random access procedure can indicate whether or not the UE supports early SRS. In other examples, the preamble and/or RO group used for the random access procedure can indicate an SRS antenna switching capability (xTyR) or the UE doesn't support SRS antenna switching.
In one example, for Type-2 random access procedure, MsgA PRACH (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching.
The network responds to the preamble of the Type-1 random access procedure or the Type-2 random access procedure, with a RAR or a success RAR or a fallback RAR.
   In one example, the RAR or a success RAR or a fallback RAR includes a trigger for SRS,
   In one example, the RAR or a success RAR or a fallback RAR indicates a resource(s) for SRS, e.g., explicitly or based on preamble ID or RO or TC-RNTI or C-RNTI or antenna switching capability if known, or default antenna switching capability as aforementioned.
   In one example, the SRS resource(s) is transmitted before Msg3.
   In one example, the SRS resource(s) is transmitted after Msg3. In a further example, Msg3 can indicate capability of UE to support early SRS and/or SRS antenna switching capability (xTyR) or the UE doesn't support SRS antenna switching, transmission of early SRS and/or early SRS resource(s) can be based on signaling in Msg3,
   In one example, the SRS resource is transmitted with (or as part of) Msg3.
   In one example, the SRS resource is transmitted after Msg4.
   In one example, the SRS resource is transmitted after UE is in connected state.
For type 1 random access procedure, the UE transmits Msg3. In one example, Msg3 includes C-RNTI MAC CE or CCCH SDU.
In one example, for Type-1 random access procedure, Msg3 (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching
The network responds to the Msg3 of the Type-1 random access procedure with a Msg4
   In one example, the Msg4 includes a trigger for SRS,
   In one example, the Msg4 indicates a resource for SRS, e.g., explicitly or based on preamble ID or RO or TC-RNTI or C-RNTI or antenna switching capability if known, or default antenna switching capability as aforementioned.
   In one example, the SRS resource is transmitted after UE is in connected state.

According to or following those specified/defined herein in the present disclosure,
A UE receives in system information (e.g., SIB1, SIB2, etc.) information related to channel measurement resource(s), interference measurement resource(s) in terms/form their resource ID(s)/index(es), resource set ID(s)/index(es), resource setting ID(s)/index(es) and/or etc. e.g. provided by earlyCsi-ResourceConfig, and/or their corresponding CSI reporting setting(s) e.g. provided by earlyCsi-ReportConfig, and/or SRS resource configuration(s) including SRS resource set(s) and/or SRS resource(s) for early SRS, and/or their association(s) to one or more preamble IDs and/or ROs as specified/defined herein in the present disclosure for (early) CSI measurement/reporting and (early) SRS; in addition, the system information could also comprise indicator(s) to enable early SRS and early CSI acquisition, and/or minimum time offset(s) required (e.g., value T in the above described design examples) between the CSI acquisition/SRS triggering signaling (e.g., Msg2 RAR, Msg4, PDCCH that schedules the RAR, PDCCH that schedules the Msg4, etc.) and the actual measurement/reception of CSI-RS(s) and/or transmission of CSI report(s) and/or transmission of SRS(s).
The UE transmits a preamble for a Type-1 random access procedure or a Type-2 random access procedure. In one example, a Type-2 random access procedure includes a PRACH and a PUSCH.
   In one example, the preambles and/or ROs are partitioned into 2 groups or into groups, wherein the preamble and/or RO group used for the random access procedure can indicate whether or not the UE supports early CSI and SRS. In other examples, the preamble and/or RO group used for the random access procedure can indicate a CSI report type and/or an SRS antenna switching capability (xTyR) or the UE doesn't support SRS antenna switching.
   In one example, for Type-2 random access procedure, MsgA PRACH (based on preamble and/or RO group) and/or MsgA PUSCH (based on signaling in MsgA PUSCH) can indicate capability of UE to support early CSI/SRS and/or CSI report type(s) and/or capability of UE to support early SRS and/or SRS antenna switching capability (xTyR) or the UE doesn't support SRS antenna switching.
The network responds to the preamble of the Type-1 random access procedure or the Type-2 random access procedure, with a RAR or a success RAR or a fallback RAR, wherein the RAR/success RAR/fallback RAR could include or comprise information related to early CSI measurement/reporting,
   In one example, the RAR or a success RAR or a fallback RAR includes a trigger for CSI measurement
   In one example, the RAR or a success RAR or a fallback RAR includes a trigger for CSI reporting
   In one example, the RAR or success RAR or a fallback RAR includes a trigger for CSI measurement and reporting
   In one example, the RAR or success RAR or a fallback RAR includes minimum time offset(s) required (e.g., value T in the above described design examples) between the RAR/success RAR/fallback RAR (or the corresponding scheduling PDCCH) and the actual measurement/reception of CSI-RS(s) and/or transmission of CSI report(s)
   In one example, the RAR/success RAR/fallback RAC includes UL resource(s)/grant for CSI reporting
   In one example, the RAR or a success RAR or a fallback RAR indicates CSI-RS resource(s) for CSI measurement and/or resource(s) for CSI reporting, e.g., explicitly or based on preamble ID or RO or TC-RNTI or C-RNTI or CSI report type(s) if known, or default CSI report type(s) as aforementioned.
The trigger for CSI measurement could point to or could be associated or linked to one or more CSI-RS resources and/or one or more CSI resource sets provided or configured in the system information for (early) CSI measurement and/or reporting. The RAR/success RAR/fallback RAR could also or additionally include or comprise information related to early SRS
   In one example, the RAR or a success RAR or a fallback RAR includes a trigger for SRS,
   In one example, the RAR or a success RAR or a fallback RAR indicates a resource(s) for SRS, e.g., explicitly or based on preamble ID or RO or TC-RNTI or C-RNTI or antenna switching capability if known, or default antenna switching capability as aforementioned.
   In one example, the SRS resource(s) is transmitted before Msg3.
   In one example, the SRS resource(s) is transmitted after Msg3. In a further example, Msg3 can indicate capability of UE to support early SRS and/or SRS antenna switching capability (xTyR) or the UE doesn't support SRS antenna switching, transmission of early SRS and/or early SRS resource(s) can be based on signaling in Msg3,
   In one example, the SRS resource is transmitted with (or as part of) Msg3.
   In one example, the SRS resource is transmitted after Msg4.
   In one example, the SRS resource is transmitted after UE is in connected state.
For Type 1 random access procedure, the UE transmits Msg3. Here, Msg3 could comprise or include information related to (early) CSI measurement/reporting,
   In one example, Msg3 includes C-RNTI MAC CE or CCCH SDU.
   In one example, for Type-1 random access procedure, Msg3 (based on preamble and/or RO group) and/or MsgA PUSCH (based on signaling in MsgA PUSCH) can indicate capability of UE to support early CSI acquisition and/or UE's support of CSI report type(s).
   In one example, Msg3 includes an indicator to indicate to the network that (or whether or not) the UE has available CSI report(s) to transmit.
   In one example, Msg3 includes the CSI report(s), wherein the CSI report(s) could be triggered by the trigger in the RAR/success RAR/fallback RAR as aforementioned, and/or
   the UE could identify or determine to the CSI report(s) according to and/or include the CSI report(s) in Msg3 when/if the system information comprises information related to (early) CSI measurement/reporting such as the indicator(s) to indicate/enable/configure early CSI, CSI resource setting(s), CSI reporting setting(s) and/or etc. for (early) CSI acquisition as specified/defined herein in the present disclosure.
The Msg3 could also or additionally include or comprise information related to (early) SRS:
   In one example, Msg3 includes C-RNTI MAC CE or CCCH SDU.
   In one example, for Type-1 random access procedure, Msg3 (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching
The network responds to the Msg3 of the Type-1 random access procedure with a Msg4, wherein the Msg4 could comprise (e.g., when/if Msg3 includes the indicator to indicate that the UE has available CSI report(s) to transmit) information related to (early) CSI measurement/reporting
   In one example, the Msg4 includes a trigger for CSI measurement
   In one example, the Msg4 includes a trigger for CSI reporting
   In one example, the Msg4 includes a trigger for CSI measurement and reporting
   In one example, the Msg4 includes minimum time offset(s) required (e.g., value T in the above described design examples) between the Msg4 (or the corresponding scheduling PDCCH) and the actual measurement/reception of CSI-RS(s) and/or transmission of CSI report(s)
   In one example, the Msg4 includes UL resource(s)/grant for CSI reporting
   In one example, the Msg4 indicates CSI-RS resource(s) for CSI measurement and/or resource(s) for CSI reporting, e.g., explicitly or based on preamble ID or RO or TC-RNTI or C-RNTI or CSI report type(s) if known, or default CSI report type(s) as aforementioned.
   In one example, when/if Msg1 and/or Msg3 includes and/or indicates capability of UE to support early CSI acquisition and/or UE's support of CSI report type(s), the Msg4 could include information related to channel measurement resource(s), interference measurement resource(s) in terms/form their resource ID(s)/index(es), resource set ID(s)/index(es), resource setting ID(s)/index(es) and/or etc. e.g. provided by earlyCsi-ResourceConfig, and/or their corresponding CSI reporting setting(s) e.g. provided by earlyCsi-ReportConfig, and/or their association(s) to one or more preamble IDs and/or ROs as specified/defined herein in the present disclosure for (early) CSI measurement/reporting; in addition, the system information could also comprise indicator(s) to enable early CSI acquisition, and/or minimum time offset(s) required (e.g., value T in the above described design examples) between the CSI acquisition triggering signaling (e.g., Msg4, PDCCH that schedules Msg4, etc.) and the actual measurement/reception of CSI-RS(s) and/or transmission of CSI report(s).
The trigger for CSI measurement could point to or could be associated or linked to one or more CSI-RS resources and/or one or more CSI resource sets provided or configured in the system information, and/or provided or indicated in Msg4, for (early) CSI measurement and/or reporting. The Msg4 could also or in addition comprise or include information related to (early) SRS:
   In one example, the Msg4 includes a trigger for SRS,
   In one example, the Msg4 indicates a resource for SRS, e.g., explicitly or based on preamble ID or RO or TC-RNTI or C-RNTI or antenna switching capability if known, or default antenna switching capability as aforementioned.
   In one example, the SRS resource is transmitted after UE is in connected state.

A UE can receive from the network (e.g., a/the PCell), a Scell activation/deactivation MAC CE command, to indicate activation of a (target) Scell. When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least measuring CSI-RS(s) after receiving the Scell activation/deactivation MAC CE command for/of the (target) Scell activated/indicated therein is enabled,
In one example (Option-1), the UE could start measuring or measure the CSI-RS(s) corresponding to the CSI-RS resource(s) associated, provided, indicated, triggered, activated or configured with/for the activated/indicated target Scell, after reception of the corresponding Scell activation/deactivation MAC CE command that indicates/activates the target Scell. In this case, CSI-RS resource(s) associated, provided, indicated, triggered, activated or configured with/for the activated/indicated target Scell before reception of the corresponding Scell activation/deactivation MAC CE command may not be counted as active CSI-RS resource(s) for the target Scell.
   For example, the UE could start measuring the CSI-RS(s) corresponding to the periodic CSI-RS resource(s) associated, provided or configured with/for the activated/indicated target Scell, at least X symbol(s)/slot(s)/ms/etc. after reception of the corresponding Scell activation/deactivation MAC CE command that indicates/activates the target Scell (e.g., in n+X slot/symbol, wherein n is the first (or last) slot/symbol that the UE receives the corresponding Scell activation/deactivation MAC CE command that indicates/activates the target Scell), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
   For another example, the UE could start measuring the CSI-RS(s) corresponding to the periodic CSI-RS resource(s) associated, provided or configured with/for the activated/indicated target Scell, at least Y symbol(s)/slot(s)/ms/etc. after a/the first (or last) symbol/slot/etc. of HARQ-ACK transmission corresponding or specific or associated to or for the PDSCH(s) that carries or conveys the corresponding Scell activation/deactivation MAC CE command that indicates/activates the target Scell (e.g., in n+Y slot/symbol, wherein n is the first (or last) slot/symbol that the UE transmits the HARQ-ACK), wherein the UE could determine or identify value(s) of Y according to or based on: (1) fixed value(s), e.g., Y=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
   For another example, the UE could measure the CSI-RS(s) corresponding to the CSI-RS resource(s) activated for the activated/indicated target Scell, after reception of the corresponding Scell activation/deactivation MAC CE command that indicates/activates the target Scell. In one example, the CSI-RS resource(s) could be activated by a SP CSI-RS/CSI-IM Resource Set Activation/Deactivation MAC CE associated with the target Scell—e.g., received from the target Scell and/or comprising a/the serving cell ID of the target Scell. In another example, the CSI-RS resource(s) could be activated by the Scell activation/deactivation MAC CE command, wherein the Scell activation/deactivation MAC CE command could comprise field(s) that indicates information related to the CSI-RS resource(s), e.g., in terms/form of the corresponding CSI-RS resource ID(s)/index(es) and/or CSI resource set ID(s)/index(es), for the target Scell.
   For another example, the UE could measure the CSI-RS(s) corresponding to the CSI-RS resource(s) triggered for the activated/indicated target Scell, after reception of the corresponding Scell activation/deactivation MAC CE command that indicates/activates the target Scell. Here, the CSI-RS resource(s) could be provided by one or more CSI resource settings associated, linked or mapped to one or more CSI reporting settings associated, linked or mapped to a trigger state indicated by a non-zero CSI request field from a list of trigger states provided by CSI-AperiodicTriggerStateList, wherein the one or more CSI resource settings and/or the one or more CSI reporting settings could be associated, corresponding or specific to the (indicated/activated) target Scell. The CSI request field could be indicated in
      A DCI e.g. DCI format(s) 0_1/0_2/0_3 received from the target Scell and/or after reception of the Scell activation/deactivation MAC CE command that triggers transmission(s) of the CSI-RS(s)
      A DCI that schedules DL resource(s) e.g. PDSCH(s) that carries the Scell activation/deactivation MAC CE command
      The Scell activation/deactivation MAC CE that indicates/activates the target Scell
In one example (Option-2), the UE could measure the CSI-RS(s) corresponding to the (e.g., periodic, semi-persistent or aperiodic) CSI-RS resource(s) associated, provided, indicated, triggered, activated or configured with/for the activated/indicated target Scell, before reception of the corresponding Scell activation/deactivation MAC CE command that indicates/activates the target Scell. In this case, CSI-RS resource(s) associated, provided, indicated, triggered, activated or configured with/for the activated/indicated target Scell before reception of the corresponding Scell activation/deactivation MAC CE command could be counted as active CSI-RS resource(s) for the target Scell. Furthermore, the UE may not perform any measurement(s) on the CSI-RS(s) corresponding to the CSI-RS resource(s) associated, provided, indicated, triggered, activated or configured with/for the activated/indicated target Scell, after reception of the corresponding Scell activation/deactivation MAC CE command that indicates/activates the target Scell, according to or following those specified/defined herein in the present disclosure (e.g., those in Option-1). In this case, CSI-RS resource(s) associated, provided, indicated, triggered, activated or configured with/for the activated/indicated target Scell after reception of the corresponding Scell activation/deactivation MAC CE command may not be counted as active CSI-RS resource(s) for the target Scell.
In one example (Option-3), the UE could measure the CSI-RS(s) corresponding to the (e.g., periodic, semi-persistent or aperiodic) CSI-RS resource(s) associated, provided, indicated, triggered, activated or configured with/for the activated/indicated target Scell, before reception of the corresponding Scell activation/deactivation MAC CE command that indicates/activates the target Scell. Furthermore, the UE could also measure the CSI-RS(s) corresponding to the CSI-RS resource(s) associated, provided, indicated, triggered, activated or configured with/for the activated/indicated target Scell, after reception of the corresponding Scell activation/deactivation MAC CE command that indicates/activates the target Scell, according to or following those specified/defined herein in the present disclosure (e.g., those in Option-1). In this case, CSI-RS resource(s) associated, provided, indicated, triggered, activated or configured with/for the activated/indicated target Scell before and after reception of the corresponding Scell activation/deactivation MAC CE command could be counted as active CSI-RS resource(s) for the target Scell.

The UE could be configured or enabled or indicated by the network, e.g., via/by/in higher layer RRC signalling(s)/parameter(s) and/or MAC CE command(s) and/or dynamic DCI based L1 signaling(s), to follow those specified/described in Option-1, Option-2 and/or Option-3 according to or based on a corresponding UE's capability or capability signalling, wherein the UE′ capability or capability signalling could comprise one or more of the following components that the UE could support or could be capable of:
{Option-1}
{Option-2}
{Option-3}
{Option-1, Option-2}
{Option-1, Option-3}
{Option-2, Option-3}
{Option-1, Option-2, Option-3}

According to or following those specified/defined herein in the present disclosure, a UE can receive from the network, a Scell activation/deactivation MAC CE command, to indicate activation of a (target) Scell. When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least CSI reporting after receiving the Scell activation/deactivation MAC CE command for/of the (target) Scell activated/indicated therein is enabled, the UE could send or transmit the CSI report(s) associated, corresponding or specific to or for the activated/indicated target Scell via/in/on corresponding UL resource(s)/channel(s) including (CG Type 1/2 and/or DG) PUSCH(s) and/or PUCCH(s) associated or specific to or for the activated/indicated target Scell, after reception of the corresponding Scell activation/deactivation MAC CE command that indicates/activates the target Scell.
In one example, the UE could send or transmit the CSI report(s) associated, corresponding or specific to or for the activated/indicated target Scell via/in/on the first available UL resource(s)/channel(s) including (CG Type 1/2 and/or DG) PUSCH(s) and/or PUCCH(s) associated or specific to or for the activated/indicated target Scell, at least X symbol(s)/slot(s)/ms/etc. after reception of the corresponding Scell activation/deactivation MAC CE command that indicates/activates the target Scell (e.g., in n+X slot/symbol, wherein n is the first (or last) slot/symbol that the UE receives the corresponding Scell activation/deactivation MAC CE command that indicates/activates the target Scell), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could send or transmit the CSI report(s) associated, corresponding or specific to or for the activated/indicated target Scell via/in/on the first available UL resource(s)/channel(s) including (CG Type1/2 and/or DG) PUSCH(s) and/or PUCCH(s) associated or specific to or for the activated/indicated target Scell, at least Y symbol(s)/slot(s)/ms/etc. after a/the first (or last) symbol/slot/etc. of HARQ-ACK transmission corresponding or specific or associated to or for the PDSCH(s) that carries or conveys the corresponding Scell activation/deactivation MAC CE command that indicates/activates the target Scell (e.g., in n+Y slot/symbol, wherein n is the first (or last) slot/symbol that the UE transmits the HARQ-ACK), wherein the UE could determine or identify value(s) of Y according to or based on: (1) fixed value(s), e.g., Y=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could send or transmit the CSI report(s) associated, corresponding or specific to or for the activated/indicated target Scell via/in/on the semi-persistent UL resource(s)/channel(s) including PUCCH(s) and/or PUSCH(s) associated or specific to or for the activated/indicated target Scell, after reception of the corresponding Scell activation/deactivation MAC CE command that indicates/activates the target Scell. In one example, the semi-persistent UL resource(s)/channel(s)—e.g., PUCCH(s)—for carrying or conveying the CSI report(s) could be activated by a SP CSI reporting on PUCCH activation/deactivation MAC CE associated with the target Scell—e.g., received from the target Scell and/or comprising a/the serving cell ID of the target Scell. In another example, the semi-persistent UL resource(s)/channel(s)—e.g., PUCCH(s)—for carrying or conveying the CSI report(s) could be activated by the Scell activation/deactivation MAC CE command, wherein the Scell activation/deactivation MAC CE command could comprise field(s) that indicates information related to the semi-persistent UL resource(s)/channel(s) e.g. PUCCH(s) that could be used to convey or carry the CSI report(s), e.g., indicating the activation/deactivation status of the corresponding semi-persistent CSI report configuration.
In another example, the UE could send or transmit the CSI report(s) associated, corresponding or specific to or for the activated/indicated target Scell via/in/on the semi-persistent UL resource(s)/channel(s) including PUCCH(s) and/or PUSCH(s) associated or specific to or for the activated/indicated target Scell, after reception of the corresponding Scell activation/deactivation MAC CE command that indicates/activates the target Scell. In one example, the semi-persistent UL resource(s)/channel(s)—e.g., PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-AperiodicTriggerStateList, wherein the one or more CSI reporting settings could be associated, corresponding or specific to the (indicated/activated) target Scell, and the CSI request field could be indicated in
   A first DCI e.g. DCI format(s) 0_1/0_2/0_3 received from the target Scell and/or after reception of the Scell activation/deactivation MAC CE command that activates the semi-persistent UL resource(s)/channel(s) including PUSCH(s) for CSI reporting
   A second DCI that schedules DL resource(s) e.g. PDSCH(s) that carries the Scell activation/deactivation MAC CE command
   The Scell activation/deactivation MAC CE that indicates/activates the target Scell
Furthermore, the aforementioned first DCI, second DCI and/or the Scell activation/deactivation MAC CE could also comprise, indicate, include or contain UL grant for the (semi-persistent) UL channel(s)/resource(s) including PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.
In another example, the UE could send or transmit the CSI report(s) associated, corresponding or specific to or for the activated/indicated target Scell via/in/on aperiodic UL resource(s)/channel(s) including DG PUSCH(s) associated or specific to or for the activated/indicated target Scell, after reception of the corresponding Scell activation/deactivation MAC CE command that indicates/activates the target Scell. In one example, the aperiodic UL resource(s)/channel(s)—e.g., DG PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-AperiodicTriggerStateList, wherein the one or more CSI reporting settings could be associated, corresponding or specific to the (indicated/activated) target Scell, and the CSI request field could be indicated in
   A first DCI e.g. DCI format(s) 0_1/0_2/0_3 received from the target Scell and/or after reception of the Scell activation/deactivation MAC CE command that indicates the aperiodic UL resource(s)/channel(s) including DG PUSCH(s) for CSI reporting
   A second DCI that schedules DL resource(s) e.g. PDSCH(s) that carries the Scell activation/deactivation MAC CE command
   The Scell activation/deactivation MAC CE that indicates/activates the target Scell
Furthermore, the aforementioned first DCI, second DCI and/or the Scell activation/deactivation MAC CE could also comprise, indicate, include or contain UL grant for the aperiodic UL channel(s)/resource(s) including DG PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.

According to or following those specified/defined herein in the present disclosure, a UE can receive from the network, a Scell activation/deactivation MAC CE command, to indicate activation of a (target) Scell. For transmitting SRS(s) to acquire CSI when/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least SRS transmission(s) after receiving the Scell activation/deactivation MAC CE command for/of the (target) Scell activated/indicated therein is enabled, the UE could transmit SRS(s) corresponding to SRS resource(s) associated, corresponding or specific to or for the activated/indicated target Scell, after reception of the corresponding Scell activation/deactivation MAC CE command that indicates/activates the target Scell.
In one example, the UE could send or transmit the SRS(s) corresponding to the SRS resource(s) associated, corresponding or specific to or for the activated/indicated target Scell, at least X symbol(s)/slot(s)/ms/etc. after reception of the corresponding Scell activation/deactivation MAC CE command that indicates/activates the target Scell (e.g., in n+X slot/symbol, wherein n is the first (or last) slot/symbol that the UE receives the corresponding Scell activation/deactivation MAC CE command that indicates/activates the target Scell), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could transmit the SRS(s) corresponding to the SRS resource(s) associated, corresponding or specific to or for the activated/indicated target Scell, at least Y symbol(s)/slot(s)/ms/etc. after a/the first (or last) symbol/slot/etc. of HARQ-ACK transmission corresponding or specific or associated to or for the PDSCH(s) that carries or conveys the corresponding Scell activation/deactivation MAC CE command that indicates/activates the target Scell (e.g., in n+Y slot/symbol, wherein n is the first (or last) slot/symbol that the UE transmits the HARQ-ACK), wherein the UE could determine or identify value(s) of Y according to or based on: (1) fixed value(s), e.g., Y=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could transmit the SRS(s) corresponding to the semi-persistent SRS resource(s) associated, corresponding or specific to or for the activated/indicated target Scell, after reception of the corresponding Scell activation/deactivation MAC CE command that indicates/activates the target Scell. In one example, the semi-persistent SRS resource(s) could be activated by a SP SRS activation/deactivation MAC CE associated with the target Scell—e.g., received from the target Scell and/or comprising a/the serving cell ID of the target Scell. In another example, the semi-persistent SRS resource(s) could be activated by the Scell activation/deactivation MAC CE command, wherein the Scell activation/deactivation MAC CE command could comprise field(s) that indicates information related to the semi-persistent SRS resource(s), e.g., in form/terms of the corresponding SRS resource set ID(s)/index(es) and/or the SRS resource ID(s)/index(es).
In another example, the UE could transmit the SRS(s) corresponding to the aperiodic SRS resource(s) associated, corresponding or specific to or for the activated/indicated target Scell, after reception of the corresponding Scell activation/deactivation MAC CE command that indicates/activates the target Scell. In one example, the aperiodic SRS resource(s) could be triggered by a (non-zero) SRS request field indicated in
   A first DCI e.g. DCI format(s) 0_1/0_2/0_3 received from the target Scell and/or after reception of the Scell activation/deactivation MAC CE command that indicates the aperiodic SRS resource(s)
   A second DCI that schedules DL resource(s) e.g. PDSCH(s) that carries the Scell activation/deactivation MAC CE command
   The Scell activation/deactivation MAC CE that indicates/activates the target Scell
Furthermore, the aforementioned first DCI, second DCI and/or the Scell activation/deactivation MAC CE could also comprise, indicate, include or contain SRS resource set indicator(s), SRS resource indicator(s), second SRS resource set indicator(s) and/or SRS offset indicator(s) related to the triggered or indicated aperiodic SRS resource(s).

A UE can receive from the network (e.g., a/the PCell), a Scell switching signaling e.g. in form/terms of a downlink control signaling PDCCH of a DCI format received in a CORESET with a corresponding Scell switching field set to ‘1’ or ‘enabled’, to indicate a (target) Scell to which the UE could switch their downlink and/or uplink control and/or data channel(s)/signal(s). When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least measuring CSI-RS(s) after receiving the Scell switching signaling is enabled for a/the target Scell,
In one example (Option-1), the UE could start measuring or measure the CSI-RS(s) corresponding to the CSI-RS resource(s) associated, provided, indicated, triggered, activated or configured with/for the target Scell, after reception of the Scell switching signaling. In this case, CSI-RS resource(s) associated, provided, indicated, triggered, activated or configured with/for the target Scell before reception of the corresponding Scell switching signaling may not be counted as active CSI-RS resource(s) for the target Scell.
   For example, the UE could start measuring the CSI-RS(s) corresponding to the periodic CSI-RS resource(s) associated, provided or configured with/for the target Scell, at least X symbol(s)/slot(s)/ms/etc. after reception of the corresponding Scell switching signalling (e.g., in n+X slot/symbol, wherein n is the first (or last) slot/symbol that the UE receives the corresponding Scell switching signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
   For another example, the UE could measure the CSI-RS(s) corresponding to the CSI-RS resource(s) activated for the target Scell, after reception of the corresponding Scell switching signaling. In one example, the CSI-RS resource(s) could be activated by a SP CSI-RS/CSI-IM Resource Set Activation/Deactivation MAC CE associated with the target Scell—e.g., received from the target Scell and/or comprising a/the serving cell ID of the target Scell. In another example, the CSI-RS resource(s) could be activated by the Scell switching signaling, wherein the Scell switching signaling could comprise field(s) that indicates information related to the CSI-RS resource(s), e.g., in terms/form of the corresponding CSI-RS resource ID(s)/index(es) and/or CSI resource set ID(s)/index(es), for the target Scell.
   For another example, the UE could measure the CSI-RS(s) corresponding to the CSI-RS resource(s) triggered for the target Scell, after reception of the Scell switching signaling. Here, the CSI-RS resource(s) could be provided by one or more CSI resource settings associated, linked or mapped to one or more CSI reporting settings associated, linked or mapped to a trigger state indicated by a non-zero CSI request field from a list of trigger states provided by CSI-AperiodicTriggerStateList, wherein the one or more CSI resource settings and/or the one or more CSI reporting settings could be associated, corresponding or specific to the target Scell. The CSI request field could be indicated in
      A DCI e.g. DCI format(s) 0_1/0_2/0_3 received from the target Scell and/or after reception of the Scell switching signaling
      The Scell switching signaling
In one example (Option-2), the UE could measure the CSI-RS(s) corresponding to the (e.g., periodic, semi-persistent or aperiodic) CSI-RS resource(s) associated, provided, indicated, triggered, activated or configured with/for the target Scell, before reception of the Scell switching signaling. In this case, CSI-RS resource(s) associated, provided, indicated, triggered, activated or configured with/for the target Scell before reception of the Scell switching signaling could be counted as active CSI-RS resource(s) for the target Scell. Furthermore, the UE may not perform any measurement(s) on the CSI-RS(s) corresponding to the CSI-RS resource(s) associated, provided, indicated, triggered, activated or configured with/for the target Scell, after reception of the Scell switching signaling, according to or following those specified/defined herein in the present disclosure (e.g., those in Option-1). In this case, CSI-RS resource(s) associated, provided, indicated, triggered, activated or configured with/for the target Scell after reception of the Scell switching signaling may not be counted as active CSI-RS resource(s) for the target Scell.
In one example (Option-3), the UE could measure the CSI-RS(s) corresponding to the (e.g., periodic, semi-persistent or aperiodic) CSI-RS resource(s) associated, provided, indicated, triggered, activated or configured with/for the target Scell, before reception of the corresponding Scell switching signaling. Furthermore, the UE could also measure the CSI-RS(s) corresponding to the CSI-RS resource(s) associated, provided, indicated, triggered, activated or configured with/for the target Scell, after reception of the corresponding Scell switching signaling, according to or following those specified/defined herein in the present disclosure (e.g., those in Option-1). In this case, CSI-RS resource(s) associated, provided, indicated, triggered, activated or configured with/for the target Scell before and after reception of the corresponding Scell switching signaling could be counted as active CSI-RS resource(s) for the target Scell.

The UE could be configured or enabled or indicated by the network, e.g., via/by/in higher layer RRC signalling(s)/parameter(s) and/or MAC CE command(s) and/or dynamic DCI based L1 signaling(s), to follow those specified/described in Option-1, Option-2 and/or Option-3 according to or based on a corresponding UE's capability or capability signalling, wherein the UE′ capability or capability signalling could comprise one or more of the following components that the UE could support or could be capable of:
{Option-1}
{Option-2}
{Option-3}
{Option-1, Option-2}
{Option-1, Option-3}
{Option-2, Option-3}
{Option-1, Option-2, Option-3}

According to or following those specified/defined herein in the present disclosure, a UE can receive from the network (e.g., a/the PCell), a Scell switching signaling e.g. in form/terms of a downlink control signaling PDCCH of a DCI format received in a CORESET with a corresponding Scell switching field set to ‘l’ or ‘enabled’, to indicate a (target) Scell to which the UE could switch their downlink and/or uplink control and/or data channel(s)/signal(s). When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least CSI reporting after receiving the Scell switching signaling for/of the (target) Scell is enabled, the UE could send or transmit the CSI report(s) associated, corresponding or specific to or for the target Scell via/in/on corresponding UL resource(s)/channel(s) including (CG Type1/2 and/or DG) PUSCH(s) and/or PUCCH(s) associated or specific to or for the target Scell, after reception of the corresponding Scell switching signaling.
In one example, the UE could send or transmit the CSI report(s) associated, corresponding or specific to or for the target Scell via/in/on the first available UL resource(s)/channel(s) including (CG Type1/2 and/or DG) PUSCH(s) and/or PUCCH(s) associated or specific to or for the target Scell, at least X symbol(s)/slot(s)/ms/etc. after reception of the corresponding Scell switching signaling (e.g., in n+X slot/symbol, wherein n is the first (or last) slot/symbol that the UE receives the corresponding Scell switching signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could send or transmit the CSI report(s) associated, corresponding or specific to or for the target Scell via/in/on the semi-persistent UL resource(s)/channel(s) including PUCCH(s) and/or PUSCH(s) associated or specific to or for the target Scell, after reception of the corresponding Scell switching signaling. In one example, the semi-persistent UL resource(s)/channel(s)—e.g., PUCCH(s)—for carrying or conveying the CSI report(s) could be activated by a SP CSI reporting on PUCCH activation/deactivation MAC CE associated with the target Scell—e.g., received from the target Scell and/or comprising a/the serving cell ID of the target Scell. In another example, the semi-persistent UL resource(s)/channel(s)—e.g., PUCCH(s)—for carrying or conveying the CSI report(s) could be activated by the Scell switching signaling, wherein the Scell switching signaling could comprise field(s) that indicates information related to the semi-persistent UL resource(s)/channel(s) e.g. PUCCH(s) that could be used to convey or carry the CSI report(s), e.g., indicating the activation/deactivation status of the corresponding semi-persistent CSI report configuration.
In another example, the UE could send or transmit the CSI report(s) associated, corresponding or specific to or for the target Scell via/in/on the semi-persistent UL resource(s)/channel(s) including PUCCH(s) and/or PUSCH(s) associated or specific to or for the target Scell, after reception of the corresponding Scell switching signaling. In one example, the semi-persistent UL resource(s)/channel(s)—e.g., PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-AperiodicTriggerStateList, wherein the one or more CSI reporting settings could be associated, corresponding or specific to the target Scell, and the CSI request field could be indicated in
   A DCI e.g. DCI format(s) 0_1/0_2/0_3 received from the target Scell and/or after reception of the Scell switching signaling that activates the semi-persistent UL resource(s)/channel(s) including PUSCH(s) for CSI reporting
   The Scell switching signaling
Furthermore, the aforementioned DCI and/or the Scell switching signaling could also comprise, indicate, include or contain UL grant for the (semi-persistent) UL channel(s)/resource(s) including PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.
In another example, the UE could send or transmit the CSI report(s) associated, corresponding or specific to or for the target Scell via/in/on aperiodic UL resource(s)/channel(s) including DG PUSCH(s) associated or specific to or for the target Scell, after reception of the corresponding Scell switching signaling. In one example, the aperiodic UL resource(s)/channel(s)—e.g., DG PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-Aperiodic TriggerStateList, wherein the one or more CSI reporting settings could be associated, corresponding or specific to the target Scell, and the CSI request field could be indicated in
   A DCI e.g. DCI format(s) 0_1/0_2/0_3 received from the target Scell and/or after reception of the Scell switching signaling that indicates the aperiodic UL resource(s)/channel(s) including DG PUSCH(s) for CSI reporting
   The Scell switching signaling
Furthermore, the aforementioned DCI and/or Scell switching signaling could also comprise, indicate, include or contain UL grant for the aperiodic UL channel(s)/resource(s) including DG PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.

According to or following those specified/defined herein in the present disclosure, a UE can receive from the network (e.g., a/the PCell), a Scell switching signaling e.g. in form/terms of a downlink control signaling PDCCH of a DCI format received in a CORESET with a corresponding Scell switching field set to ‘l’ or ‘enabled’, to indicate a (target) Scell to which the UE could switch their downlink and/or uplink control and/or data channel(s)/signal(s). For transmitting SRS(s) to acquire CSI, when/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least SRS transmission(s) after receiving the Scell switching signaling is enabled, the UE could transmit SRS(s) corresponding to SRS resource(s) associated, corresponding or specific to or for the target Scell, after reception of the corresponding Scell switching signaling.
In one example, the UE could send or transmit the SRS(s) corresponding to the SRS resource(s) associated, corresponding or specific to or for the target Scell, at least X symbol(s)/slot(s)/ms/etc. after reception of the corresponding Scell switching signalling (e.g., in n+X slot/symbol, wherein n is the first (or last) slot/symbol that the UE receives the corresponding Scell switching signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could transmit the SRS(s) corresponding to the semi-persistent SRS resource(s) associated, corresponding or specific to or for the target Scell, after reception of the corresponding Scell switching signaling. In one example, the semi-persistent SRS resource(s) could be activated by a SP SRS activation/deactivation MAC CE associated with the target Scell—e.g., received from the target Scell and/or comprising a/the serving cell ID of the target Scell. In another example, the semi-persistent SRS resource(s) could be activated by the Scell switching signaling, wherein the Scell switching signaling could comprise field(s) that indicates information related to the semi-persistent SRS resource(s), e.g., in form/terms of the corresponding SRS resource set ID(s)/index(es) and/or the SRS resource ID(s)/index(es).
In another example, the UE could transmit the SRS(s) corresponding to the aperiodic SRS resource(s) associated, corresponding or specific to or for the target Scell, after reception of the corresponding Scell switching signaling. In one example, the aperiodic SRS resource(s) could be triggered by a (non-zero) SRS request field indicated in
   A DCI e.g. DCI format(s) 0_1/0_2/0_3 received from the target Scell and/or after reception of the Scell switching signaling that indicates the aperiodic SRS resource(s)
   The Scell switching signaling
Furthermore, the aforementioned DCI and/or the Scell switching signaling could also comprise, indicate, include or contain SRS resource set indicator(s), SRS resource indicator(s), second SRS resource set indicator(s) and/or SRS offset indicator(s) related to the triggered or indicated aperiodic SRS resource(s).

A UE can receive from the network (e.g., a/the PCell), a downlink control wake-up signaling (a PDCCH (candidate) of a DCI format received or monitored in a CORESET), e.g., in form/terms of a wake-up signal (WUS) via a PDCCH of a DCI format 2_6 with a/the wake-up indication field set to ‘1’ and/or a PDCCH that provides or schedules PDSCH(s)/PUSCH(s) for a/the (target) Scell, to wake up the UE from dormancy of a/the target Scell. When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least measuring CSI-RS(s) after receiving the downlink control wake-up signaling is enabled for a/the target Scell,
In one example (Option-1), the UE could start measuring or measure the CSI-RS(s) corresponding to the CSI-RS resource(s) associated, provided, indicated, triggered, activated or configured with/for the target Scell, after reception of the downlink control wake-up signaling. In this case, CSI-RS resource(s) associated, provided, indicated, triggered, activated or configured with/for the target Scell before reception of the corresponding downlink control wake-up signaling may not be counted as active CSI-RS resource(s) for the target Scell.
   For example, the UE could start measuring the CSI-RS(s) corresponding to the periodic CSI-RS resource(s) associated, provided or configured with/for the target Scell, at least X symbol(s)/slot(s)/ms/etc. after reception of the corresponding downlink control wake-up signalling (e.g., in n+X slot/symbol, wherein n is the first (or last) slot/symbol that the UE receives the corresponding downlink wake-up signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
   For another example, the UE could measure the CSI-RS(s) corresponding to the CSI-RS resource(s) activated for the target Scell, after reception of the corresponding downlink control wake-up signaling. In one example, the CSI-RS resource(s) could be activated by a SP CSI-RS/CSI-IM Resource Set Activation/Deactivation MAC CE associated with the target Scell—e.g., received from the target Scell and/or comprising a/the serving cell ID of the target Scell. In another example, the CSI-RS resource(s) could be activated by the downlink control wake-up signaling, wherein the downlink control wake-up signaling could comprise field(s) that indicates information related to the CSI-RS resource(s), e.g., in terms/form of the corresponding CSI-RS resource ID(s)/index(es) and/or CSI resource set ID(s)/index(es), for the target Scell.
   For another example, the UE could measure the CSI-RS(s) corresponding to the CSI-RS resource(s) triggered for the target Scell, after reception of the downlink control wake-up signaling. Here, the CSI-RS resource(s) could be provided by one or more CSI resource settings associated, linked or mapped to one or more CSI reporting settings associated, linked or mapped to a trigger state indicated by a non-zero CSI request field from a list of trigger states provided by CSI-AperiodicTriggerStateList, wherein the one or more CSI resource settings and/or the one or more CSI reporting settings could be associated, corresponding or specific to the target Scell. The CSI request field could be indicated in
      A DCI e.g. DCI format(s) 0_1/0_2/0_3 received from the target Scell and/or after reception of the downlink control wake-up signaling
      The downlink control wake-up signaling
In one example (Option-2), the UE could measure the CSI-RS(s) corresponding to the (e.g., periodic, semi-persistent or aperiodic) CSI-RS resource(s) associated, provided, indicated, triggered, activated or configured with/for the target Scell, before reception of the downlink control wake-up signaling. In this case, CSI-RS resource(s) associated, provided, indicated, triggered, activated or configured with/for the target Scell before reception of the downlink control wake-up signaling could be counted as active CSI-RS resource(s) for the target Scell. Furthermore, the UE may not perform any measurement(s) on the CSI-RS(s) corresponding to the CSI-RS resource(s) associated, provided, indicated, triggered, activated or configured with/for the target Scell, after reception of the downlink control wake-up signaling, according to or following those specified/defined herein in the present disclosure (e.g., those in Option-1). In this case, CSI-RS resource(s) associated, provided, indicated, triggered, activated or configured with/for the target Scell after reception of the downlink control wake-up signaling may not be counted as active CSI-RS resource(s) for the target Scell.
In one example (Option-3), the UE could measure the CSI-RS(s) corresponding to the (e.g., periodic, semi-persistent or aperiodic) CSI-RS resource(s) associated, provided, indicated, triggered, activated or configured with/for the target Scell, before reception of the corresponding downlink control wake-up signaling. Furthermore, the UE could also measure the CSI-RS(s) corresponding to the CSI-RS resource(s) associated, provided, indicated, triggered, activated or configured with/for the target Scell, after reception of the corresponding downlink control wake-up signaling, according to or following those specified/defined herein in the present disclosure (e.g., those in Option-1). In this case, CSI-RS resource(s) associated, provided, indicated, triggered, activated or configured with/for the target Scell before and after reception of the corresponding downlink control wake-up signaling could be counted as active CSI-RS resource(s) for the target Scell.

The UE could be configured or enabled or indicated by the network, e.g., via/by/in higher layer RRC signalling(s)/parameter(s) and/or MAC CE command(s) and/or dynamic DCI based L1 signaling(s), to follow those specified/described in Option-1, Option-2 and/or Option-3 according to or based on a corresponding UE's capability or capability signalling, wherein the UE′ capability or capability signalling could comprise one or more of the following components that the UE could support or could be capable of:
{Option-1}
{Option-2}
{Option-3}
{Option-1, Option-2}
{Option-1, Option-3}
{Option-2, Option-3}
{Option-1, Option-2, Option-3}

According to or following those specified/defined herein in the present disclosure, a UE can receive from the network (e.g., a/the PCell), a downlink control wake-up signaling (a PDCCH (candidate) of a DCI format received or monitored in a CORESET), e.g., in form/terms of a wake-up signal (WUS) via a PDCCH of a DCI format 2_6 with a/the wake-up indication field set to ‘1’ and/or a PDCCH that provides or schedules PDSCH(s)/PUSCH(s) for a/the (target) Scell, to wake up the UE from dormancy of a/the target Scell. When/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least CSI reporting after receiving the downlink control wake-up signaling for/of the (target) Scell is enabled, the UE could send or transmit the CSI report(s) associated, corresponding or specific to or for the target Scell via/in/on corresponding UL resource(s)/channel(s) including (CG Type1/2 and/or DG) PUSCH(s) and/or PUCCH(s) associated or specific to or for the target Scell, after reception of the corresponding downlink control wake-up signaling.
In one example, the UE could send or transmit the CSI report(s) associated, corresponding or specific to or for the target Scell via/in/on the first available UL resource(s)/channel(s) including (CG Type1/2 and/or DG) PUSCH(s) and/or PUCCH(s) associated or specific to or for the target Scell, at least X symbol(s)/slot(s)/ms/etc. after reception of the corresponding downlink control wake-up signalling (e.g., in n+X slot/symbol, wherein n is the first (or last) slot/symbol that the UE receives the corresponding downlink control wake-up signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could send or transmit the CSI report(s) associated, corresponding or specific to or for the target Scell via/in/on the semi-persistent UL resource(s)/channel(s) including PUCCH(s) and/or PUSCH(s) associated or specific to or for the target Scell, after reception of the corresponding downlink control wake-up signaling. In one example, the semi-persistent UL resource(s)/channel(s)—e.g., PUCCH(s)—for carrying or conveying the CSI report(s) could be activated by a SP CSI reporting on PUCCH activation/deactivation MAC CE associated with the target Scell—e.g., received from the target Scell and/or comprising a/the serving cell ID of the target Scell. In another example, the semi-persistent UL resource(s)/channel(s)—e.g., PUCCH(s)—for carrying or conveying the CSI report(s) could be activated by the downlink control wake-up signaling, wherein the downlink control wake-up signaling could comprise field(s) that indicates information related to the semi-persistent UL resource(s)/channel(s) e.g. PUCCH(s) that could be used to convey or carry the CSI report(s), e.g., indicating the activation/deactivation status of the corresponding semi-persistent CSI report configuration.
In another example, the UE could send or transmit the CSI report(s) associated, corresponding or specific to or for the target Scell via/in/on the semi-persistent UL resource(s)/channel(s) including PUCCH(s) and/or PUSCH(s) associated or specific to or for the target Scell, after reception of the corresponding downlink control wake-up signaling. In one example, the semi-persistent UL resource(s)/channel(s)—e.g., PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-AperiodicTriggerStateList, wherein the one or more CSI reporting settings could be associated, corresponding or specific to the target Scell, and the CSI request field could be indicated in
   A DCI e.g. DCI format(s) 0_1/0_2/0_3 received from the target Scell and/or after reception of the downlink control wake-up signaling that activates the semi-persistent UL resource(s)/channel(s) including PUSCH(s) for CSI reporting
   The downlink control wake-up signaling
Furthermore, the aforementioned DCI and/or the downlink control wake-up signaling could also comprise, indicate, include or contain UL grant for the (semi-persistent) UL channel(s)/resource(s) including PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.
In another example, the UE could send or transmit the CSI report(s) associated, corresponding or specific to or for the target Scell via/in/on aperiodic UL resource(s)/channel(s) including DG PUSCH(s) associated or specific to or for the target Scell, after reception of the corresponding downlink control wake-up signaling. In one example, the aperiodic UL resource(s)/channel(s)—e.g., DG PUSCH(s)—for carrying or conveying the CSI report(s) could be associated, linked, mapped or specific to one or more CSI reporting setting(s) associated, linked or mapped to a trigger state indicated by a non-zero CSI request field from a list of trigger states provided by CSI-AperiodicTriggerStateList, wherein the one or more CSI reporting settings could be associated, corresponding or specific to the target Scell, and the CSI request field could be indicated in
   A DCI e.g. DCI format(s) 0_1/0_2/0_3 received from the target Scell and/or after reception of the downlink control wake-up signaling that indicates the aperiodic UL resource(s)/channel(s) including DG PUSCH(s) for CSI reporting
   The downlink control wake-up signaling
Furthermore, the aforementioned DCI and/or downlink control wake-up signaling could also comprise, indicate, include or contain UL grant for the aperiodic UL channel(s)/resource(s) including DG PUSCH(s), and/or a TDRA field, wherein a codepoint of the TDRA field could point to a slot offset value for sending the CSI report(s) over/in/by the corresponding PUSCH transmission occasion(s) and/or resource(s) from a list of report slot offset value(s) provided by reportSlotOffsetList or reportSlotOffsetList-r17, associated/linked/specific/corresponding to the one or more CSI reporting settings.

According to or following those specified/defined herein in the present disclosure, a UE can receive from the network (e.g., a/the PCell), a downlink control wake-up signaling (a PDCCH (candidate) of a DCI format received or monitored in a CORESET), e.g., in form/terms of a wake-up signal (WUS) via a PDCCH of a DCI format 2_6 with a/the wake-up indication field set to ‘1’ and/or a PDCCH that provides or schedules PDSCH(s)/PUSCH(s) for a/the (target) Scell, to wake up the UE from dormancy of a/the target Scell. For transmitting SRS(s) to acquire CSI, when/if the UE is provided or configured or enabled by the network, e.g., via higher layer RRC signalling(s)/parameter(s) and/or MAC CE command(s) and/or dynamic DCI based L1 signaling(s) according to or based on corresponding UE's capability(s) or capability signalling(s), that at least SRS transmission(s) after receiving the downlink control wake-up signaling is enabled, the UE could transmit SRS(s) corresponding to SRS resource(s) associated, corresponding or specific to or for the target Scell, after reception of the corresponding downlink control wake-up signaling.
In one example, the UE could send or transmit the SRS(s) corresponding to the SRS resource(s) associated, corresponding or specific to or for the target Scell, at least X symbol(s)/slot(s)/ms/etc. after reception of the corresponding downlink control wake-up signaling (e.g., in n+X slot/symbol, wherein n is the first (or last) slot/symbol that the UE receives the corresponding downlink control wake-up signaling), wherein the UE could determine or identify value(s) of X according to or based on: (1) fixed value(s), e.g., X=3 ms, in system specification(s), (2) network's configuration(s)/indication(s) e.g. via higher layer RRC signalling(s)/parameter(s) and/or MAC CE command(s) and/or dynamic DCI based L1 signaling(s) based on or according to a corresponding UE's capability or capability signalling, and/or (3) UE's autonomous selection or determination, which could be further sent to the network via/by various UL channel(s) and/or signal(s) including e.g. CSI/beam report(s) and/or UE's capability signalling(s).
In another example, the UE could transmit the SRS(s) corresponding to the semi-persistent SRS resource(s) associated, corresponding or specific to or for the target Scell, after reception of the corresponding downlink control wake-up signaling. In one example, the semi-persistent SRS resource(s) could be activated by a SP SRS activation/deactivation MAC CE associated with the target Scell—e.g., received from the target Scell and/or comprising a/the serving cell ID of the target Scell. In another example, the semi-persistent SRS resource(s) could be activated by the downlink control wake-up signaling, wherein the downlink control wake-up signaling could comprise field(s) that indicates information related to the semi-persistent SRS resource(s), e.g., in form/terms of the corresponding SRS resource set ID(s)/index(es) and/or the SRS resource ID(s)/index(es).
In another example, the UE could transmit the SRS(s) corresponding to the aperiodic SRS resource(s) associated, corresponding or specific to or for the target Scell, after reception of the corresponding downlink control wake-up signaling. In one example, the aperiodic SRS resource(s) could be triggered by a (non-zero) SRS request field indicated in
   A DCI e.g. DCI format(s) 0_1/0_2/0_3 received from the target Scell and/or after reception of the downlink control wake-up signaling that indicates the aperiodic SRS resource(s)
   The downlink control wake-up signaling
Furthermore, the aforementioned DCI and/or the downlink control wake-up signaling could also comprise, indicate, include or contain SRS resource set indicator(s), SRS resource indicator(s), second SRS resource set indicator(s) and/or SRS offset indicator(s) related to the triggered or indicated aperiodic SRS resource(s).

The aforementioned Scell activation/deactivation MAC CE command, Scell switching signaling and/or downlink control wake-up signaling can be replaced by/with a carrier/BWP switching command, and the corresponding signaling mechanism(s), UE's behaviors and/or operations can be similarly defined and/or specified.

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method 1000 begins with the UE receiving information related to early CSI acquisition for a SCell (1010). The UE then receives signaling associated with the SCell (1020). In various embodiments, the signaling is a SCell activation or deactivation command, a SCell switching signaling, or a SCell switching out-of-dormancy signaling.

The UE then identifies a target CSI report configuration for early CSI acquisition for the SCell based on the signaling and the information (1030). In various embodiments, the information includes one or more of a higher layer parameter that enables early CSI acquisition for the SCell and one or more candidate CSI report configurations for early CSI acquisition for the SCell. In some examples, the signaling includes an indicator indicating the target CSI report configuration from the one or more candidate CSI report configurations. In various embodiments, when the signaling does not include an indicator indicating the target CSI report configuration, the information includes only one CSI report configuration for early CSI acquisition for the SCell, and the only one CSI report configuration corresponds to the target CSI report configuration.

The UE then determines one or more CSI-RSs for channel measurement and one or more UL resources for reporting CSI based on the target CSI report configuration (1040) and measures the one or more CSI-RSs (1050). In various embodiments, the one or more CSI-RSs are measured no earlier than T gap symbols after an end of reception of the signaling, where T gap is higher layer configured. The one or more UL resources include a dynamic grant PUSC) resource or a configured grant PUSCH resource.

The UE then determines a CSI report based on the measurement (1060) and transmits the CSI report in the one or more UL resources (1070). In various embodiments, the UE transmits, when the one or more UL resources include a configured grant PUSCH resource, the CSI report in a first transmission occasion of the configured grant PUSCH resource within T_proc after reception of the signaling, where T proc is higher layer configured.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive information related to early channel state information (CSI) acquisition for a secondary cell (SCell); and
receive signaling associated with the SCell; and
a processor operably coupled with the transceiver, the processor configured to:
identify, based on the signaling and the information, a target CSI report configuration for early CSI acquisition for the SCell; and
determine, based on the target CSI report configuration, (i) one or more CSI reference signals (CSI-RSs) for channel measurement and (ii) one or more uplink (UL) resources for reporting CSI,
wherein the transceiver is further configured to measure the one or more CSI-RSs,
wherein the processor is further configured to determine a CSI report based on the measurement, and
wherein the transceiver is further configured to transmit the CSI report in the one or more UL resources.

2. The UE of claim 1, wherein the information includes at least one of:
a higher layer parameter that enables early CSI acquisition for the SCell; and
one or more candidate CSI report configurations for early CSI acquisition for the SCell.

3. The UE of claim 2, wherein the signaling includes an indicator indicating the target CSI report configuration from the one or more candidate CSI report configurations.

4. The UE of claim 1, wherein:
when the signaling does not include an indicator indicating the target CSI report configuration, the information includes only one CSI report configuration for early CSI acquisition for the SCell, and
the only one CSI report configuration corresponds to the target CSI report configuration.

5. The UE of claim 1, wherein the signaling is:
a SCell activation or deactivation command,
a SCell switching signaling, or
a SCell switching out-of-dormancy signaling.

6. The UE of claim 1, wherein:
the one or more CSI-RSs are measured no earlier than T_gap symbols after an end of reception of the signaling, where T_gap is higher layer configured; and
the one or more UL resources include:
a dynamic grant physical uplink shared channel (PUSCH) resource, or
a configured grant PUSCH resource.

7. The UE of claim 1, wherein:
the transceiver is further configured to transmit, when the one or more UL resources include a configured grant physical uplink shared channel (PUSCH) resource, the CSI report in a first transmission occasion of the configured grant PUSCH resource within a time duration (T proc) after reception of the signaling, and
the T_proc is higher layer configured.

8. A base station (BS), comprising:
a transceiver configured to:
transmit information related to early channel state information (CSI) acquisition for a secondary cell (SCell); and
transmit signaling associated with the SCell, wherein the signaling and the information indicate a target CSI report configuration for early CSI acquisition for the SCell; and
a processor operably coupled with the transceiver, the processor configured to determine, based on the target CSI report configuration, (i) one or more CSI reference signals (CSI-RSs) and (ii) one or more uplink (UL) resources for receiving CSI reporting,
wherein the transceiver is further configured to:
transmit the one or more CSI-RSs, and
receive a CSI report associated with the one or more CSI-RSs in the one or more uplink (UL) resources.

9. The BS of claim 8, wherein the information includes at least one of:
a higher layer parameter that enables early CSI acquisition for the SCell; and
one or more candidate CSI report configurations for early CSI acquisition for the SCell.

10. The BS of claim 9, wherein the signaling includes an indicator indicating the target CSI report configuration from the one or more candidate CSI report configurations.

11. The BS of claim 8, wherein:
when the signaling does not include an indicator indicating the target CSI report configuration, the information includes only one CSI report configuration for early CSI acquisition for the SCell, and
the only one CSI report configuration corresponds to the target CSI report configuration.

12. The BS of claim 8, wherein the signaling is:
a SCell activation or deactivation command,
a SCell switching signaling, or
a SCell switching out-of-dormancy signaling.

13. The BS of claim 8, wherein:
the one or more CSI-RSs are transmitted no later than T gap symbols after an end of transmission of the signaling,
the transceiver is further configured to transmit, via higher layer, T_gap; and
the one or more UL resources include:
a dynamic grant physical uplink shared channel (PUSCH) resource, or
a configured grant PUSCH resource.

14. The BS of claim 8, wherein, the transceiver is further configured to:
receive, when the one or more UL resources include a configured grant physical uplink shared channel (PUSCH) resource, the CSI report in a first transmission occasion of the configured grant PUSCH resource within a time duration (T_proc) after reception of the signaling, and
transmit, via higher layer, the T_proc.

15. A method performed by a user equipment (UE), the method comprising:
receiving information related to early channel state information (CSI) acquisition for a secondary cell (SCell);
receiving signaling associated with the SCell;
identifying, based on the signaling and the information, a target CSI report configuration for early CSI acquisition for the SCell;
determining, based on the target CSI report configuration, (i) one or more CSI reference signals (CSI-RSs) for channel measurement and (ii) one or more uplink (UL) resources for reporting CSI;
measuring the one or more CSI-RSs;
determining a CSI report based on the measurement; and
transmitting the CSI report in the one or more UL resources.

16. The method of claim 15, wherein the information includes at least one of:
a higher layer parameter that enables early CSI acquisition for the SCell; and
one or more candidate CSI report configurations for early CSI acquisition for the SCell.

17. The method of claim 16, wherein the signaling includes an indicator indicating the target CSI report configuration from the one or more candidate CSI report configurations.

18. The method of claim 15, wherein:
when the signaling does not include an indicator indicating the target CSI report configuration, the information includes only one CSI report configuration for early CSI acquisition for the SCell, and
the only one CSI report configuration corresponds to the target CSI report configuration.

19. The method of claim 15, wherein the signaling is:
a SCell activation or deactivation command,
a SCell switching signaling, or
a SCell switching out-of-dormancy signaling.

20. The method of claim 15, wherein:
the one or more CSI-RSs are measured no earlier than T_gap symbols after an end of reception of the signaling, where T gap is higher layer configured; and
the one or more UL resources include:
a dynamic grant physical uplink shared channel (PUSCH) resource, or
a configured grant PUSCH resource.
